(19) United States
(12) Patent Application Publication
(10) Pub. No.: US 2026/0222760 A1
(43) Pub. Date: Jul. 30, 2026

(54) ACOUSTIC PROCESSING DEVICE, ACOUSTIC PROCESSING METHOD, AND RECORDING MEDIUM

(71) Applicant: Panasonic Intellectual Property Corporation of America, Torrance, CA (US)

(72) Inventors: Masahiro Oshikiri, Osaka (JP); Tomokazu Ishikawa, Osaka (JP); Hiroyuki Ehara, Kanagawa (JP); Hikaru Usami, Osaka (JP); Seigo Enomoto, Kyoto (JP); Kota Nakahashi, Osaka (JP); Shuji Miyasaka, Osaka (JP)

(21) Appl. No.: 19/575,031

(22) Filed: Mar. 23, 2026

Related U.S. Application Data
(63) Continuation of application No. PCT/JP2024/035424, filed on Oct. 3, 2024.
(60) Provisional application No. 63/542,844, filed on Oct. 6, 2023.
(60) Provisional application No. 63/542,842, filed on Oct. 6, 2023.
(60) Provisional application No. 63/615,038, filed on Dec. 27, 2023.

(51) Int. Cl. H04S 7/00

(52) U.S. Cl. CPC H04S 7/304; H04S 2400/11

(57) ABSTRACT

Acoustic processing device (information processing device) includes: an obtainer that obtains sound information including: an acoustic signal; and information on a position of a sound source object in a three-dimensional sound field; a table referencer that references a table that associates at least one of a position of a user in the three-dimensional sound field or a position of the sound source object with information for determining a target sound; and a reduction processor that determines the target sound using the information for determining the target sound obtained by referencing the table, and generates an output sound signal excluding a signal of the target sound determined, by removing the signal of the target sound from among signals of a plurality of sounds generated for use in generating the output sound signal from the acoustic signal included in the sound information obtained.

### CROSS REFERENCE TO RELATED APPLICATIONS

This is a continuation application of PCT International Application No. PCT/JP2024/035424 filed on Oct. 3, 2024, designating the United States of America, which is based on and claims priority of U.S. Provisional Patent Application No. 63/542,842 filed on Oct. 6, 2023, U.S. Provisional Patent Application No. 63/542,844 filed on Oct. 6, 2023, and U.S. Provisional Patent Application No. 63/615,038 filed on Dec. 27, 2023. The entire disclosures of the above-identified applications, including the specifications, drawings, and claims are incorporated herein by reference in their entirety.

### FIELD

The present disclosure relates to an acoustic processing device, an acoustic processing method, and a recording medium.

### BACKGROUND

Techniques for acoustic reproduction to make a user perceive three-dimensional sound in a virtual three-dimensional space are known (see, for example, Patent Literature (PTL) 1). In order to make the sound be perceived as arriving from a sound source object to the user in such a three-dimensional space, processing is required to generate output sound information from the original sound information. In particular, enormous processing is required to reproduce three-dimensional sound in response to the movement of the user's body in a virtual space. With the development of computer graphics (CG), it has become possible to construct visually complex virtual environments relatively easily, and technology for realizing corresponding auditory information has become important. In addition, when processing from sound information to output sound information is performed in advance, a large memory area for storing the pre-calculated processing results is required. When transmitting such large processing result data, a wide communication bandwidth may be required.

In order to achieve a sound environment that more closely resembles reality, the number of objects that produce sound in a virtual three-dimensional space increases, secondary sounds based on acoustic effects such as reflected sound, diffracted sound, and reverberation increase, and furthermore, these secondary sounds need to be appropriately changed in response to the movement of the user, requiring a large amount of processing.

### CITATION LIST

### Patent Literature

PTL 1: Japanese Unexamined Patent Application Publication No. 2020-18620

### SUMMARY

### Technical Problem

In view of this, the present disclosure has an object to provide an acoustic processing device and the like that can appropriately generate an output sound signal from the perspective of processing load.

### Solution to Problem

An acoustic processing device according to one aspect of the present disclosure includes: an obtainer that obtains sound information including: an acoustic signal; and information on a position of a sound source object in a three-dimensional sound field; a table referencer that references a table that associates at least one of a position of a user in the three-dimensional sound field or a position of the sound source object with information for determining a target sound; and a reduction processor that determines the target sound using the information for determining the target sound obtained by referencing the table, and generates an output sound signal excluding a signal of the target sound determined, by removing the signal of the target sound from among signals of a plurality of sounds generated for use in generating the output sound signal from the acoustic signal included in the sound information obtained.

An acoustic processing method according to one aspect of the present disclosure is an acoustic processing method executed by a computer, the acoustic processing method including: obtaining sound information including: an acoustic signal; and information on a position of a sound source object in a three-dimensional sound field; referencing a table that associates at least one of a position of a user in the three-dimensional sound field or a position of the sound source object with information for determining a target sound; and determining the target sound using the information for determining the target sound obtained by referencing the table, and generating an output sound signal excluding a signal of the target sound determined, by removing the signal of the target sound from among signals of a plurality of sounds generated for use in generating the output sound signal from the acoustic signal included in the sound information obtained.

One aspect of the present disclosure may be realized as a non-transitory computer-readable recording medium for use in a computer, the recording medium having a computer program recorded thereon for causing the computer to execute an acoustic processing method described above.

Note that these general or specific aspects may be implemented using a system, a device, a method, an integrated circuit, a computer program, or a non-transitory computer-readable recording medium such as a CD-ROM, or any combination thereof.

### Advantageous Effects

The present disclosure makes it possible to appropriately generate an output sound signal.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating an example of use of an acoustic reproduction system according to an embodiment of the present disclosure.

FIG. 2 is a block diagram illustrating the functional configuration of an acoustic reproduction system according to an embodiment of the present disclosure.

FIG. 3 is a diagram for explaining one example of an audio signal according to an embodiment of the present disclosure.

FIG. 4 is a block diagram illustrating the functional configuration of an obtainer according to an embodiment of the present disclosure.

FIG. 5 is a block diagram illustrating the functional configuration of an output sound generator according to an embodiment of the present disclosure.

FIG. 6 is a diagram for explaining another example of an acoustic reproduction system according to an embodiment of the present disclosure.

FIG. 7 is a diagram for explaining another example of an acoustic reproduction system according to an embodiment of the present disclosure.

FIG. 8 is a diagram for explaining another example of an acoustic reproduction system according to an embodiment of the present disclosure.

FIG. 9 is a diagram for explaining another example of an acoustic reproduction system according to an embodiment of the present disclosure.

FIG. 10 is a diagram for explaining another example of an acoustic reproduction system according to an embodiment of the present disclosure.

FIG. 11 is a diagram for explaining another example of an acoustic reproduction system according to an embodiment of the present disclosure.

FIG. 12 is a diagram for explaining another example of an acoustic reproduction system according to an embodiment of the present disclosure.

FIG. 13 is a diagram for explaining another example of an acoustic reproduction system according to an embodiment of the present disclosure.

FIG. 14 is a diagram for explaining another example of an acoustic reproduction system according to an embodiment of the present disclosure.

FIG. 15 is a diagram for explaining a specific example of an acoustic reproduction system according to Example 1 of an embodiment of the present disclosure.

FIG. 16 is a diagram for explaining a specific example of an acoustic reproduction system according to Example 1 of an embodiment of the present disclosure.

FIG. 17 is a diagram for explaining a specific example of an acoustic reproduction system according to Example 1 of an embodiment of the present disclosure.

FIG. 18 is a diagram for explaining a specific example of an acoustic reproduction system according to Example 1 of an embodiment of the present disclosure.

FIG. 19 is a diagram for explaining a specific example of an acoustic reproduction system according to Example 1 of an embodiment of the present disclosure.

FIG. 20 is a diagram for explaining a specific example of an acoustic reproduction system according to Example 1 of an embodiment of the present disclosure.

FIG. 21 is a diagram for explaining a specific example of an acoustic reproduction system according to Example 1 of an embodiment of the present disclosure.

FIG. 22 is a diagram for explaining a specific example of an acoustic reproduction system according to Example 1 of an embodiment of the present disclosure.

FIG. 23 is a diagram for explaining a specific example of an acoustic reproduction system according to Example 1 of an embodiment of the present disclosure.

FIG. 24 is a diagram for explaining a specific example of an acoustic reproduction system according to Example 1 of an embodiment of the present disclosure.

FIG. 25 is a diagram for explaining a specific example of an acoustic reproduction system according to Example 1 of an embodiment of the present disclosure.

FIG. 26 is a diagram for explaining a specific example of an acoustic reproduction system according to Example 1 of an embodiment of the present disclosure.

FIG. 27 is a diagram for explaining a specific example of an acoustic reproduction system according to Example 1 of an embodiment of the present disclosure.

FIG. 28 is a diagram for explaining a specific example of an acoustic reproduction system according to Example 1 of an embodiment of the present disclosure.

FIG. 29 is a diagram for explaining a specific example of an acoustic reproduction system according to Example 1 of an embodiment of the present disclosure.

FIG. 30 is a diagram for explaining a specific example of an acoustic reproduction system according to Example 1 of an embodiment of the present disclosure.

FIG. 31 is a diagram for explaining a specific example of an acoustic reproduction system according to Example 1 of an embodiment of the present disclosure.

FIG. 32 is a diagram for explaining a specific example of an acoustic reproduction system according to Example 1 of an embodiment of the present disclosure.

FIG. 33 is a diagram for explaining a specific example of an acoustic reproduction system according to Example 1 of an embodiment of the present disclosure.

FIG. 34 is a diagram for explaining a specific example of an acoustic reproduction system according to Example 1 of an embodiment of the present disclosure.

FIG. 35 is a diagram for explaining a specific example of an acoustic reproduction system according to Example 2 of an embodiment of the present disclosure.

FIG. 36 is a diagram for explaining a specific example of an acoustic reproduction system according to Example 2 of an embodiment of the present disclosure.

FIG. 37 is a diagram for explaining a specific example of an acoustic reproduction system according to Example 2 of an embodiment of the present disclosure.

FIG. 38 is a diagram for explaining a specific example of an acoustic reproduction system according to Example 2 of an embodiment of the present disclosure.

FIG. 39 is a diagram for explaining a specific example of an acoustic reproduction system according to Example 2 of an embodiment of the present disclosure.

FIG. 40 is a diagram for explaining a specific example of an acoustic reproduction system according to Example 2 of an embodiment of the present disclosure.

FIG. 41 is a diagram for explaining a specific example of an acoustic reproduction system according to Example 2 of an embodiment of the present disclosure.

FIG. 42 is a diagram for explaining a specific example of an acoustic reproduction system according to Example 2 of an embodiment of the present disclosure.

FIG. 43 is a diagram for explaining a specific example of an acoustic reproduction system according to Example 2 of an embodiment of the present disclosure.

FIG. 44 is a diagram for explaining a specific example of an acoustic reproduction system according to Example 2 of an embodiment of the present disclosure.

FIG. 45 is a diagram for explaining a specific example of an acoustic reproduction system according to Example 2 of an embodiment of the present disclosure.

FIG. 46 is a diagram for explaining a specific example of an acoustic reproduction system according to Example 2 of an embodiment of the present disclosure.

FIG. 47 is a diagram for explaining a specific example of an acoustic reproduction system according to Example 2 of an embodiment of the present disclosure.

FIG. 48 is a diagram for explaining a specific example of an acoustic reproduction system according to Example 2 of an embodiment of the present disclosure.

FIG. 49 is a diagram for explaining a specific example of an acoustic reproduction system according to Example 2 of an embodiment of the present disclosure.

FIG. 50 is a diagram for explaining a specific example of an acoustic reproduction system according to Example 2 of an embodiment of the present disclosure.

FIG. 51 is a diagram for explaining a specific example of an acoustic reproduction system according to Example 2 of an embodiment of the present disclosure.

FIG. 52 is a diagram for explaining a specific example of an acoustic reproduction system according to Example 2 of an embodiment of the present disclosure.

FIG. 53 is a diagram for explaining a specific example of an acoustic reproduction system according to Example 2 of an embodiment of the present disclosure.

FIG. 54 is a diagram for explaining a specific example of an acoustic reproduction system according to Example 2 of an embodiment of the present disclosure.

FIG. 55 is a diagram for explaining a specific example of an acoustic reproduction system according to Example 2 of an embodiment of the present disclosure.

FIG. 56 is a diagram for explaining a specific example of an acoustic reproduction system according to Example 2 of an embodiment of the present disclosure.

FIG. 57 is a diagram for explaining a specific example of an acoustic reproduction system according to Example 2 of an embodiment of the present disclosure.

FIG. 58 is a diagram for explaining a specific example of an acoustic reproduction system according to Example 3 of an embodiment of the present disclosure.

FIG. 59 is a diagram for explaining a specific example of an acoustic reproduction system according to Example 3 of an embodiment of the present disclosure.

FIG. 60 is a diagram for explaining a specific example of an acoustic reproduction system according to Example 3 of an embodiment of the present disclosure.

FIG. 61 is a diagram for explaining a specific example of an acoustic reproduction system according to Example 3 of an embodiment of the present disclosure.

FIG. 62A is a diagram for explaining a specific example of an acoustic reproduction system according to Example 3 of an embodiment of the present disclosure.

FIG. 62B is a diagram for explaining a specific example of an acoustic reproduction system according to Example 3 of an embodiment of the present disclosure.

FIG. 63 is a diagram for explaining a specific example of an acoustic reproduction system according to Example 3 of an embodiment of the present disclosure.

FIG. 64 is a diagram for explaining a specific example of an acoustic reproduction system according to Example 3 of an embodiment of the present disclosure.

FIG. 65 is a diagram for explaining a specific example of an acoustic reproduction system according to Example 3 of an embodiment of the present disclosure.

FIG. 66 is a diagram for explaining a specific example of an acoustic reproduction system according to Example 3 of an embodiment of the present disclosure.

FIG. 67 is a diagram for explaining a specific example of an acoustic reproduction system according to Example 3 of an embodiment of the present disclosure.

FIG. 68 is a diagram for explaining a specific example of an acoustic reproduction system according to Example 3 of an embodiment of the present disclosure.

FIG. 69 is a diagram for explaining a specific example of an acoustic reproduction system according to Example 3 of an embodiment of the present disclosure.

FIG. 70 is a diagram for explaining a specific example of an acoustic reproduction system according to Example 3 of an embodiment of the present disclosure.

### DESCRIPTION OF EMBODIMENT(S)

### Underlying Knowledge Forming Basis of the Disclosure

Techniques for acoustic reproduction to make a user perceive three-dimensional sound in a virtual three-dimensional space (hereinafter may be referred to as a three-dimensional sound field) are known (see, for example, PTL 1). By using this technique, the user can perceive the sound as if a sound source object is at a predetermined position in the virtual space and the sound is arriving from that direction. In order to localize a sound image at a predetermined position in a virtual three-dimensional space in this way, for example, computational processing is required to generate interaural time differences and interaural level differences (or sound pressure differences) between the ears for the signal of the sound that the sound source object is producing (also referred to as sound emitted from the sound source object, or reproduced sound), such that the sound is perceived as a three-dimensional sound. Such computational processing is performed by applying a three-dimensional sound filter. A three-dimensional sound filter is an information processing filter that, when applied to the original sound information and the resulting output sound signal is reproduced, allows the direction and distance of the sound, the size of the sound source, and the spaciousness to be perceived three-dimensionally.

As one example of computational processing for applying such a three-dimensional sound filter, processing that convolves a head-related transfer function for perceiving sound as arriving from a predetermined direction with the signal of the target sound is known. Performing the convolution processing of this head-related transfer function at sufficiently fine angles with respect to the direction of arrival of the reproduced sound from the position of the sound source object to the user's position enhances the sense of realism experienced by the user.

In recent years, development of technology related to virtual reality (VR) has been actively conducted. In virtual reality, the position of sound source objects in a virtual three-dimensional space appropriately changes in response to the user's movement, with the main focus being on allowing the user to physically experience as if they are moving within the virtual space. For this purpose, it is necessary to relatively move the localization position of the sound image in the virtual space in response to the user's movement. Such processing has been performed by applying a three-dimensional sound filter, such as the head-related transfer function mentioned above, to the original sound information. However, when a user moves in a three-dimensional space, the sound transmission path changes from moment to moment each time the positional relationship between the sound source object and the user changes, including sound reverberation and interference. As a result, it is necessary to determine the sound transmission path from the sound source object based on the positional relationship between the sound source object and the user each time, and to convolve the transfer function considering sound reverberation and interference. However, with such information processing, the processing amount becomes enormous, and without a large-scale processing device, it may not be possible to achieve an improvement in the sense of realism.

As a means to reduce such enormous processing amounts, attempts have been made to partially reduce the sounds to be reproduced. More specifically, for each of the many sound source objects in the three-dimensional space, or for each of the plurality of types of sounds generated from each of the sound source objects, rather than convolving the head-related transfer function with all of them, the sounds are partially reduced and then the head-related transfer function is convolved. By doing this, in the convolution of the head-related transfer function, which particularly requires a large processing amount, that is, in the process of generating a spatial audio signal for output (in other words, an output signal or an output sound signal), a significant reduction in the processing amount is expected because the number of sound signals to be processed is reduced.

However, indiscriminately reducing sound signals would lead to sound degradation, so in order to inhibit this sound degradation, sounds with relatively little sound degradation are prepared in advance as a table, and the sounds to reduce are determined by referring to that table. This makes it possible to realize an acoustic processing device that can inhibit sound degradation while reducing the processing amount.

A more specific overview of the present disclosure is as follows.

An acoustic processing device according to a first aspect of the present disclosure includes: an obtainer that obtains sound information including: an acoustic signal; and information on a position of a sound source object in a three-dimensional sound field; a table referencer that references a table that associates at least one of a position of a user in the three-dimensional sound field or a position of the sound source object with information for determining a target sound; and a reduction processor that determines the target sound using the information for determining the target sound obtained by referencing the table, and generates an output sound signal excluding a signal of the target sound determined, by removing the signal of the target sound from among signals of a plurality of sounds generated for use in generating the output sound signal from the acoustic signal included in the sound information obtained.

That is, the acoustic processing device according to the first aspect references a table prepared in advance based on at least one of the position of the object or the position of the listener, among a plurality of sounds emitted from an object (sound source object) and reaching a listener (user) through a plurality of paths, and outputs the content indicated in the table to subsequent processing (reduction processing).

According to such an acoustic processing device, for at least one of the position of the user or the position of the sound source object in the three-dimensional sound field, sounds with relatively little sound degradation are prepared in advance as a table, and which sounds to remove are determined by referring to that table. This makes it possible to inhibit sound degradation while reducing the processing amount. Therefore, from the perspective of processing load, it is possible to appropriately generate an output sound signal.

An acoustic processing device according to a second aspect is the acoustic processing device according to the first aspect, wherein the table includes a priority for each of the plurality of sounds, and a lower rank in the priority increases a likelihood to be determined as the target sound.

That is, the acoustic processing device according to the second aspect is an acoustic processing device in which the table indicates priorities of sounds reaching the listener.

According to such an acoustic processing device, the table can include a priority for each of the plurality of sounds, wherein a lower rank in priority increases a likelihood to be determined as the target sound, and which sounds to remove can be determined by referencing that table.

An acoustic processing device according to a third aspect is the acoustic processing device according to the first aspect, wherein the table includes an identifier for distinguishing, from other sounds, each of at least two sounds to be determined as the target sound from among the plurality of sounds.

That is, the acoustic processing device according to the third aspect is an acoustic processing device in which the table indicates identifiers of two or more sounds reaching the listener.

According to such an acoustic processing device, the table can include an identifier for distinguishing, from other sounds, each of at least two sounds to be determined as the target sound from among the plurality of sounds, and which sounds to remove can be determined by referring to that table.

An acoustic processing device according to a fourth aspect is the acoustic processing device according to the first aspect, wherein the table includes information indicating whether or not to perform an operation to generate each of the plurality of sounds.

That is, the acoustic processing device according to the fourth aspect is an acoustic processing device in which the table indicates operation/non-operation information of sounds reaching the listener.

According to such an acoustic processing device, the table can include information indicating whether or not to perform an operation to generate each of the plurality of sounds, and which sounds to remove can be determined by referring to that table.

An acoustic processing device according to a fifth aspect is the acoustic processing device according to the first aspect, wherein the table includes information indicating whether or not to perform an operation to generate each of the plurality of sounds, and a priority for each of the plurality of sounds, and a lower priority increases a likelihood to be determined as the target sound.

That is, the acoustic processing device according to the fifth aspect is an acoustic processing device in which the table includes both operation/non-operation information and priorities of sounds reaching the listener.

According to such an acoustic processing device, the table can include information indicating whether or not to perform an operation to generate each of the plurality of sounds, and a priority for each of the plurality of sounds, wherein a lower priority increases a likelihood to be determined as the target sound, and which sounds to remove can be determined by referencing that table.

An acoustic processing device according to a sixth aspect is the acoustic processing device according to any one of the first to fifth aspects, wherein the reduction processor includes a culler that removes the signal of the target sound by discarding the signal of the target sound.

That is, the acoustic processing device according to the sixth aspect is an acoustic processing device in which the subsequent processing culls sounds indicated in the table.

According to such an acoustic processing device, the signal of the determined target sound can be removed by discarding the signal of the target sound.

An acoustic processing device according to a seventh aspect is the acoustic processing device according to the sixth aspect, wherein the reduction processor discards the signal of the target sound by stopping an operation to generate the signal of the target sound.

That is, the acoustic processing device according to the seventh aspect is an acoustic processing device in which the subsequent processing stops the operation of sound generators indicated in the table.

According to such an acoustic processing device, the signal of the determined target sound can be removed by discarding the signal of the target sound by stopping an operation to generate the signal of the target sound.

An acoustic processing device according to an eighth aspect is the acoustic processing device according to any one of the first to fifth aspects, wherein the reduction processor includes an integrator that removes signals of at least two target sounds, each of which is the target sound, by discarding the signals of the at least two target sounds and supplementing one signal of a virtual sound that integrates the signals of the at least two target sounds.

That is, the acoustic processing device according to the eighth aspect is an acoustic processing device in which the subsequent processing integrates sounds indicated in the table into a smaller number of sounds than the number of sounds indicated in the table.

According to such an acoustic processing device, the signals of at least two target sounds can be removed by discarding the signals of the at least two target sounds and supplementing one signal of a virtual sound that integrates the signals of the at least two target sounds.

An acoustic processing device according to a ninth aspect is the acoustic processing device according to the eighth aspect, wherein the integrator supplements the signal of the virtual sound to localize the virtual sound at a position based on positions of the at least two target sounds discarded and the position of the user.

That is, the acoustic processing device according to the ninth aspect is an acoustic processing device in which a sound generated after integration is emitted from a position within a region determined based on positions of sounds to be integrated and a position of the listener.

According to such an acoustic processing device, the signal of the virtual sound can be supplemented such that the virtual sound is localized at a position based on positions of the at least two target sounds discarded and a position of the user.

An acoustic processing device according to a tenth aspect is the acoustic processing device according to the third aspect, wherein the table is created in advance to include identifiers of at least two sounds as sounds to be determined as the target sound, based on at least one of information regarding an angle of two or more sounds arriving toward the user or information regarding a level ratio of the two or more sounds arriving toward the user.

That is, the acoustic processing device according to the tenth aspect is an acoustic processing device in which the sounds to be integrated are determined based on the angle of intersection (angle formed) between two sounds when the two sounds reach the listener or the level ratio of the two sounds.

According to such an acoustic processing device, which sounds to remove can be determined by referring to a table created in advance to include identifiers of at least two sounds as sounds to be determined as the target sound, based on at least one of information regarding an angle of two or more sounds arriving toward the user or information regarding a level ratio of the two or more sounds arriving toward the user.

An acoustic processing device according to an eleventh aspect is the acoustic processing device according to any one of the first to tenth aspects, wherein the reduction processor gradually removes at least one sound signal in a time domain.

That is, the acoustic processing device according to the eleventh aspect is an acoustic processing device in which predetermined processing (subsequent processing) includes processing that smoothly transitions the integration processing from before a change to after the change when an identifier of a sound to be integrated changes over time.

According to such an acoustic processing device, at least one sound signal can be gradually removed in the time domain.

An acoustic processing device according to a twelfth aspect is the acoustic processing device according to any one of the first to eleventh aspects, wherein the reduction processor corrects the information for determining the target sound obtained by referencing the table, and determines the target sound using the information for determining the target sound that has been corrected.

That is, the acoustic processing device according to the twelfth aspect is an acoustic processing device in which the subsequent processing generates sounds that reach the listener based on content obtained by referring to the table.

According to such an acoustic processing device, the information for determining the target sound obtained by referencing the table can be corrected, and the target sound can be determined using the information for determining a more appropriate target sound that has been corrected.

An acoustic processing device according to a thirteenth aspect is the acoustic processing device according to any one of the first to twelfth aspects, wherein the table referencer converts each of the position of the user and the position of the sound source object using positions of grid points that partition the three-dimensional sound field into unit spaces of a predetermined size, and references the table using at least one of the position of the user that has been converted or the position of the sound source object that has been converted.

That is, the acoustic processing device according to the thirteenth aspect is an acoustic processing device in which the position of the object and the position of the listener are represented by positions of grid points set at an arbitrary resolution in the space.

According to such an acoustic processing device, each of the position of the user and the position of the sound source object can be converted using positions of grid points that partition the three-dimensional sound field into unit spaces of a predetermined size, and the table can be referenced using at least one of the position of the user or the position of the sound source object that have been converted.

An acoustic processing device according to a fourteenth aspect is the acoustic processing device according to any one of the first to twelfth aspects, wherein the table referencer converts each of the position of the user and the position of the sound source object using identifiers of voxels that are unit spaces partitioning the three-dimensional sound field into a plurality of sizes, and references the table using at least one of the position of the user that has been converted or the position of the sound source object that has been converted.

That is, the acoustic processing device according to the fourteenth aspect is an acoustic processing device in which the position of the object and the position of the listener are represented by identifiers of voxels of arbitrary size in the space.

According to such an acoustic processing device, each of the position of the user and the position of the sound source object can be converted using identifiers of voxels that are unit spaces partitioning the three-dimensional sound field into a plurality of sizes, and the table can be referenced using at least one of the position of the user or the position of the sound source object that have been converted.

An acoustic processing device according to a fifteenth aspect is the acoustic processing device according to the thirteenth or fourteenth aspect, wherein a size of the unit spaces is changed based on at least one of a storage capacity or a processing capability of the acoustic processing device.

That is, the acoustic processing device according to the fifteenth aspect is an acoustic processing device in which the spacing of the grid points or the size of the voxels is determined based on the storage capacity or processing capability of the device in which the acoustic processing device is implemented.

According to such an acoustic processing device, after setting the size of the unit spaces based on at least one of storage capacity or processing capability of the acoustic processing device, the table can be referenced using at least one of the position of the user or the position of the sound source object that have been converted using positions of grid points or identifiers of voxels.

An acoustic processing device according to a sixteenth aspect is the acoustic processing device according to any one of the first to fifteenth aspects, further including a table setter that sets the table when the acoustic processing device is initialized.

That is, the acoustic processing device according to the sixteenth aspect is an acoustic processing device in which the table is set when the acoustic processing device is initialized.

According to such an acoustic processing device, the table set when the acoustic processing device is initialized can be used in subsequent processing.

An acoustic processing device according to a seventeenth aspect is the acoustic processing device according to the sixteenth aspect, wherein the table setter further updates at least a portion of the table when information for updating the table is obtained.

That is, the acoustic processing device according to the seventeenth aspect is an acoustic processing device in which part or all of the contents of the table are updated according to information obtained while the acoustic processing device is operating.

According to such an acoustic processing device, when information for updating the table is obtained, the at least partially updated table can be used in subsequent processing.

An acoustic processing device according to an eighteenth aspect is the acoustic processing device according to the second aspect, wherein the reduction processor integrates a computation amount in descending order of the priorities included in the table, and determines each sound at or below a rank at which the computation amount exceeds a predetermined computation amount as the target sound.

That is, the acoustic processing device according to the eighteenth aspect is an acoustic processing device in which predetermined processing is applied to sounds with lower priorities under a constraint of fitting within a predetermined amount of computation.

According to such an acoustic processing device, sounds that cannot be processed within a processing amount that is within the predetermined amount of computation can be removed.

An acoustic processing device according to a nineteenth aspect is the acoustic processing device according to any one of the first to eighteenth aspects, wherein when there are a plurality of the users present or a plurality of the sound source objects present, the table referencer references, from among a plurality of the tables, one table that corresponds to a combination of the position of the user and the position of the sound source object.

That is, the acoustic processing device according to the nineteenth aspect is an acoustic processing device in which, when a plurality of objects, a plurality of listeners, or both are present, a table corresponding to the combination of object and listener is used.

According to such an acoustic processing device, when a plurality of users or a plurality of sound source objects are present, one table that corresponds to a combination of the position of the user and the position of the sound source object can be referenced from among a plurality of tables.

An acoustic processing method according to a twentieth aspect is an acoustic processing method executed by a computer, the acoustic processing method including: obtaining sound information including: an acoustic signal; and information on a position of a sound source object in a three-dimensional sound field; referencing a table that associates at least one of a position of a user in the three-dimensional sound field or a position of the sound source object with information for determining a target sound; and determining the target sound using the information for determining the target sound obtained by referencing the table, and generating an output sound signal excluding a signal of the target sound determined, by removing the signal of the target sound from among signals of a plurality of sounds generated for use in generating the output sound signal from the acoustic signal included in the sound information obtained.

According to this, advantageous effects similar to those of the acoustic processing device described above can be achieved.

A recording medium according to a twenty-first aspect is a non-transitory computer-readable recording medium for use in a computer, the recording medium having a computer program recorded thereon for causing the computer to execute the acoustic processing method described above.

According to this, advantageous effects similar to those of the acoustic processing method described above can be achieved using a computer.

Furthermore, these general or specific aspects may be implemented using a system, a device, a method, an integrated circuit, a computer program, or a non-transitory computer-readable recording medium such as a CD-ROM, or any combination thereof.

Hereinafter, one or more embodiments will be described in detail with reference to the drawings. Each embodiment described below presents a general or specific example. The numerical values, shapes, materials, elements, the arrangement and connection of the elements, steps, the processing order of the steps etc., shown in the following embodiment are mere examples, and do not limit the scope of the present disclosure. Among the elements described in the following one or more embodiments, those not recited in any of the independent claims are described as optional elements. Moreover, the figures are schematic diagrams and are not necessarily precise illustrations. In the figures, elements that are essentially the same share the same reference signs, and repeated description may be omitted or simplified.

In the following description, ordinal numbers such as first, second, and third may be given to elements. These ordinal numbers are given to elements in order to distinguish between the elements, and thus do not necessarily correspond to an order that has intended meaning. Such ordinal numbers may be switched as appropriate, new ordinal numbers may be given, or the ordinal numbers may be removed.

In the following description, an acoustic signal included in sound information may be described, but the acoustic signal may be expressed as an audio signal or a sound signal. Stated differently, in the present disclosure, an acoustic signal has the same meaning as an audio signal or a sound signal.

### Embodiment

### Overview

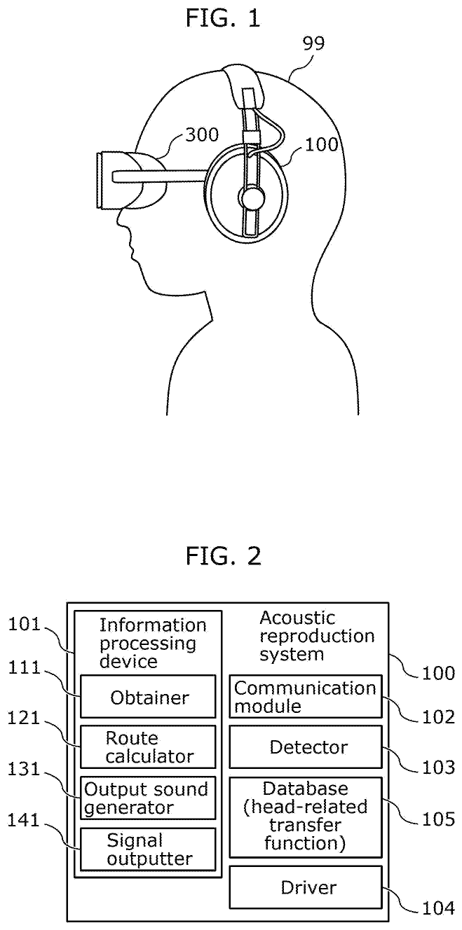

First, an overview of an acoustic reproduction system according to an embodiment will be described. FIG. 1 is a schematic diagram illustrating an example of use of an acoustic reproduction system according to the embodiment. FIG. 1 illustrates user 99 using acoustic reproduction system 100.

Acoustic reproduction system 100 illustrated in FIG. 1 is used simultaneously with stereoscopic image reproduction device 300, for example. By simultaneously viewing stereoscopic images and listening to three-dimensional sound, the images enhance the auditory sense of realism, and the sound enhances the visual sense of realism, allowing one to experience as if being at the scene where the images and sound were captured. For example, when an image (moving image) of people having a conversation is displayed, even if the localization of the sound image (sound source object) of the conversation sound is misaligned with the person's mouth, it is known that user 99 perceives it as conversation sound emitted from the person's mouth. In this manner, by combining images and sound, the position of the sound image may be corrected by visual information, thereby enhancing the sense of realism.

Stereoscopic image reproduction device 300 is an image display device worn on the head of user 99. Accordingly, stereoscopic image reproduction device 300 moves integrally with the head of user 99. For example, stereoscopic image reproduction device 300 is, as illustrated in the figure, a glasses-type device supported by the ears and nose of user 99.

Stereoscopic image reproduction device 300 changes the image to be displayed in response to the movement of the head of user 99, to cause user 99 to perceive as if he or she is moving their head within a three-dimensional image space. Stated differently, when an object within the three-dimensional image space is positioned in front of user 99, if user 99 turns to the right, the object moves to the left direction of user 99, and if user 99 turns to the left, the object moves to the right direction of user 99. Thus, stereoscopic image reproduction device 300 moves the three-dimensional image space in the opposite direction to the movement of user 99.

Stereoscopic image reproduction device 300 displays two images, each with a parallax shift, one to the left eye and the other to the right eye of user 99. User 99 can perceive the three-dimensional position of an object in the image based on the parallax shift of the displayed image. Note that when acoustic reproduction system 100 is used for the reproduction of healing sounds to induce sleep, or when user 99 uses it with their eyes closed, stereoscopic image reproduction device 300 does not need to be used simultaneously. Stated differently, stereoscopic image reproduction device 300 is not an essential element of the present disclosure. In addition to dedicated image display devices, there are cases where general-purpose portable terminals such as smartphones and tablet devices owned by user 99 are used for stereoscopic image reproduction device 300.

Such general-purpose portable terminals include various sensors for detecting the posture and movement of the terminal, in addition to a display for displaying images. Such general-purpose portable terminals also include a processor for information processing, enabling connection to a network for sending and receiving information with server devices such as cloud servers. Stated differently, stereoscopic image reproduction device 300 and acoustic reproduction system 100 can also be implemented by a combination of a smartphone and general-purpose headphones without information processing functions.

As in this example, the function for detecting head movement, the function for presenting images, the image information processing function for presentation, the function for presenting sound, and the sound information processing function for presentation may be appropriately arranged in one or more devices to implement stereoscopic image reproduction device 300 and acoustic reproduction system 100. When stereoscopic image reproduction device 300 is unnecessary, it suffices to appropriately arrange the function for detecting head movement, the function for presenting sound, and the sound information processing function for presentation in one or more devices. For example, acoustic reproduction system 100 can also be implemented by a processing device such as a computer or smartphone that includes the sound information processing function for presentation, and headphones or the like that include the function for detecting head movement and the function for presenting sound.

Acoustic reproduction system 100 is an audio presentation device worn on the head of user 99. Accordingly, acoustic reproduction system 100 moves integrally with the head of user 99. For example, acoustic reproduction system 100 according to the present embodiment is what is known as an over-ear headphone device. Note that the embodiment of acoustic reproduction system 100 is not particularly limited and may be, for example, two in-ear devices independently worn on the left and right ears of user 99.

Acoustic reproduction system 100 changes the sound to be presented in response to the movement of the head of user 99, to cause user 99 to perceive as if he or she is moving their head within a three-dimensional sound field. Thus, as described above, acoustic reproduction system 100 moves the three-dimensional sound field in the opposite direction to the movement of user 99.

Here, when user 99 moves within the three-dimensional sound field, the position of the sound source object relative to the position of user 99 in the three-dimensional sound field changes. As a result, it is necessary to generate output sound signals for reproduction by performing calculation processing based on the position of the sound source object and user 99 each time user 99 moves. Since such processes normally requires an enormous amount of processing, in the present disclosure, from the perspective of reducing the amount of processing, an output sound signal is generated and output in which a plurality of sound signals constituting the output sound signal to be subjected to convolution of the head-related transfer function are reduced. As a result, the number of sound signals subjected to convolution of the head-related transfer function is reduced, and thus a significant reduction in the processing amount is expected. In such cases, if the sound signals to be removed are determined by performing additional calculations, the processing amount increases by the amount of processing for the additional calculations, and thus it is preferable to determine which sound signals to remove using calculations that are as simple as possible. Therefore, in the present disclosure, the determination of which sound signals to remove is performed using only simple calculations by referring to a table calculated in advance. In this way, in the present disclosure, sounds to remove can be appropriately determined using only simple additional calculations, and the effect of reducing the processing amount obtained by reducing the sound signals can be made more pronounced.

### Structure

Next, a configuration of acoustic reproduction system 100 according to the present embodiment will be described with reference to FIG. 2. FIG. 2 is a block diagram illustrating the functional configuration of an acoustic reproduction system according to the embodiment.

As illustrated in FIG. 2, acoustic reproduction system 100 according to the present embodiment includes information processing device 101, communication module 102, detector 103, driver 104, and database 105.

Information processing device 101 is one example of an acoustic processing device, and is a computing device for executing various types of signal processing in acoustic reproduction system 100. Information processing device 101 includes a processor and memory, such as in a computer, and is implemented by the processor executing a program stored in the memory. The functions related to each functional element described below are realized by executing this program.

Information processing device 101 includes obtainer 111, route calculator 121, output sound generator 131, and signal outputter 141. Each functional element included in information processing device 101 will be described in detail below along with details regarding configurations other than information processing device 101.

Communication module 102 is an interface device for receiving input of sound information to acoustic reproduction system 100. For example, communication module 102 includes an antenna and a signal converter, and receives sound information from an external device via wireless communication. More specifically, communication module 102 receives, via the antenna, a wireless signal indicating sound information converted into a format for wireless communication, and reconverts the wireless signal into sound information using the signal converter. In this way, acoustic reproduction system 100 obtains sound information from the external device via wireless communication. Sound information obtained by communication module 102 is obtained by obtainer 111. In this way, obtainer 111 is one example of a sound obtainer. The sound information is input to information processing device 101 as described above. Communication between acoustic reproduction system 100 and the external device may be wired communication.

The sound information obtained by acoustic reproduction system 100 is, for example, encoded in a predetermined format such as MPEG-H 3D Audio (ISO/IEC 23008-3). As one example, encoded sound information includes information about reproduced sound that is reproduced by acoustic reproduction system 100 and information about a localization position when the sound image of the sound is localized at a predetermined position in a three-dimensional sound field (i.e., the sound is perceived as arriving from a predetermined direction). Sound information can also be interpreted as information about the sound source object. Stated differently, the sound information includes a position of the sound source object in the three-dimensional sound field and sound produced by the sound source object.

The sound information is obtained as input data as described above, and includes an audio signal (acoustic signal), which is information about reproduced sound, and information about the position of the sound source object in the three-dimensional sound field, which is other information. The other information may include information for defining the three-dimensional sound field. Therefore, there may be cases where the other information is collectively referred to as information related to space (spatial information), which includes information about the position of the sound for defining the source object and information three-dimensional sound field. When viewed from the perspective of the audio signal, the input data can be said to be sound information in which other information (metadata) is attached to the audio signal. When viewed from the perspective of the spatial information, the input data can be said to be information in which the audio signal is attached to the spatial information. Alternatively, the input data may be considered as sound space information, as it encompasses both of these aspects.

As one specific example, the sound information includes information related to a plurality of sounds including a first reproduced sound and a second reproduced sound, and the sound images are localized so that when each sound is reproduced, they are perceived as sounds arriving from different positions in a three-dimensional sound field. Therefore, the sound source object of the first reproduced sound is localized at a first position in the three-dimensional sound field, and the sound source object of the second reproduced sound is localized at a second position in the three-dimensional sound field. In this way, the sound information may include a plurality of sounds. Stated differently, the sound information may include a plurality of audio signals corresponding to the first reproduced sound and the second reproduced sound, respectively, and positions of a plurality of sound source objects at a first position and a second position that correspond one-to-one with the plurality of audio signals.

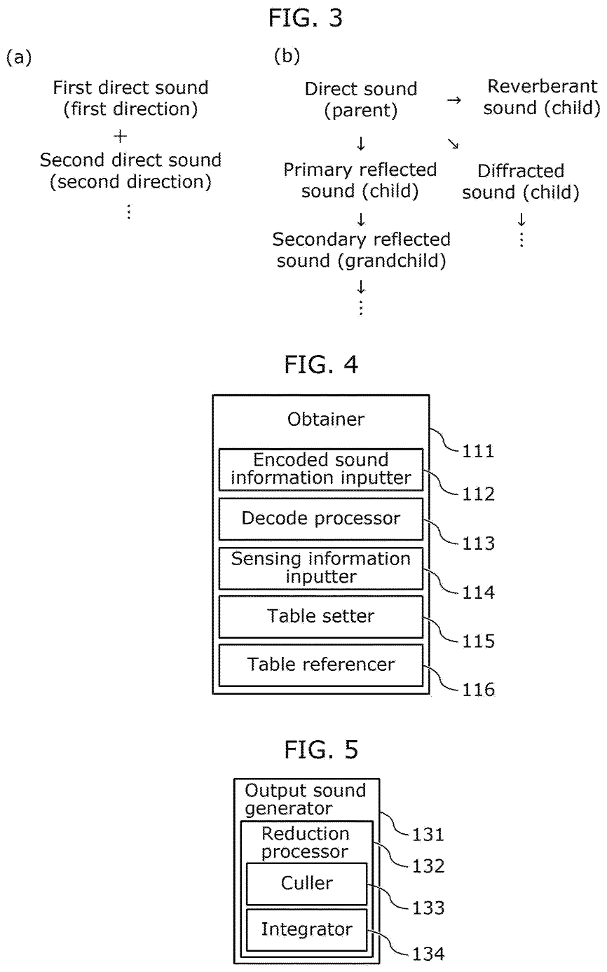

FIG. 3 is a diagram for explaining one example of an audio signal according to an embodiment of the present disclosure. For example, as illustrated in (a) in FIG. 3, the sound information may include an audio signal of a first direct sound arriving at the position of user 99 from a first position (from a first direction) in advance, and an audio signal of a second direct sound arriving at the position of user 99 from a second position (from a second direction). Note that the sound information immediately after being obtained may include only information about the reproduced sound. In such cases, information related to the predetermined position may be separately obtained, and subsequent processing may be performed when such information is collected. As described above, the sound information includes first sound information related to the first reproduced sound and second sound information related to the second reproduced sound, but a plurality of items of sound information separately including these may be obtained respectively and simultaneously reproduced (that is, treated as one item of sound information) to localize sound images at different positions in the three-dimensional sound field and cause reproduced sounds to arrive from different directions.

Alternatively, the sound information may include a plurality of audio signals and a position of one sound source object that corresponds many-to-one with the plurality of audio signals. For example, such sound information is used in situations where a plurality of reproduced sounds are emitted from a certain sound source object. For example, each of the plurality of audio signals corresponds to direct sound that arrives directly from the position of the sound source object to the position of user 99, and secondary sound (sound generated by indirect propagation) that occurs along with the direct sound and arrives via a path different from the direct sound.

For example, as illustrated in (b) in FIG. 3, the sound information immediately after being obtained includes an audio signal related to direct sound, and is converted into sound information including audio signals of reverberant sound, primary reflected sound, diffracted sound, and the like by conversion processing that calculates secondary sounds. In the conversion processing that calculates this secondary sound, information on the conditions of the spatial environment of the three-dimensional sound field (for example, position of objects in the three-dimensional sound field, reflection, diffraction characteristics, etc.) is used. Thus, secondary sound is computationally generated from sound information related to one reproduced sound, based on the conditions of the spatial environment of the three-dimensional sound field, and therefore is not included in the sound information immediately after being obtained, and sound information including these secondary sounds is generated by conversion processing that calculates secondary sounds. From one secondary sound, another secondary sound may also be generated by the propagation of that secondary sound. Note that the information on the conditions of the spatial environment is a part of the spatial information, and may be obtained together with the audio signal by the input sound information. The audio signal and the spatial information may be obtained separately. Stated differently, the sound information may be obtained from a single file or bitstream, or may be obtained separately from a plurality of files or bitstreams. For example, the audio signal and the spatial information may be obtained from separate files or bitstreams, or each of the audio signal and the spatial information may be obtained from a plurality of files or bitstreams.

In the example of (b) in FIG. 3, generation of a secondary reflected sound from a primary reflected sound is illustrated. As illustrated in the figure, these secondary sounds are assigned tags that enable identification of mutual relationships such as parent, child, and grandchild, as information regarding the genealogy (in other words, generation lineage) of the generation relationship from the direct sound. Alternatively, when the direct sound is designated as generation 0, the generation number may be quantified as generation 1 to which the primary reflected sound belongs, generation 2 to which the secondary reflected sound belongs, and so on. Note that how many generations of generation from the direct sound are permitted may be settable according to the scale of computational resources.

Thus, the form of the input sound information is not particularly limited, and acoustic reproduction system 100 may include obtainer 111 corresponding to various forms of sound information.

Here, one example of obtainer 111 will be described with reference to FIG. 4. FIG. 4 is a block diagram illustrating the functional configuration of an obtainer according to the embodiment. As illustrated in FIG. 4, obtainer 111 according to the present embodiment includes, for example, encoded sound information inputter 112, decode processor 113, sensing information inputter 114, table setter 115, and table referencer 116.

Encoded sound information inputter 112 is a processor into which encoded sound information obtained by obtainer 111 is input. Encoded sound information inputter 112 outputs the input sound information to decode processor 113. Decode processor 113 is a processor that generates reproduced sound included in the sound information and a position of the sound source object in a format to be used in subsequent processing by decoding the sound information output from encoded sound information inputter 112. Sensing information inputter 114 will be described below along with the function of detector 103.

Detector 103 is for detecting the movement speed of the head of user 99. Detector 103 includes a combination of various sensors used for detecting movement, such as a gyro sensor and an acceleration sensor. In the present embodiment, detector 103 is provided in acoustic reproduction system 100, but it may be provided in an external device, such as stereoscopic image reproduction device 300 that operates in response to the movement of the head of user 99, similarly to acoustic reproduction system 100. In such cases, detector 103 need not be included in acoustic reproduction system 100. Detector 103 may be an external imaging device or the like that captures images of the movement of the head of user 99, and the movement of user 99 may be detected by processing the captured images.

Detector 103 is, for example, integrally fixed to the housing of acoustic reproduction system 100, and detects the movement speed of the housing. Acoustic reproduction system 100 including the above-mentioned housing, after being worn by user 99, moves integrally with the head of user 99, and therefore detector 103 can detect the movement speed of the head of user 99.

Detector 103 may, for example, detect a rotation amount with at least one of three mutually orthogonal axes in three-dimensional space as a rotation axis, or detect a displacement amount with at least one of the three axes as a displacement direction, as an amount of movement of the head of user 99. Detector 103 may also detect both the rotation amount and the displacement amount as the amount of movement of the head of user 99.

Sensing information inputter 114 obtains the movement speed of the head of user 99 from detector 103. More specifically, sensing information inputter 114 obtains, as the movement speed, the amount of movement of the head of user 99 detected by detector 103 per unit time. In this way, sensing information inputter 114 obtains at least one of the rotation speed or the displacement speed from detector 103. Here, the amount of movement of the head of user 99 that is obtained is used to determine the position and posture (in other words, the coordinates and orientation) of user 99 in the three-dimensional sound field. Therefore, obtainer 111 also functions as a position obtainer by means of sensing information inputter 114. In acoustic reproduction system 100, sound is reproduced by determining the relative position of the sound image object with respect to user 99 based on the determined coordinates and orientation of user 99. More specifically, the above-mentioned functions are realized by route calculator 121 and output sound generator 131.

Route calculator 121 includes a direction of arrival calculation function that calculates, based on the determined coordinates and orientation of user 99, a relative direction of arrival of the reproduced sound arriving at the position of user 99 from the position of the sound source object, and a conversion process that calculates the secondary sound described above. Therefore, route calculator 121 includes a function that calculates a propagation route from the sound source object, and calculates (i) a secondary sound arriving at the position of user 99 by indirect propagation of the reproduced sound according to the calculated propagation route of the reproduced sound and (ii) the direction of arrival of the secondary sound. The direction of arrival of the secondary sound includes additional information such as what kind of object caused the reflection in the case of reflected sound, and to what degree the attenuation rate is at the time of reflection. The additional information is included in the direction of arrival of the secondary sound calculated by the input sound information. Stated differently, the additional information is computationally generated and obtained from the sound information.

To summarize the spatial information: it includes the spatial position of the sound source object in the space (three-dimensional sound field) (information about the position of the sound source object), reflection and diffraction characteristics of sound at the sound source object (collectively, information on the conditions of the spatial environment), and additional information such as the size of the three-dimensional sound field. Based on spatial information, route calculator 121 generates secondary sounds that result from reflection or diffraction of the reproduced sound off various sound source objects. It then calculates additional information such as the direction of arrival of these secondary sounds and their volume levels after attenuation caused by the reflection or diffraction. The sound information (input data) includes spatial information in the form of metadata attached to the audio signal, and this spatial information includes, as described above, information other than the audio signal, such as information necessary for positioning the sound source object in the three-dimensional sound field by making the sound three-dimensional, and/or information used to calculate the information necessary for positioning the sound source object in the three-dimensional sound field by making the sound three-dimensional.

Route calculator 121 may be realized by any process as long as it can calculate the direction of arrival of the reproduced sound when the reproduced sound reaches the user as direct sound, and calculate the secondary sound arriving at the position of user 99 by secondary propagation of the reproduced sound, together with its direction of arrival. Route calculator 121 determines, from which direction in the three-dimensional sound field to cause user 99 to perceive the reproduced sound and secondary sound as arriving, based on the coordinates and orientation of user 99, and processes the sound information such that, when the output sound signal is reproduced, it is perceived as such a sound.

Output sound generator 131 is a processor that generates an output sound signal by processing information related to reproduced sound included in the sound information.

Here, one example of output sound generator 131 will be described with reference to FIG. 5. FIG. 5 is a block diagram illustrating the functional configuration of an output sound generator according to the embodiment. As illustrated in FIG. 5, output sound generator 131 according to the present embodiment includes, for example, reduction processor 132, and reduction processor 132 includes culler 133 and integrator 134.

Reduction processor 132 is a processor that reduces certain sound signals. Through processing of sound information by route calculator 121 and the like, a plurality of sound signals are generated representing several sounds until sound from a certain sound source object arrives at user 99. These sounds include direct sound as well as indirect sounds such as reverberant sound, reflected sound (primary, secondary, and subsequent higher-order), and diffracted sound. Reduction processor 132 determines, from among these plurality of sound signals, those sound signals that are unlikely to produce an audible difference even if removed, that is, sound signals whose degradation is difficult for user 99 to perceive, and removes those signals.

Reduction processor 132 uses culler 133 to stop generation of sound signals, or performs culling processing that discards generated sound signals, thereby preventing those sound signals from being included in subsequent output sound signals. Culler 133 is thus a processor that discards specific sound signals that have been determined as sounds to remove. Note that discarding here refers to discarding in a broad sense that also includes discarding of signals by stopping generation itself.

Reduction processor 132 uses integrator 134 to discard two or more sound signals, and instead performs integration processing that generates one or more virtual sounds that virtually replace the two or more sounds by integrating the discarded sound signals into a smaller number of virtual sounds, thereby preventing those two or more sound signals from being included in subsequent output sound signals, and instead causing a smaller number of virtual sound signals to be included in subsequent output sound signals. Integrator 134 is thus a processor that discards specific two or more sound signals that have been determined as sounds to remove, and instead generates a smaller number of virtual sound signals to replace them.

Here, reduction processor 132 determines specific sounds to remove based on the table prepared and referenced by table setter 115 and table referencer 116 illustrated in FIG. 4.

Table setter 115 obtains a table from an external device, or sets a table by table generation processing, and stores the table in a storage or the like (not illustrated). The table set by table setter 115 is a database that associates at least one of the position of user 99 in the three-dimensional sound field or the position of the sound source object with information for determining target sounds. Table setter 115 sets a table received from an external source as a table for use by reduction processor 132, or when information for updating a table is obtained, updates an already-set table using that information, thereby setting the table for use by reduction processor 132 to be updated before and after.

Table referencer 116 is a processor that obtains information for determining target sounds by referring to the table. For example, by querying (i.e., referencing) the table with the position of user 99 and the position of the sound source object as arguments, information for determining sounds to be removed can be obtained as a response. Information for determining sounds to be removed may be information that directly indicates the sounds to remove, or may be information that indirectly indicates the sounds to remove by being subjected to calculation processing using the information for determining the sounds to remove. Information for determining target sounds will be described in greater detail in the examples described later.

We will now refer again to FIG. 2. Output sound generator 131 obtains the head-related transfer function used for generating the output sound signal from database 105. Database 105 is an information storage device that serves a dual function, namely, as a memory device for storing information and also as a storage controller that reads out stored information and outputs it to an external component. Database 105 stores the head-related transfer function for each direction of arrival to user 99. Included in database 105 is a set of general-purpose head-related transfer functions that can be used for everyone, or a set of head-related transfer functions optimized for user 99 individually, or a set of head-related transfer functions that are publicly available. Database 105 receives a query from output sound generator 131 specifying the direction of arrival, and outputs the head-related transfer function corresponding to that direction of arrival to output sound generator 131. Output sound generator 131 may also output all sets of head-related transfer functions or output characteristics of the head-related transfer function set itself.

Signal outputter 141 is a functional element that outputs the generated output sound signal to driver 104. Signal outputter 141 generates a waveform signal by performing digital-to-analog signal conversion based on the output sound signal, causes driver 104 to generate sound waves based on the waveform signal, and presents sound to user 99. Driver 104 includes, for example, a diaphragm and a driving mechanism such as a magnet and a voice coil. Driver 104 operates the driving mechanism in accordance with the waveform signal, and causes the diaphragm to vibrate via the driving mechanism. In this way, driver 104 generates sound waves by vibrating the diaphragm in accordance with the output sound signal (meaning to “reproduce” the output sound signal, that is, user 99 perceiving it is not included in the meaning of “reproduction”), the sound waves propagate through the air and are transmitted to user 99's ears, and user 99 perceives the sound.

### Other Configuration Examples

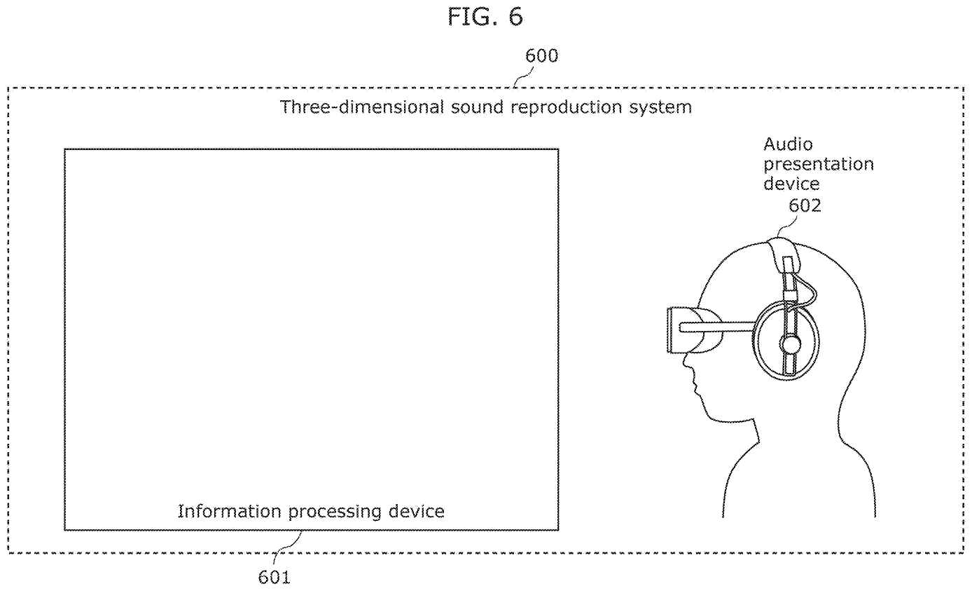

In the above example, while it has been described that acoustic reproduction system 100 according to the present embodiment is an audio presentation device and includes information processing device 101, communication module 102, detector 103, database 105, and driver 104, the functions of acoustic reproduction system 100 may be implemented by a plurality of devices or may be implemented by a single device. Specifically, this will be described with reference to FIG. 6 through FIG. 14. FIG. 6 through FIG. 14 are diagrams for explaining another example of an acoustic reproduction system according to an embodiment.

For example, information processing device 601 may be included in audio presentation device 602, and audio presentation device 602 may perform both acoustic processing and sound presentation. The acoustic processing described in the present disclosure may be divided between information processing device 601 and audio presentation device 602 and performed, or a server connected via a network to information processing device 601 or audio presentation device 602 may perform part or all of the acoustic processing described in the present disclosure.

Although the naming “information processing device” 601 is used in the above description, when information processing device 601 performs acoustic processing by decoding a bitstream generated by encoding at least a portion of data of an audio signal or spatial information used for acoustic processing, information processing device 601 may be called a decoding device, or acoustic reproduction system 100 (i.e., three-dimensional sound reproduction system 600 in the figures) may be called a decoding processing system.

Here, an example in which acoustic reproduction system 100 functions as a decoding processing system will be described.

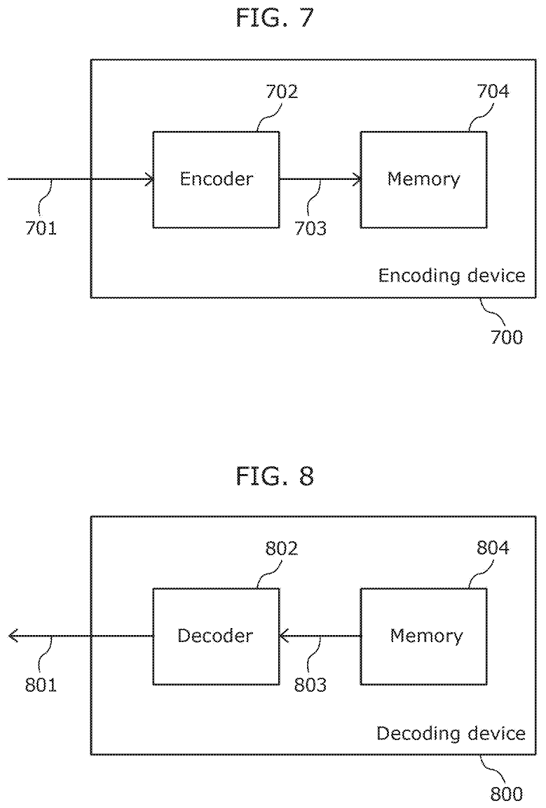

Encoding Device Example FIG. 7 is a functional block diagram illustrating the configuration of encoding device 700, which is one example of an encoding device of the present disclosure.

Input data 701 is data to be encoded that includes spatial information and/or an audio signal to be input to encoder 702. The spatial information will be described in greater detail later.

Encoder 702 encodes input data 701 to generate encoded data 703. Encoded data 703 is, for example, a bitstream generated by the encoding process.

Memory 704 stores encoded data 703. Memory 704 may be, for example, a hard disk or a solid-state drive (SSD), or may be any other type of memory device.

Although a bitstream generated by the encoding process was given as one example of encoded data 703 stored in memory 704 in the above description, encoded data 703 may be data other than a bitstream. For example, encoding device 700 may store, in memory 704, converted data generated by converting the bitstream into a predetermined data format. The data after conversion may be, for example, a file storing one or a plurality of bitstreams or a multiplexed stream. Here, the file is, for example, a file having a file format such as ISOBMFF (ISO Base Media File Format). Encoded data 703 may be in the form of a plurality of packets generated by dividing the above-mentioned bitstream or file. When the bitstream generated by encoder 702 is to be converted into data different from the bitstream, encoding device 700 may include a converter not shown in the figure, or may perform the conversion process using a central processing unit (CPU).

### Decoding Device Example

FIG. 8 is a functional block diagram illustrating the configuration of decoding device 800, which is one example of a decoding device of the present disclosure.

Memory 804 stores, for example, the same data as encoded data 703 generated by encoding device 700. Memory 804 reads the stored data and inputs it as input data 803 to decoder 802. Input data 803 is, for example, a bitstream to be decoded. Memory 804 may be, for example, a hard disk or an SSD, or may be any other type of memory device.

Decoding device 800 may use, as input data 803, converted data generated by converting the data read from memory 804, rather than directly using the data stored in memory 804 as input data 803. The data before conversion may be, for example, multiplexed data storing one or a plurality of bitstreams. Here, the multiplexed data may be, for example, a file having a file format such as ISOBMFF. Pre-conversion data may be in the form of a plurality of packets generated by dividing the above-mentioned bitstream or file. When converting data different from the bitstream read from memory 804 into a bitstream, decoding device 800 may include a converter not shown in the figure, or may perform the conversion process using a CPU.

Decoder 802 decodes input data 803 to generate audio signal 801 to be presented to a listener.

### Another Example of Encoding Device

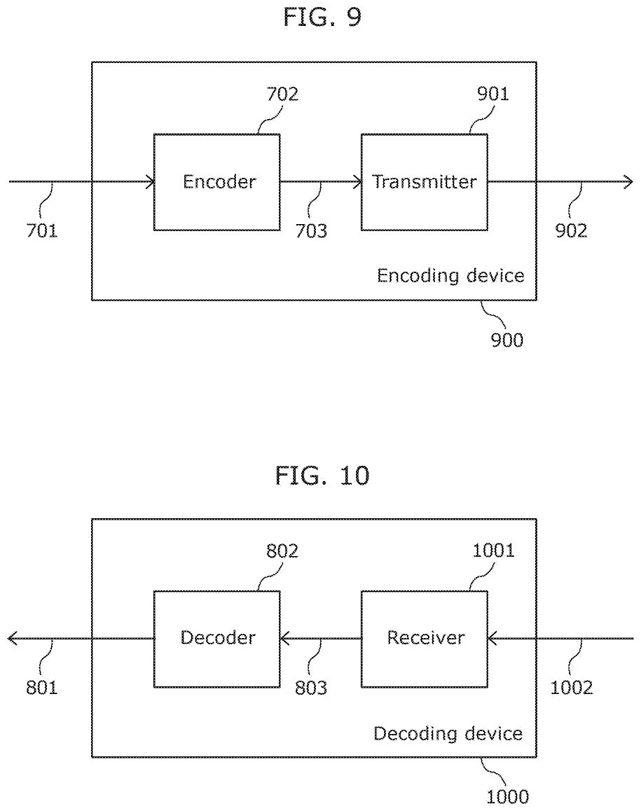

FIG. 9 is a functional block diagram illustrating the configuration of encoding device 900, which is another example of an encoding device of the present disclosure. In FIG. 9, the same reference numerals are assigned to configurations having the same functions as those in FIG. 7, and repeated explanation of these configurations will be omitted.

Encoding device 900 differs from encoding device 700 in that while encoding device 700 includes memory 704 that stores encoded data 703, encoding device 900 includes transmitter 901 that transmits encoded data 703 to an external destination.

Transmitter 901 transmits transmission signal 902 to another device or server based on encoded data 703 or data in another data format generated by converting encoded data 703. The data used for generating transmission signal 902 is, for example, the bitstream, multiplexed data, file, or packet explained in regard to encoding device 700.

### Another Example of Decoding Device

FIG. 10 is a functional block diagram illustrating the configuration of decoding device 1000, which is another example of a decoding device of the present disclosure. In FIG. 10, the same reference numerals are assigned to configurations having the same functions as those in FIG. 8, and repeated explanation of these configurations will be omitted. Decoding device 1000 differs from decoding device 800 in that while decoding device 800 reads input data 803 from memory 804, decoding device 1000 includes receiver 1001 that receives input data 803 from an external source.

Receiver 1001 receives reception signal 1002 thereby obtaining reception data, and outputs input data 803 to be input to decoder 802. The reception data may be the same as input data 803 input to decoder 802, or may be data in a data format different from input data 803. When the reception data is data in a data format different from input data 803, receiver 1001 may convert the reception data to input data 803, or a converter not shown in the figure or a CPU included in decoding device 1000 may convert the reception data to input data 803. The reception data is, for example, the bitstream, multiplexed data, file, or packet explained in regard to encoding device 900.

### Explanation of Functions of Decoder

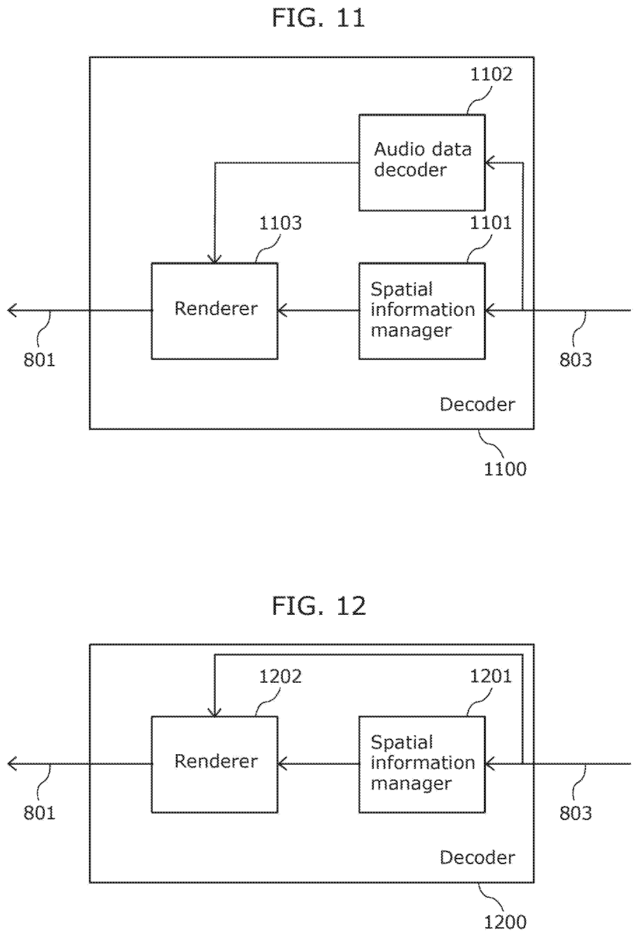

FIG. 11 is a functional block diagram illustrating the configuration of decoder 1100, which is one example of decoder 802 in FIG. 8 or FIG. 10.

Input data 803 is an encoded bitstream and includes encoded audio data, which is an encoded audio signal, and metadata used for acoustic processing.

Spatial information manager 1101 obtains metadata included in input data 803, and analyzes the metadata. The metadata includes information describing elements placed in the sound space that act on sounds. Spatial information manager 1101 manages spatial information necessary for acoustic processing obtained by analyzing the metadata, and provides the spatial information to renderer 1103. Note that in the present disclosure, the information used for acoustic processing is referred to as spatial information, but this information may be referred to be some other name. The information used for this acoustic processing may be referred to as, for example, sound space information or scene information. When the information used for acoustic processing changes over time, the spatial information input to renderer 1103 may be referred to as a spatial state, a sound space state, a scene state, or the like.

The spatial information may be managed per sound space or per scene. For example, when expressing different rooms as virtual spaces, each room may be managed as a scene of a different sound space, or even for the same space, the spatial information may be managed as different scenes depending on the scene being expressed. In the management of spatial information, an identifier for identifying (distinguishing between) each item of spatial information may be assigned. The spatial information data may be included in a bitstream, which is one form of input data 803, or the bitstream may include an identifier of the spatial information, and the spatial information data may be obtained from somewhere other than the bitstream. When the bitstream includes only the identifier of the spatial information, at the time of rendering, the spatial information data stored in the memory of the acoustic signal processing device or in an external server may be obtained as input data using the identifier of the spatial information.

Note that the information managed by spatial information manager 1101 is not limited to information included in the bitstream. For example, input data 803 may include data indicating characteristics or structure of a space obtained from a VR or AR software application or server as data not included in the bitstream. For example, input data 803 may include data indicating characteristics or a position of a listener or object as data not included in the bitstream. Input data 803 may include information obtained by a sensor included in a terminal that includes the decoding device as information indicating the position of the listener, or information indicating the position of the terminal estimated based on information obtained by the sensor. That is, spatial information manager 1101 may communicate with an external system or server and obtain spatial information and the position of the listener. Spatial information manager 1101 may obtain clock synchronization information from an external system and execute a process to synchronize with the clock of renderer 1103. The space in the above explanation may be a virtually formed space, that is, a VR space, or it may be a real space or a virtual space corresponding to a real space, that is, an AR space or a mixed reality (MR) space. The virtual space may be called a sound field or sound space. The information indicating position in the above description may be information such as coordinate values indicating a position in space, or may be information indicating a relative position with respect to a predetermined reference position, or may be information indicating movement or acceleration of a position in space.

Audio data decoder 1102 decodes encoded audio data included in input data 803 to obtain an audio signal.

The encoded audio data obtained by three-dimensional sound reproduction system 600 is, for example, a bitstream encoded in a predetermined format such as MPEG-H 3D Audio (ISO/IEC 23008-3). MPEG-H 3D Audio is merely one example of an encoding method that can be used when generating encoded audio data included in the bitstream, and the bitstream may include encoded audio data encoded using other encoding methods. For example, the encoding method used may be a lossy codec such as MP3 (MPEG-1 Audio Layer-3), AAC (Advanced Audio Coding), WMA (Windows Media Audio), AC3 (Audio Codec-3), or Vorbis, or may be a lossless codec such as ALAC (Apple Lossless Audio Codec) or FLAC (Free Lossless Audio Codec), or any other encoding method other than those mentioned above may be used. For example, PCM (Pulse Code Modulation) data may be one type of encoded audio data. In such cases, the decoding process may, for example, when the number of quantization bits of PCM data is N, convert the N-bit binary number into a numerical format (for example, floating-point format) that can be processed by renderer 1103.

Renderer 1103 receives an audio signal and spatial information as inputs, applies acoustic processing to the audio signal using the spatial information, and outputs acoustic-processed audio signal 801.

Before starting rendering, spatial information manager 1101 reads metadata of the input signal, detects rendering items such as objects or sounds specified by the spatial information, and transmits the detected rendering items to renderer 1103. After rendering starts, spatial information manager 1101 obtains the temporal changes in the spatial information and the listener's position, and updates and manages the spatial information. Spatial information manager 1101 then transmits the updated spatial information to renderer 1103. Renderer 1103 generates and outputs an audio signal with acoustic processing added based on the audio signal included in the input data and the spatial information received from spatial information manager 1101.

The update processing of the spatial information and the output processing of the audio signal added with acoustic processing may be executed in the same thread, or spatial information manager 1101 and renderer 1103 may be allocated to respective independent threads. The update processing of the spatial information and the output processing of the audio signal added with acoustic processing may be processed in different threads, and the activation frequency of the threads may be set individually, or the processing may be executed in parallel.

By executing processing in different independent threads for spatial information manager 1101 and renderer 1103, computational resources can be preferentially allocated to renderer 1103, allowing for safe implementation even in cases of sound output processing where even slight delays cannot be tolerated, for example, sound output processing where a popping noise occurs if there is a delay of even one sample (0.02 msec). In this case, allocation of computational resources to spatial information manager 1101 is restricted. However, the update of the spatial information is a low-frequency process (for example, a process such as updating the direction of the listener's face) compared to the output processing of the audio signal. Therefore, since it is not necessarily required to respond instantaneously like the output processing of the audio signal, even if allocation of computational resources is restricted, there is no significant impact on the acoustic quality provided to the listener.

The update of the spatial information may be executed periodically at predetermined times or intervals, or may be executed when a predetermined condition is met. The update of the spatial information may be executed manually by the listener or the manager of the sound space, or may be triggered by changes in an external system. For example, when the listener operates a controller to instantly warp the position of their avatar, rapidly advance or rewind time, or when the manager of the virtual space suddenly changes the environment of the scene as a production effect, the thread in which spatial information manager 1101 is arranged may be activated as a one-time interrupt process in addition to periodic activation.

The role of the information update thread that executes the update processing of the spatial information is, for example, processing to update the position or orientation of the listener's avatar placed in the virtual space based on the position or orientation of the VR goggles worn by the listener, and updating the position of objects moving within the virtual space, and is handled within a processing thread that activates at a relatively low frequency of approximately several tens of Hz. Such processing that reflects the characteristics of direct sound may be performed in a processing thread with a low occurrence frequency. This is because the frequency at which the characteristics of direct sound change is lower than the frequency of occurrence of audio processing frames for audio output. Rather, by doing so, the computational load of this processing can be relatively reduced, and the risk of pulsive noise occurring due to unnecessarily frequent information updates can be avoided.

FIG. 12 is a functional block diagram illustrating the configuration of decoder 1200, which is another example of decoder 802 in FIG. 8 or FIG. 10.

FIG. 12 differs from FIG. 11 in that input data 803 includes an unencoded audio signal rather than encoded audio data. Input data 803 includes an audio signal and a bitstream including metadata.

Spatial information manager 1201 is the same as spatial information manager 1101 in FIG. 11, so repeated explanation is omitted.

Renderer 1202 is the same as renderer 1103 in FIG. 11, so repeated explanation is omitted.

Note that while the configuration in FIG. 12 is referred to as a decoder in the above description, it may also be called an acoustic processor that performs acoustic processing. Moreover, a device including the acoustic processor may be called an acoustic processing device rather than a decoding device. Acoustic signal processing device (information processing device 601) may be called an acoustic processing device.

### Physical Configuration of Encoding Device

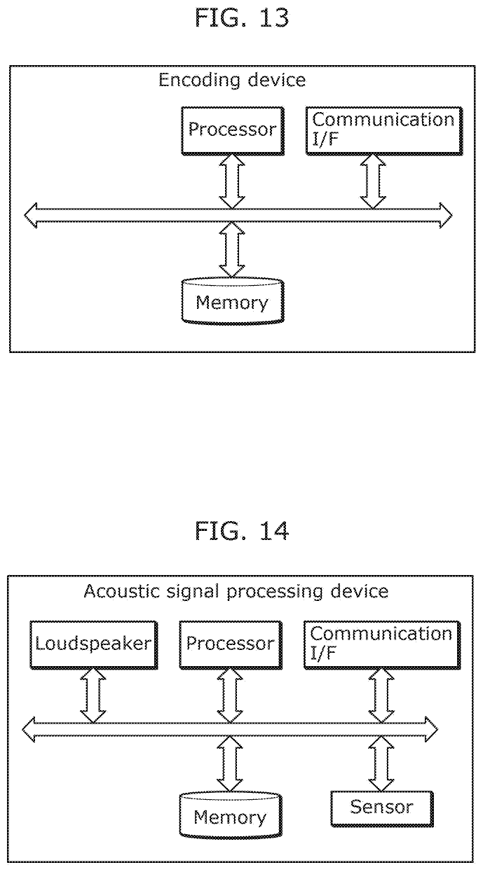

FIG. 13 illustrates one example of a physical configuration of the encoding device. The encoding device illustrated in FIG. 13 is one example of the above-mentioned encoding devices 700 and 900.

The encoding device of FIG. 13 includes a processor, memory, and a communication I/F.

The processor is, for example, a central processing unit (CPU) or digital signal processor (DSP) or graphics processing unit (GPU), and the encoding processing according to the present disclosure may be performed by the CPU or DSP or GPU executing a program stored in the memory. The processor may also be a dedicated circuit that performs signal processing on an audio signal including the encoding processing according to the present disclosure.

The memory includes, for example, random access memory (RAM) or read only memory (ROM). The memory may include magnetic storage media such as a hard disk, or semiconductor memory such as a solid-state drive (SSD). Moreover, the term “memory” may include internal memory incorporated in a CPU or GPU.

The communication I/F (interface) is, for example, a communication module corresponding to communication methods such as Bluetooth (registered trademark) or WiGig (registered trademark). The encoding device includes a function to communicate with other communication devices via the communication I/F, and transmits an encoded bitstream.

The communication module includes, for example, a signal processing circuit and an antenna that correspond to the communication method. In the above example, Bluetooth (registered trademark) or WiGig (registered trademark) were cited as examples of communication methods, but the communication method may support Long Term Evolution (LTE), New Radio (NR), or Wi-Fi (registered trademark). Moreover, the communication I/F may be a wired communication method such as Ethernet (registered trademark), Universal Serial Bus (USB), or High-Definition Multimedia Interface (HDMI) (registered trademark), rather than the wireless communication methods described above.

### Physical Configuration of Acoustic Signal Processing Device

FIG. 14 illustrates one example of a physical configuration of the acoustic signal processing device. Note that the acoustic signal processing device in FIG. 14 may be a decoding device. A portion of the configuration described here may be included in audio presentation device 602. The acoustic signal processing device illustrated in FIG. 14 is one example of the above-mentioned acoustic signal processing device 601.

The acoustic signal processing device of FIG. 14 includes a processor, memory, a communication I/F, a sensor, and a loudspeaker.

The processor is, for example, a central processing unit (CPU) or digital signal processor (DSP) or graphics processing unit (GPU), and the acoustic processing or decoding processing according to the present disclosure may be performed by the CPU or DSP or GPU executing a program stored in the memory. The processor may also be a dedicated circuit that performs signal processing on an audio signal including the acoustic processing according to the present disclosure.

The memory includes, for example, random access memory (RAM) or read only memory (ROM). The memory may include magnetic storage media such as a hard disk, or semiconductor memory such as a solid-state drive (SSD). Moreover, the term “memory” may include internal memory incorporated in a CPU or GPU.

The communication I/F (interface) is, for example, a communication module corresponding to communication methods such as Bluetooth (registered trademark) or WiGig (registered trademark). The acoustic signal processing device illustrated in FIG. 14 includes a function to communicate with other communication devices via the communication I/F, and obtains a bitstream to be decoded. The obtained bitstream is, for example, stored in memory.

The communication module includes, for example, a signal processing circuit and an antenna that correspond to the communication method. In the above example, Bluetooth (registered trademark) or WiGig (registered trademark) were cited as examples of communication methods, but the communication method may support Long Term Evolution (LTE), New Radio (NR), or Wi-Fi (registered trademark). Moreover, the communication I/F may be a wired communication method such as Ethernet (registered trademark), Universal Serial Bus (USB), or High-Definition Multimedia Interface (HDMI) (registered trademark), rather than the wireless communication methods described above.

The sensor performs sensing to estimate the position or orientation of the listener. More specifically, the sensor estimates the position and/or orientation of the listener based on one or a plurality of detection results of the position, orientation, movement, velocity, angular velocity, or acceleration of a part or all of the listener's body, such as the listener's head, and generates position information indicating the position and/or orientation of the listener. The position information may be information indicating the position and/or orientation of the listener in real space, or may be information indicating the displacement of the position and/or orientation of the listener with respect to the position and/or orientation of the listener at a predetermined time point. The position information may be information indicating the position and/or orientation relative to the three-dimensional sound reproduction system or an external device including a sensor.

The sensor may be, for example, an imaging device such as a camera or a distance measuring device such as Light Detection And Ranging (LIDAR), and may capture images of the movement of the head of the listener, and detect the movement of the head of the listener by processing the captured images. As the sensor, a device that performs position estimation using wireless communication in any frequency band, such as millimeter waves, may be used.

Note that the acoustic signal processing device illustrated in FIG. 14 may obtain position information via the communication I/F from an external device including a sensor. In such cases, the acoustic signal processing device need not include a sensor. Here, an external device refers to, for example, audio presentation device 602 described in FIG. 6, or a stereoscopic image reproduction device worn on the listener's head. The sensor includes, for example, a combination of various sensors such as a gyro sensor and an acceleration sensor.

The sensor may, for example, detect an angular velocity of rotation with at least one of three mutually orthogonal axes in the sound space as a rotation axis, or detect an acceleration of displacement with at least one of the three axes as a displacement direction, as a velocity of movement of the head of the listener.

The sensor may, for example, detect a rotation amount with at least one of three mutually orthogonal axes in the sound space as a rotation axis, or detect a displacement amount with at least one of the three axes as a displacement direction, as an amount of movement of the head of the listener. More specifically, the sensor detects the listener's position as 6DoF (position (x, y, z) and angle (yaw, pitch, roll)). The sensor includes a combination of various sensors used for detecting movement, such as a gyro sensor and an acceleration sensor.

The sensor may be implemented by a camera or a Global Positioning System (GPS) receiver, as long as it can detect the listener's position. Position information obtained by performing self-position estimation using Laser Imaging Detection and Ranging (LIDAR) or the like may be used. For example, when the audio signal reproduction system is implemented by a smartphone, the sensor is built into the smartphone.

The sensor may include a temperature sensor such as a thermocouple that detects the temperature of the acoustic signal processing device illustrated in FIG. 14, and a sensor that detects the remaining level of a battery included in or connected to the acoustic signal processing device.

The loudspeaker includes, for example, a diaphragm, a driving mechanism such as a magnet or a voice coil, and an amplifier, and presents the acoustic-processed audio signal as sound to the listener. The loudspeaker operates the driving mechanism in accordance with the audio signal amplified via the amplifier (more specifically, a waveform signal indicating the waveform of sound), and causes the diaphragm to vibrate via the driving mechanism. In this way, the diaphragm vibrating in accordance with the audio signal generates sound waves, the sound waves propagate through the air and are transmitted to the listener's ears, and the listener perceives the sound.

Note that while the acoustic signal processing device illustrated in FIG. 14 has been described as an example where it includes a loudspeaker and presents the acoustic-processed audio signal via the loudspeaker, the means for presenting the audio signal is not limited to the above configuration. For example, the acoustic-processed audio signal may be output to external audio presentation device 602 connected via a communication module. The communication performed by the communication module may be wired or wireless. As another example, the acoustic signal processing device illustrated in FIG. 14 may include a terminal that outputs an analog signal of audio, and the audio signal may be presented from earphones or the like by connecting the earphones cable to the terminal. In this case, audio presentation device 602, such as headphones, earphones, a head-mounted display, neck speakers, wearable speakers worn on the listener's head or a part of the body, or surround speakers configured with a plurality of fixed speakers, reproduces the audio signal.

### Explanation of Functions of Renderer, Example 1

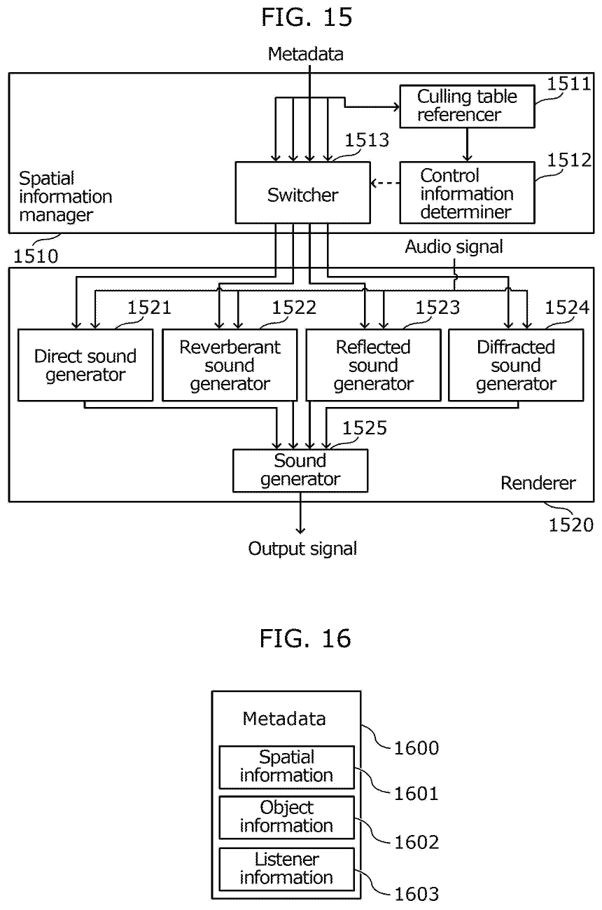

Hereinafter, Examples 1 to 3 will be described as one example of the detailed configuration of renderers 1103 and 1202 illustrated in FIG. 11 and FIG. 12. FIG. 15 through FIG. 34 are diagrams for explaining a specific example of an acoustic reproduction system according to Example 1 of the embodiment.

In Example 1, when the shape of the room that is a three-dimensional sound field, the material properties of walls used in the room (reflectance, absorptance, etc.), and the shape and material properties (same as above) of obstacles in the room are given, priorities (also referred to as priority levels) are determined in advance for a plurality of sounds such as direct sound, reflected sound, reverberant sound, and diffracted sound with respect to possible positional relationships between the listener (user 99) and sound source objects, and a culling table is created in advance as a table for culling processing. Stated differently, there is a feature of determining sounds to be removed by culling processing in the order of the priorities indicated in the table. Note that while the following description assumes culling processing as the reduction processing, integration processing may be performed as the reduction processing.

FIG. 15 will be described. FIG. 15 is a block diagram of a decoder according to the present example (i.e., renderer 1520 and spatial information manager 1510). The basic concept in the present example is to reference the culling table based on the position of the sound source object and the position of the listener, identify priorities of sounds reaching the listener at those positions, and generate sounds reaching the listener according to the priorities. This makes it possible to cancel in advance the generation of sounds having low importance (priority level) among sounds reaching the listener, enabling reduction of the amount of computation.

First, metadata is provided to the decoder. The configuration of the metadata is represented as in FIG. 16. The spatial information mainly represents information about the space that provides immersive audio to the listener, such as characteristics related to the shape of the room and material properties of walls (sound reflectance, absorptance, etc.), characteristics related to material properties of obstacles (sound reflectance, absorptance, etc.), and information about placement.

The object information mainly represents information about the position and orientation of the sound source object, and information about sounds emitted from the sound source object.

The listener information mainly represents information about the position and orientation of the listener.

The culling table is referenced based on the object position and listener position included in the metadata to obtain priorities of sounds reaching the listener. According to this priority, generation of sounds reaching the listener is performed.

Based on the priority, control information is determined for controlling whether to operate each of direct sound generator 1521, reverberant sound generator 1522, reflected sound generator 1523, and diffracted sound generator 1524, and the control information is output to switcher 1513.

The metadata is provided to each of direct sound generator 1521, reverberant sound generator 1522, reflected sound generator 1523, and diffracted sound generator 1524 via switcher 1513. According to the priority obtained by culling table referencer 1511 by referencing the culling table, control information determiner 1512 determines the control information for each generator (that is, direct sound generator 1521, reverberant sound generator 1522, reflected sound generator 1523, and diffracted sound generator 1524; the same applies hereinafter when simply referred to as “sound generator” or “generator”).

An audio signal is provided to direct sound generator 1521, reverberant sound generator 1522, reflected sound generator 1523, and diffracted sound generator 1524. The audio signal is generated by performing decoding processing on encoded audio data included in the input data using an audio data decoder not shown here, and may be provided to each of direct sound generator 1521, reverberant sound generator 1522, reflected sound generator 1523, and diffracted sound generator 1524, or audio data included in the input data may be provided to each of direct sound generator 1521, reverberant sound generator 1522, reflected sound generator 1523, and diffracted sound generator 1524.

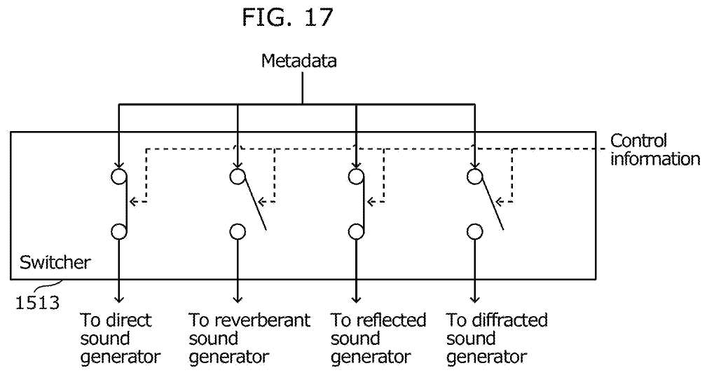

Next, switcher 1513 will be described. FIG. 17 illustrates the configuration of the switcher.

When metadata is input and a switch is turned on, the metadata is provided to the generator for which the switch is turned on. Control information indicating whether a switch is on or off is determined based on the priority information as described above. The determination method is, for example, to turn on switches for a predetermined number of generators starting from the highest priority obtained from the culling table, and turn off switches for the other generators.

Each generator for which a switch is turned on receives metadata, generates one of direct sound, reverberant sound, reflected sound, or diffracted sound, and outputs it to sound generator 1525.

Sound generator 1525 performs acoustic processing such as a head-related transfer function (HRTF) on the signals output from each generator, and outputs them as output signals. This acoustic processing performs processing adapted to the output format for the listener, such as headphones or multi-channel loudspeakers, and provides the output signal to the listener.

Note that while the decoder described above is configured with the generators in parallel, the configuration is not limited to this, and the generators may be configured in series. The series configuration will be described later.

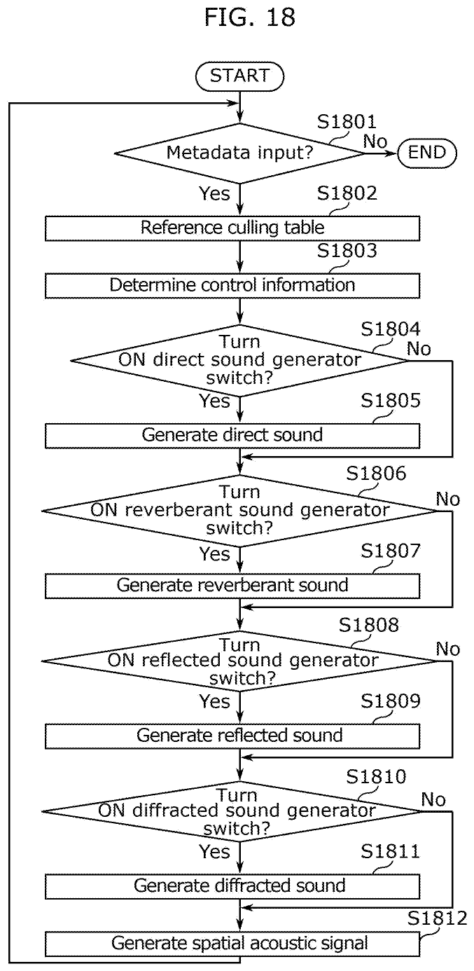

Next, FIG. 18 illustrates a flowchart of the operation of the decoder in the above configuration.

First, whether metadata has been input (whether there is an input of metadata) is determined (S1801). If metadata is input (Yes in S1801), the culling table is referenced (S1802), and if metadata is not input (No in S1801), the processing ends.

The culling table is referenced based on the positions of the listener and the sound source object (S1802) to obtain priorities of the generators.

Next, control information that specifies whether the switch of each generator is on or off is determined based on the priority information (S1803). The determination method is, for example, to turn on switches for a predetermined number of generators starting from the highest priority obtained from the culling table, and turn off switches for the other generators.

Next, the on/off state of the switch of direct sound generator 1521 is referenced (S1804), and if the switch is on (Yes in S1804), direct sound is generated (S1805), and if the switch is off (No in S1804), direct sound is not generated (S1805 is skipped).

Similarly, the switch of reverberant sound generator 1522 is referenced (S1806), and if the switch is on (Yes in S1806), reverberant sound is generated (S1807), and if the switch is off (No in S1806), reverberant sound is not generated (S1807 is skipped). The switch of reflected sound generator 1523 is referenced (S1808), and if the switch is on (Yes in S1808), reflected sound is generated (S1809), and if the switch is off (No in S1808), reflected sound is not generated (S1809 is skipped). The switch of diffracted sound generator 1524 is referenced (S1810), and if the switch is on (Yes in S1810), diffracted sound is generated (S1811), and if the switch is off (No in S1810), diffracted sound is not generated (S1811 is skipped).

Finally, spatial acoustic signal processing such as convolution processing of a head-related transfer function is performed on the generated signals to generate a spatial acoustic signal (S1812), which is output to a device used by the listener such as headphones.

The process returns to step S1801, and whether new metadata is input is determined.

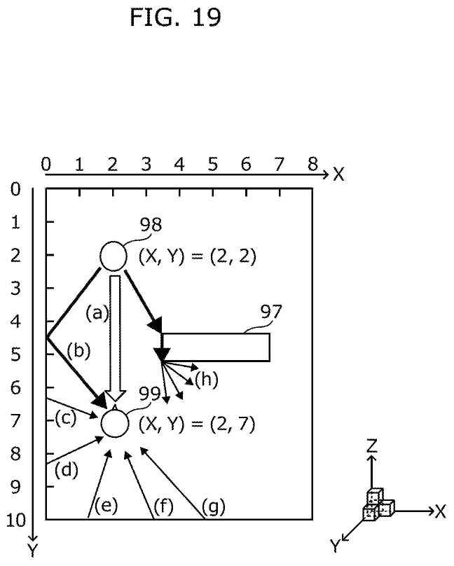

FIG. 19 will be described. FIG. 19 illustrates a conceptual diagram of a culling table.

FIG. 19 illustrates a state in which a space in which sound source object 98 and the listener (user 99) are present is divided by a three-dimensional grid. Here, assuming that a sound source object and a listener are positioned on arbitrary grid points, the culling table stores the priorities of sounds reaching the listener for the relationship between those grid points. Stated differently, here, the position of the sound source object and the position of the listener are converted to positions of grid points, and the culling table is referenced.

Taking FIG. 19 as an example, although displayed here on an X-Y plane for convenience, when the position of sound source object 98 is (X, Y)=(2, 2) and the position of the listener is (X, Y)=(2, 7), the priorities of sounds reaching the listener (direct sound (a), reverberant sounds (c) through (g), reflected sound (b), and diffracted sound (h) in the figure) are obtained by referencing the culling table. Note that obstacle 97 is illustrated in the figure as one factor that causes secondary sounds to be generated.

Note that when at least one of the sound source object or the listener is not positioned on a three-dimensional grid point, the culling table is referenced by assuming that at least one of the sound source object or the listener is positioned at the grid point closest in distance from at least one of the sound source object or the listener (by converting to the position of the grid point in that manner).

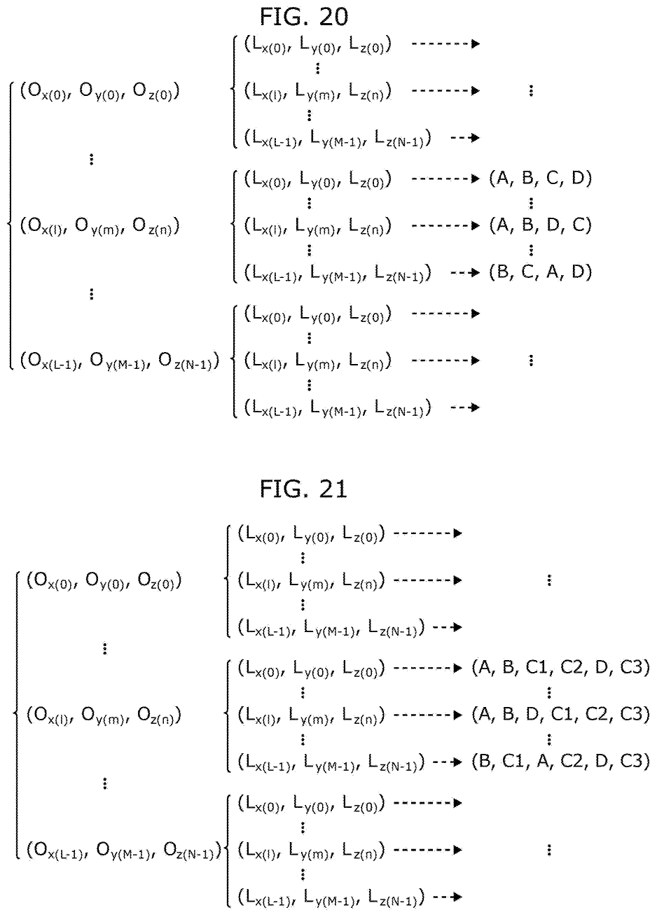

FIG. 20 will be described. FIG. 20 illustrates the configuration of a culling table. In FIG. 20, the left column indicates coordinate positions (X, Y, Z) of sound source objects, the center column indicates coordinate positions (X, Y, Z) of the listener, and the right column indicates priorities corresponding to combinations of coordinate positions of sound source objects and coordinate positions of the listener. In the priority, A indicates direct sound, B indicates reverberant sound, C indicates reflected sound, and D indicates diffracted sound, with the priority being higher toward the left and lower toward the right (descending order from left to right).

By referencing the culling table, the priority can be obtained based on the position of the sound source object and the position of the listener. For example, in FIG. 20, when the position of the sound source object is (O_{x(I)}, O_{y(m)}, O_{z(n)}) and the position of the listener is (Lₓ₍₁₎, L_{y(m)}, L_{z(n)}), the priority (A, B, D, C) is obtained. Stated differently, the priority of direct sound>reverberant sound>diffracted sound>reflected sound is obtained. L in the subscript parentheses in the figure is the number of coordinates on the X-axis, M in the subscript parentheses is the number of coordinates on the Y-axis, and N in the subscript parentheses is the number of coordinates on the Z-axis.

The culling table can be created in advance. As a specific method for this, for example, for all combinations of the position of the sound source object and the position of the listener, the direct sound, reverberant sound, reflected sound, and diffracted sound that actually reach the listener are calculated, and the priorities are determined by comparing indices that take into account auditory characteristics, such as the importance of those signals, for example, the magnitude of energy or energy corrected by auditory characteristics. In this case, although a large amount of computation is required, since the culling table can be created in advance, it is not necessary to consider limitations on hardware processing capability or real-time performance during rendering, and thus this is feasible.

Alternatively, a content creator may design part or all of the culling table to create the culling table.

The decoder may be preloaded with the culling table as part of its initialized state. In such cases, computational cost regarding the culling table can be reduced without any additional processing requirements.

Alternatively, the culling table may be obtained during initialization processing of the decoder, or the decoder may update part or all of the culling table during operation. These will be described later.

Note that while the culling table described here is designed based on both the position of the sound source object and the position of the listener, the culling table may be designed based on either the position of the sound source object or the position of the listener in order to reduce computational cost during culling table design and reduce the memory footprint of the culling table.

FIG. 21 will be described. FIG. 21 illustrates a culling table according to another embodiment. FIG. 21 illustrates a diagram similar to FIG. 20, and in this example, differs in that the culling table is configured by dividing reflected sounds into primary reflected sound C1 that strikes a wall or obstacle once and reaches the listener, secondary reflected sound C2 that strikes a wall or obstacle twice and reaches the listener, and higher-order reflected sound C3 that strikes a wall or obstacle three or more times and reaches the listener.

Since reflected sounds, excluding direct sound, have greater energy than reverberant sounds or diffracted sounds that reach the listener, configuring a culling table that accounts for secondary reflected sounds and higher can enable more appropriate culling to be performed.

In FIG. 21, the position of the sound source object and the position of the listener are referenced to obtain priorities of respective sounds reaching the listener. Sounds considered for priority determination that reach the listener include direct sound, reverberant sound, primary reflected sound, secondary reflected sound, higher-order reflected sound, and diffracted sound.

For example, in FIG. 21, when the position of the sound source object is (O_{x(I)}, O_{y(m)}, O_{z(n)}) and the position of the listener is (L_{x(L-1)}, L_{y(M-1)}, L_{z(N-1)}), the priority (B, C1, A, C2, D, C3) is obtained. Stated differently, the priority of reverberant sound>primary reflected sound>direct sound>secondary reflected sound>diffracted sound>higher-order reflected sound is obtained.

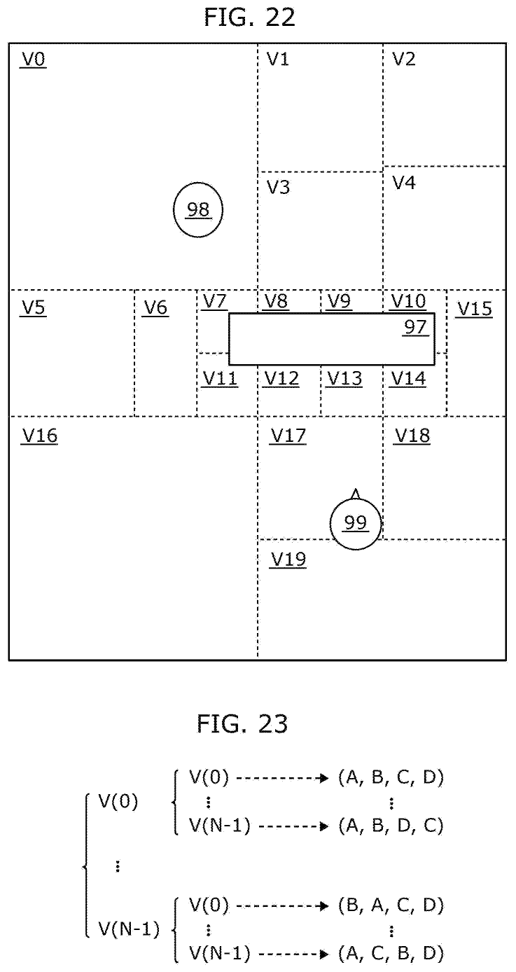

FIG. 22 and FIG. 23 will be described. In the above description, as illustrated in FIG. 19, the culling table has been defined on the premise that the space in which the sound source object and the listener are present is divided by equally-spaced grid points in three dimensions (i.e., into unit spaces of a constant size), and the sound source object and the listener are positioned on arbitrary grid points.

In the example of FIG. 22, the three-dimensional space is divided not by equally-spaced grid points but by voxels of arbitrary sizes (i.e., unit spaces of a plurality of sizes), and the culling table defines priorities of sounds reaching the listener when the sound source object and the listener are positioned at the centers of the voxels. Note that the voxels here do not necessarily need to be rectangular parallelepipeds.

The advantage of this method is that it conforms to the reality that, depending on the shape of the room or the arrangement of obstacles, there are locations where the spatial resolution of the culling table may be set coarsely, and conversely, locations where it must be set finely. For example, when there are no walls or obstacles near the sound source object or the listener, the spatial resolution of the culling table may be set coarsely. When there are walls or obstacles near the sound source object or the listener, the spatial resolution of the culling table may be set finely. By designing the culling table in consideration of such non-uniformity in the spatial resolution, the size of the culling table can be reduced, and appropriate priorities of sounds reaching the listener can be determined.

FIG. 22 illustrates, for convenience, positions of the sound source object and the listener in the X-Y plane by voxel numbers (voxel identifiers) assigned to the voxels.

Assuming that the positions of the sound source object and the listener are the positions illustrated in FIG. 22, the sound source object is regarded as being positioned at the center of voxel V0, and the listener is regarded as being positioned at the center of voxel V17, and the culling table is referenced using (V0, V17) as an index to obtain priorities of sounds reaching the listener.

FIG. 23 illustrates an example of the culling table in this case. In FIG. 23, the left column indicates identifiers of voxels at positions of sound source objects, the center column indicates identifiers of voxels at positions of the listener, and the right column indicates priorities corresponding to combinations of coordinate positions of sound source objects and coordinate positions of the listener converted with the voxel identifiers.

As illustrated in FIG. 23, priorities of the direct sound, reverberant sound, reflected sound, and diffracted sound are determined by a combination of the voxel number at which the sound source object is positioned and the voxel number at which the listener is positioned, and information on the priorities is obtained.

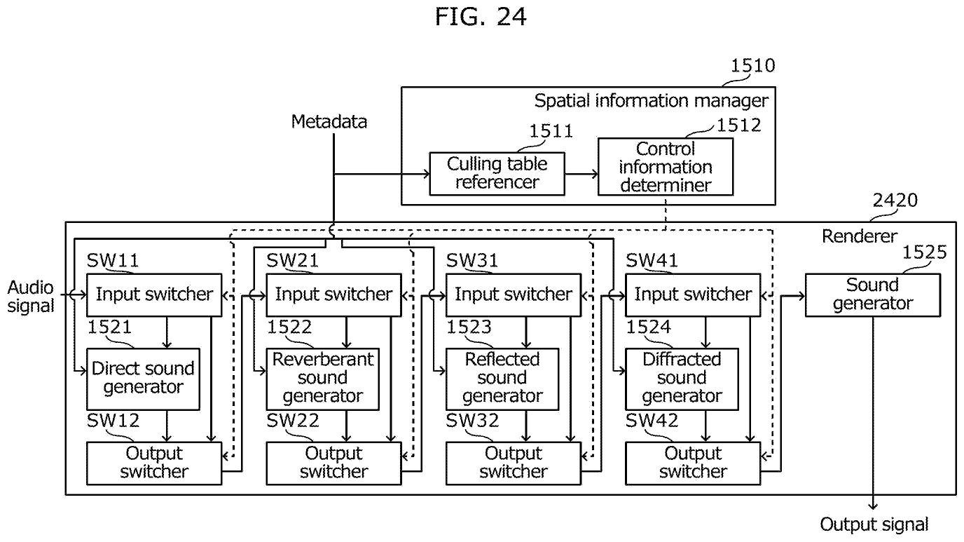

FIG. 24 will be described. FIG. 24 is a block diagram illustrating another configuration of a decoder that includes renderer 2420 instead of renderer 1520. A characteristic of this configuration is that direct sound generator 1521, reverberant sound generator 1522, reflected sound generator 1523, and diffracted sound generator 1524 are connected in series. According to this configuration, sound generated by a generator at a preceding stage affects a generator at the current stage, making it possible to provide accurate immersive audio that is closer to actual spatial acoustics.

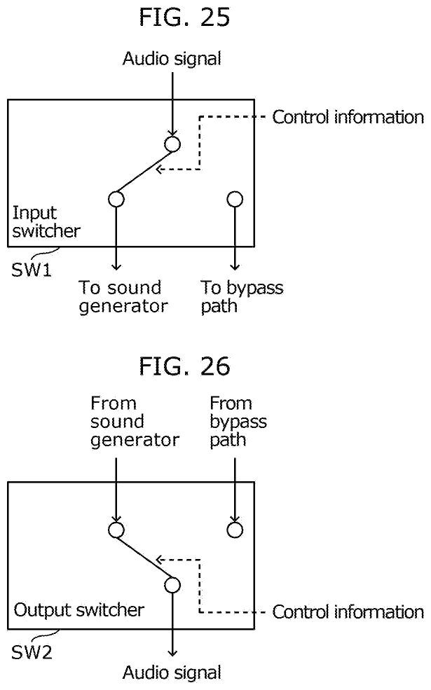

The culling table is referenced based on the position of the sound source object and the position of the listener included in the metadata to obtain priorities of sounds reaching the listener. According to this priority, input switchers SW11, SW21, SW31, and SW41, and output switchers SW12, SW22, SW32, and SW42 are controlled to generate sounds reaching the listener. Input switchers SW11, SW21, SW31, and SW41 are all configured like input switcher SW1 illustrated in FIG. 25, and output switchers SW12, SW22, SW32, and SW42 are all configured like output switcher SW2 illustrated in FIG. 26.

More specifically, input switcher SW11 at a preceding stage of direct sound generator 1521 and output switcher SW12 at a subsequent stage thereof, input switcher SW21 at a preceding stage of reverberant sound generator 1522 and output switcher SW22 at a subsequent stage thereof, input switcher SW31 at a preceding stage of reflected sound generator 1523 and output switcher SW32 at a subsequent stage thereof, and input switcher SW41 at a preceding stage of diffracted sound generator 1524 and output switcher SW42 at a subsequent stage thereof each synchronize with one another using control information provided from control information determiner 1512 to control whether to operate direct sound generator 1521, reverberant sound generator 1522, reflected sound generator 1523, and diffracted sound generator 1524.

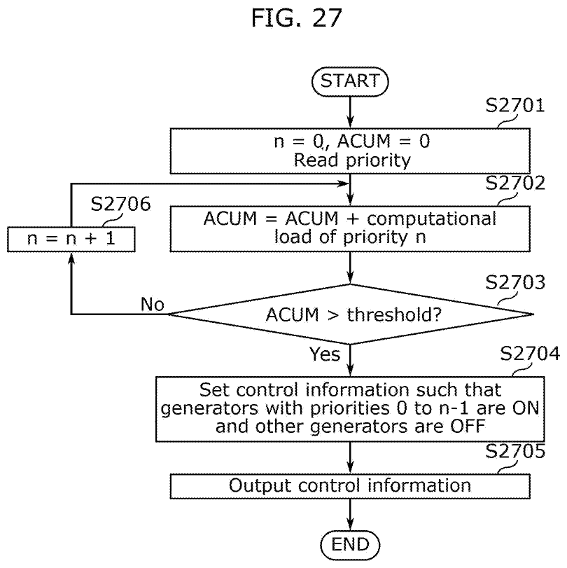

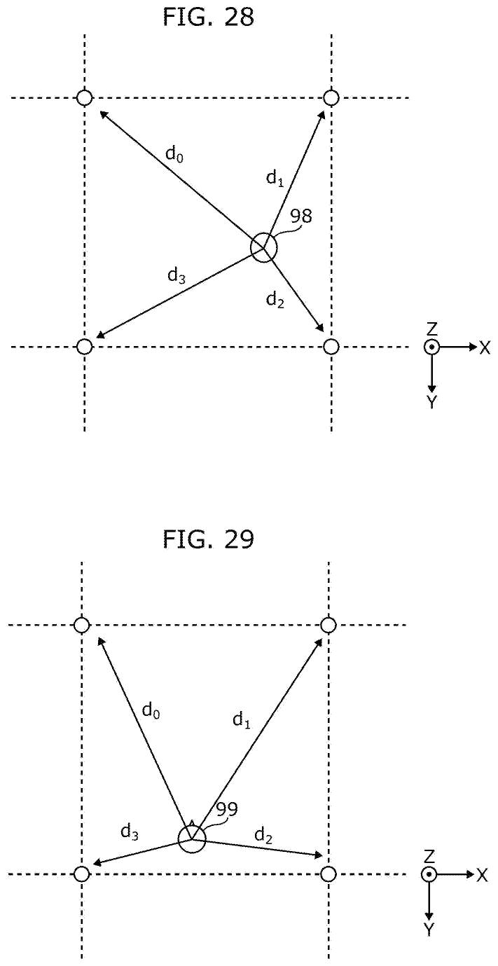

FIG. 27 will be described. In the above example, control has been described in which switches for a predetermined number of generators starting from the highest priority obtained from the culling table are turned on, and switches for the other generators are turned off. This example is characterized in that switches for generators with higher priorities that fit within a predetermined amount of computation are turned on, and switches for the other generators are turned off.

In this example, sounds reaching the listener can be preserved to the maximum extent possible while maintaining decoder computational load below a predetermined threshold. Accordingly, stable operation is possible even when the decoder is incorporated in a device with limited processing capability, and it is possible to provide immersive audio with the highest possible quality within that processing capability.

The figure illustrates a flowchart of the operation of the decoder in this example. According to the priority provided by culling table referencer 1511, control information determiner 1512 initializes the amount of computation (S2701) and then accumulates (integrates) the amounts of computation of generators with higher priorities (S2702). Each time an accumulation is performed, this accumulated value is compared with a predetermined threshold (S2703). When the accumulated value is smaller than the predetermined threshold (No in S2703), the amount of computation of the generator with the next priority is accumulated (returning to S2702 via S2706). When the accumulated value is larger (Yes in S2703), control information is set and generated such that generators with higher priorities than the most recently accumulated generator are turned on, and the other generators are turned off (S2704). Thereafter, the generated control information is output (S2705).

FIG. 28 and FIG. 29 will be described. When the sound source object or the listener is not positioned on a three-dimensional grid point, the culling table is referenced by assuming that the sound source object or the listener is positioned at the grid point closest in distance from the sound source object or the listener. However, when the culling table is designed such that spacing of the grid points assumed by the culling table is coarse in order to reduce the amount of computation, the actual position of the sound source object or the listener and the position of the grid points diverge, and there is a problem in that accurate priority information may not be obtained.

Therefore, in order to solve this problem, priority information may be obtained by using information from a plurality of grid points positioned in the vicinity of the sound source object or the listener.

A specific method will be described below. FIG. 28 illustrates a relationship between the position of the sound source object and each grid point in the vicinity, and FIG. 29 illustrates a relationship between the position of the listener and each grid point in the vicinity. Here, to simplify the explanation, the description will be limited to the X-Y plane.

When the distance between the position of the sound source object and grid point Cᵢ in the vicinity is di (FIG. 28), and the distance between the position of the listener and grid point Cⱼ in the vicinity is dⱼ (FIG. 29), the probability P(Cⱼ, Cᵢ) that the sound source object is positioned at grid point Cᵢ and the listener is positioned at grid point Cⱼ is defined as in Expression (1) below.

$$\begin{matrix}[ Math . 1 ] & \\ P ( {C}_{i} , {C}_{j} ) = P ( {C}_{i} ) \cdot P ( {C}_{j} ) & ( 1 )\end{matrix}$$

Here, P(Cⱼ) and P(Cᵢ) are calculated from the distance between the position of the sound source object or the position of the listener and each grid point using Expression (2) and Expression (3) below.

$$\begin{matrix}[ Math . 2 ] & \\ P ( {C}_{i} ) = \frac{{d}_{i}}{{\sum }_{i} {d}_{i}} & ( 2 )\end{matrix}$$

$$\begin{matrix}[ Math . 3 ] & \\ P ( {C}_{j} ) = \frac{{d}_{j}}{{\sum }_{i} {d}_{j}} & ( 3 )\end{matrix}$$

When the direct sound is A, the reverberant sound is B, the reflected sound is C, and the diffracted sound is D, the evaluation value {E(X); X=A, B, C, D} for each sound is given by Expression (4) below.

$$\begin{matrix}[ Math . 4 ] & \\ E ( X ) = {\sum }_{for all i , j} P ( {C}_{i} , {C}_{j} ) \cdot W ( Order ( {C}_{i} , {C}_{j} , X ) ) X ∈ \{ A , B , C , D \} & ( 4 )\end{matrix}$$

Here, the function Order (Cᵢ, Cⱼ, X) is a function that returns, using the culling table, the priority of sound X that reaches the listener when the sound source object is positioned at grid point Cᵢ and the listener is positioned at grid point Cⱼ, and the function W(n) represents a function that returns the weight when the priority is n. For example, the function W(n) is defined in advance such that a greater weight is given to higher priorities, such as W(0)=10 when priority n=0, W(1)=5 when n=1, W(2)=2 when n=2, and W(3)=1 when n=3.

The magnitudes of these evaluation values {E(X); X=A, B, C, D} are compared, and priorities are determined in descending order of evaluation value E(X).

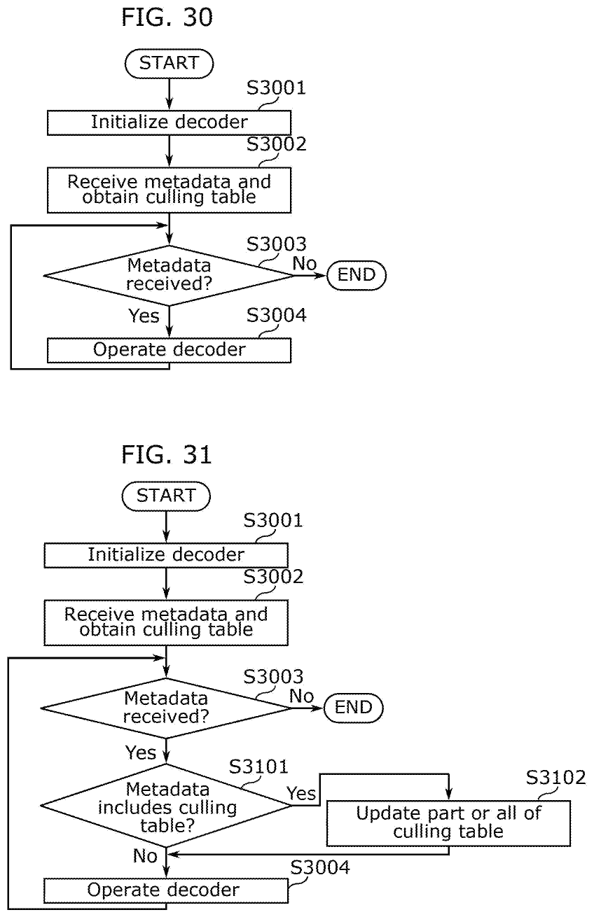

FIG. 30 will be described. A feature of this example is that the culling table is provided to the decoder as metadata during initialization of the decoder. This eliminates the need for the decoder to create a table during operation, thereby reducing the computational cost during operation of the decoder.

FIG. 30 illustrates a flowchart of the operation in this example. First, the decoder is initialized (S3001), and at that time, metadata storing the culling table is received and the culling table is obtained (S3002). The obtained culling table is used in subsequent operations of the decoder.

Whether metadata is received is determined (S3003). If metadata is not received (No in S3003), the processing ends.

When metadata is received (Yes in S3003), acoustic processing is performed based on this metadata in the operation of the decoder (S3004), and immersive audio is generated and output.

The process returns to step S3003, and whether there is a reception of metadata is determined.

Note that while the algorithm here is defined based on whether metadata is received, the algorithm is not limited thereto and may be defined based on whether a bitstream, multiplexed data, a packet, or the like is received.

FIG. 31 will be described. A feature of this example is that the culling table is provided to the decoder as metadata during initialization of the decoder, and when metadata includes part or all of the culling table while the decoder is in operation, part or all of the culling table is updated. This eliminates the need for the decoder to create a table during operation, and enables the culling table to follow changes when spatial information changes, thereby reducing the computational cost during operation of the decoder while maintaining the quality of immersive audio.

FIG. 31 illustrates a flowchart of the operation in this example. Part of the operation is the same as in FIG. 30 described above, and therefore may be denoted by the same reference signs.

The decoder is initialized (S3001), and at that time, metadata storing the culling table is received and the culling table is obtained (S3002). The obtained culling table is used in subsequent operations of the decoder.

Whether metadata is received is determined (S3003). If metadata is not received (No in S3003), the processing ends.

When metadata is received (Yes in S3003), whether the metadata includes part or all of the culling table is determined (S3101). If it does include part or all (Yes in S3101), part or all of the culling table is updated (S3102).

Acoustic processing is performed based on this metadata in the decoder (operation of the decoder (S3004)), and immersive audio is generated and output.

The process returns to step S3003, and whether there is a reception of metadata is determined.

Note that while the algorithm here is defined based on whether metadata is received, the algorithm is not limited thereto and may be defined based on whether a bitstream, multiplexed data, a packet, or the like is received.

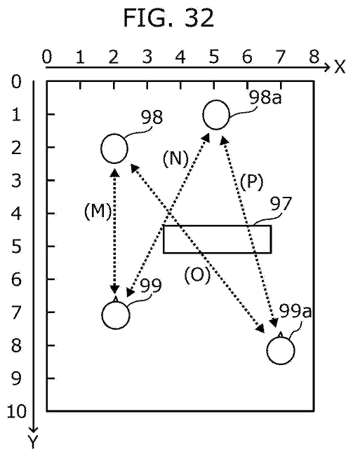

FIG. 32 will be described. While a rendering operation using a culling table when there is one sound source object and one listener has been described above, here, a rendering operation using a culling table when there are a plurality of (two or more) sound source objects, a plurality of listeners, or both, will be described. A feature in this situation is that a culling table adapted to each combination of sound source object and listener is used for each combination. With this, by using a culling table adapted to each combination of sound source object and listener, more accurate priority information can be obtained than when using a common culling table, enabling precise stoppage of sound generation mechanisms that have minimal importance to the listener.

FIG. 32 illustrates an example in which a plurality of objects 98 and 98a and listeners (users 99 and 99a) are arranged. Here, for convenience, the X-Y plane is displayed. In this figure, two sound source objects and two listeners are arranged. Here, the sounds reaching one listener (user 99) are emitted from sound source object 98 and sound source object 98a, respectively, and the culling tables used are two: culling table (M) generated from the positional relationship between sound source object 98 and the one listener, and culling table (N) generated from the positional relationship between sound source object 98a and the one listener. Culling table (M) is used to reference the priorities of sounds when sounds emitted from sound source object 98 reach the one listener, and culling table (N) is used to reference the priorities of sounds when sounds emitted from sound source object 98a reach the one listener.

Similarly, the sounds reaching the other listener (user 99a) are emitted from sound source object 98 and sound source object 98a, respectively, and the culling tables used are two: culling table (O) generated from the positional relationship between sound source object 98 and the other listener, and culling table (P) generated from the positional relationship between sound source object 98a and the other listener. Culling table (O) is used to reference the priorities of sounds when sounds emitted from sound source object 98 reach the other listener, and culling table (P) is used to reference the priorities of sounds when sounds emitted from sound source object 98a reach the other listener.

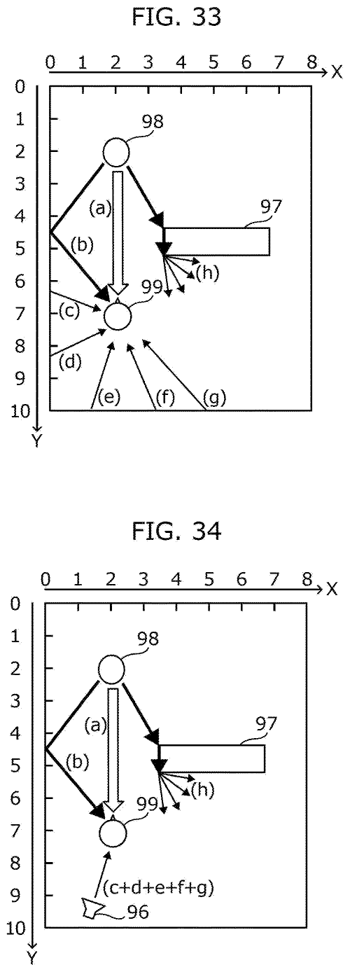

FIG. 33 and FIG. 34 will be described. In the above example, sounds with low priorities are culled based on the priorities obtained by referencing the culling table. In contrast, in this example, instead of culling sounds with low priorities, a plurality of sounds to be culled that have low priorities are collectively integrated and regarded as virtual sounds output from a virtual object that is a virtual sound source object. This makes it possible to substitute a plurality of sounds with low priorities with sounds output from a smaller number of virtual objects, enabling reduction of the amount of computation. In addition, since a plurality of sounds with low priorities are not completely discarded, degradation of immersive audio due to culling can be avoided to a certain extent.

FIG. 33 illustrates a conceptual diagram of culling processing in this example. In this figure, a case where reverberant sounds (c) to (g) are selected as sounds with low priorities is illustrated. As illustrated in this figure, a plurality of reverberant sounds that were reaching the listener are collectively integrated by the integration processing into sounds output from a smaller number of virtual objects 96, as illustrated in FIG. 34, for example, and are output toward the listener.

Although reverberant sounds have been used as an example in the description here, the present disclosure is not limited thereto, and it is also possible to similarly perform integration processing instead of culling processing for reflected sounds and diffracted sounds.

As a method for collectively integrating a plurality of sounds with low priorities, for example, a method may be used in which sounds to be culled are added and integrated, and are regarded as sounds output from virtual object 96. During addition, at least one of the energy or phase of each sound may be adjusted before addition.

In contrast to Example 1 that has been described thus far, the priorities in the culling table may be determined through two-stage processing. More specifically, in the first stage, priorities are tentatively determined using the culling table based on the listener position and the object position, as has been done thus far. Next, in the second stage, analysis is performed on sound generators with low priorities, and the priorities are modified (in other words, corrected) based on the analysis results to determine the final priorities. For this analysis method, for example, an index that takes into account the auditory characteristics of the listener may be used.

This enables performance improvement in cases where there is a discrepancy in acoustic conditions between when the culling table was designed and in actual operation.

Note that sound generator here refers to one or more of direct sound generator 1521 that generates direct sound, reverberant sound generator 1522 that generates reverberant sound, reflected sound generator 1523 that generates reflected sound, and diffracted sound generator 1524 that generates diffracted sound.

Although the subject matter of the present disclosure has been described thus far based on sound propagation, the present disclosure is not limited to sound propagation and can also be applied to, for example, light propagation.

Regarding light propagation, the present disclosure is applicable to computer graphics that generate scenes based on direct light, reflected light, and diffracted light. More specifically, priorities of direct light, reflected light, and diffracted light are referenced from the culling table based on the positional relationship between the light source and the user in a virtual space or a space that fuses a virtual space and real space, and based on these priorities, the operation of the generator for light with low priority is stopped, and computer graphics are generated. This enables stopping generation of only light with low priority, so the degree of degradation in the quality of computer graphics provided to the user can be kept small, and the amount of computation for generating computer graphics can be greatly reduced.

### Explanation of Functions of Renderer, Example 2

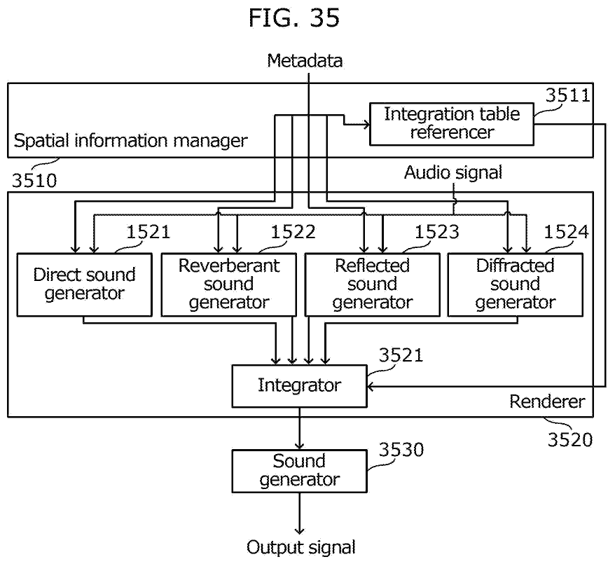

FIG. 35 through FIG. 57 are diagrams for explaining a specific example of an acoustic reproduction system according to Example 2 of the embodiment.

In Example 2, when the shape of the room, the material properties of walls (reflectance, absorptance, etc.), and the shape and material properties (same as just mentioned) of obstacles are given, combinations of sounds to be integrated among a plurality of sounds such as direct sound, reflected sound, reverberant sound, and diffracted sound are determined in advance with respect to possible positional relationships between the listener and sound source objects, and an integration table is created in advance as a table for integration processing.

FIG. 35 will be described. FIG. 35 is a block diagram of a decoder according to the present example (i.e., renderer 3520, sound generator 3530, and spatial information manager 3510). The basic concept in the present example is to reference the integration table based on the position of the sound source object and the position of the listener, identify a plurality of sounds to be integrated at those positions, and use information of the plurality of sounds to construct virtual objects fewer in number than the sounds to be integrated and generate sounds reaching the listener. This reduces the number of sounds input to downstream sound generator 3530, thereby decreasing computational requirements.

First, metadata is provided to the decoder. The configuration of the metadata is represented as in FIG. 16, and description thereof will be omitted here.

The integration table is referenced based on the object position and listener position included in the metadata to obtain identifiers of sounds to be integrated among sounds reaching the listener.

Direct sound generator 1521, reverberant sound generator 1522, reflected sound generator 1523, and diffracted sound generator 1524 each receive an audio signal and metadata, generate direct sound, reverberant sound, reflected sound, and diffracted sound, respectively, and output them to integrator 3521. The audio signal is generated by performing decoding processing on encoded audio data included in the metadata using an audio data decoder not shown here, and may be provided to each of direct sound generator 1521, reverberant sound generator 1522, reflected sound generator 1523, and diffracted sound generator 1524, or audio data included in the metadata may be provided to each of direct sound generator 1521, reverberant sound generator 1522, reflected sound generator 1523, and diffracted sound generator 1524.

Integrator 3521 integrates sounds corresponding to the identifiers obtained by integration table referencer 3511 among signals input to integrator 3521, and outputs them to sound generator 3530. Sounds not corresponding to the identifiers are output directly to sound generator 3530.

Sound generator 3530 performs acoustic processing such as a head related transfer function (HRTF) on the signal input from integrator 3521, and outputs it as an output signal. This acoustic processing performs processing adapted to the output format for the listener, such as headphones or multi-channel loudspeakers, and provides the output signal to the listener.

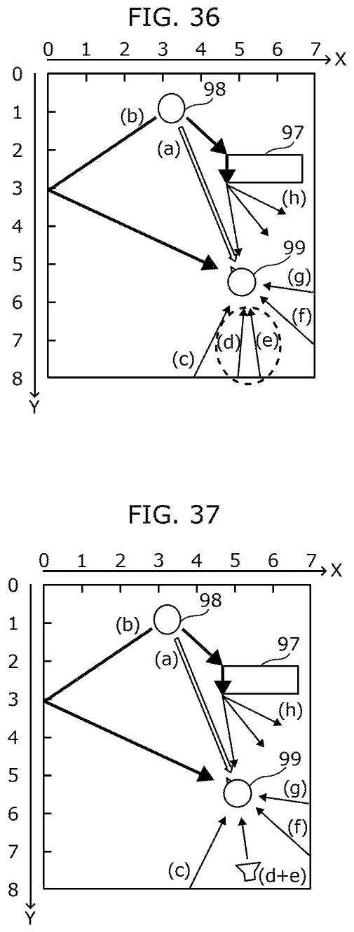

FIG. 36 and FIG. 37 will be described. These figures illustrate diagrams similar to FIG. 19. FIG. 36 illustrates, as sounds reaching the listener, direct sound (a), reflected sound (b), reverberant sounds (c) through (g), and diffracted sound (h).

When the position of the sound source object and the position of the listener have the respective relationships shown in the figure, in order to reference the integration table, the sound source object is considered to be positioned at grid point (3, 1) closest to the position in the figure, and similarly, the listener is considered to be positioned at grid point (5, 5) closest to the position in the figure.

Next, the integration table is referenced based on grid point (3, 1) near the position of the sound source object and grid point (5, 5) near the position of the listener to obtain identifiers of sounds to be integrated. FIG. 36 illustrates that identifiers indicating reverberant sound (d) and reverberant sound (e) are obtained from the integration table.

Note that as a method for integrating a plurality of sounds to be integrated to construct a virtual object, for example, a method may be used in which sounds to be integrated are added and are regarded as sounds output from the virtual object. During addition, at least one of the energy or phase of each sound may be adjusted before addition. Note that the method described here is merely one example, and the method for integrating a plurality of sounds is not limited to this method.

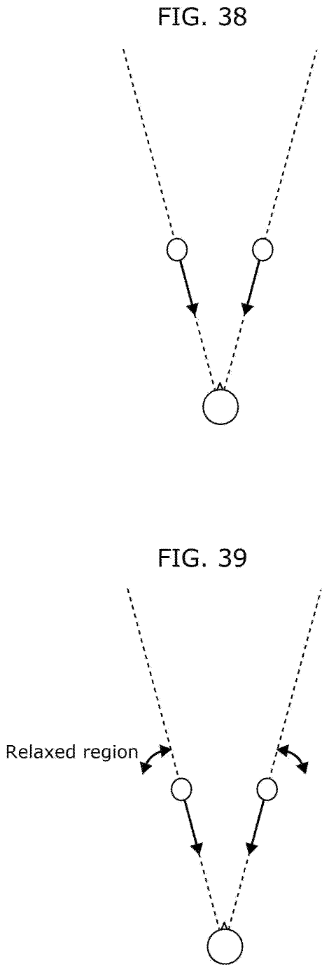

The position of the virtual object is any position within a region (the hatched region in FIG. 38) delimited by a direction connecting the listener and one of the sounds and a direction connecting the listener and the other of the sounds. Alternatively, the position of the virtual object may be any position within a region (the hatched region in FIG. 39) delimited by a direction obtained by relaxing outward the direction connecting the listener and one of the sounds and a direction obtained by relaxing outward the direction connecting the listener and the other of the sounds.

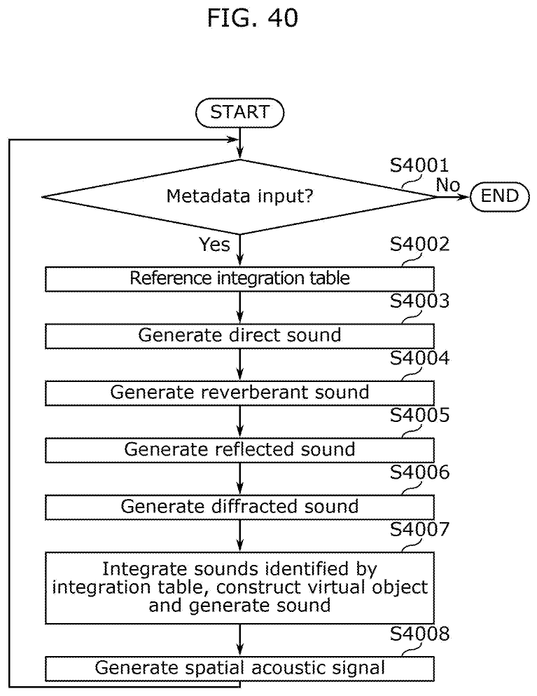

Next, FIG. 40 illustrates a flowchart of the operation of the decoder in the above configuration.

First, whether metadata is input (whether there is an input of metadata) is determined (S4001). If metadata is input (Yes in S4001), the process proceeds to generation of direct sound, and if metadata is not input (No in S4001), the processing ends.

If metadata is input (Yes in S4001), the integration table is referenced based on the positions of the listener and the sound source object (S4002) to obtain identifiers of sounds to be integrated.

Furthermore, sounds that reach the listener, namely, direct sound, reverberant sound, reflected sound, and diffracted sound, are respectively generated (S4003 to S4006).

Sounds to be integrated that are identified by the integration table are integrated to construct a virtual object, and sound of the virtual object is generated (S4007).

As a result of the integration processing, spatial acoustic signal processing such as a head related transfer function (HRTF) is performed on the remaining direct sound, reverberant sound, reflected sound, diffracted sound, and the generated sound of the virtual object to generate a spatial acoustic signal (S4008), which is output to a device used by the listener such as headphones.

The process returns to step S4001, and whether new metadata is input is determined.

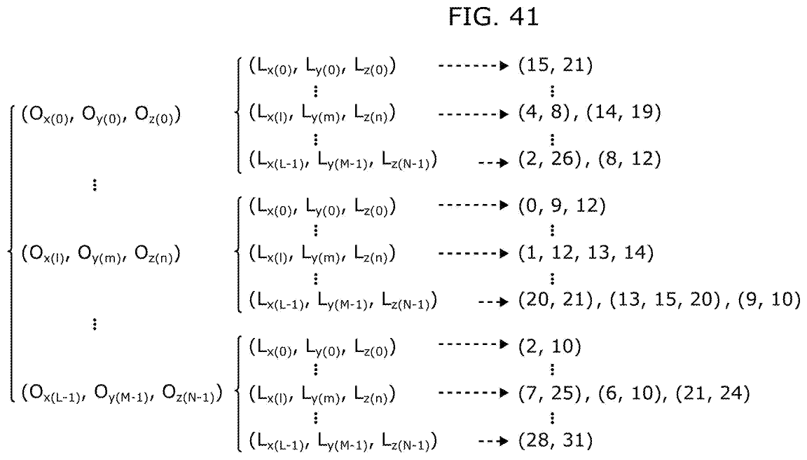

FIG. 41 will be described. FIG. 41 illustrates an example of an integration table. In FIG. 41, the left column indicates coordinate positions (X, Y, Z) of sound source objects, the center column indicates coordinate positions (X, Y, Z) of the listener, and the right column indicates identifiers of sounds to be integrated corresponding to combinations of coordinate positions of sound source objects and coordinate positions of the listener. Identifiers of sounds to be integrated are indicated by two or more identifiers enclosed in parentheses, and when there are a plurality of pairs of parentheses, this means that the sounds of the identifiers within each pair of parentheses are integrated respectively.

By referencing the integration table based on the position of the sound source object and the position of the listener, identifiers of sounds to be integrated can be obtained. FIG. 41 illustrates a configuration example of an integration table, and illustrates a state in which identifiers of sounds to be integrated are stored for all or some combinations of positions of sound source objects and positions of the listener on predetermined grid points.

For example, in FIG. 41, when the position of the sound source object is (O_{x(L-1)}, O_{y(M-1)}, O_{z(N-1)}) and the position of the listener is (Lₓ₍₀₎, L_{y(0)}, L_{z(0)}), the identifiers to be integrated (2, 10) are obtained. Therefore, the sound with identifier 2 and the sound with identifier 10 are integrated to construct one virtual object, and sound is generated and output.

When the position of the sound source object is (Oₓ₍₀₎, O_{y(0)}, O_{z(0})) and the position of the listener is (L_{x(I)}, L_{y(m)}, L_{z(n)}), the identifiers to be integrated (4, 8) and (14, 19) are obtained. In this case, the sound with identifier 4 and the sound with identifier 8 are integrated, and the sound with identifier 14 and the sound with identifier 19 are integrated to construct virtual objects, and sound is generated and output.

When the position of the object is (O_{x(I)}, O_{y(m)}, O_{z(n)}) and the position of the listener is (L_{x(I)}, L_{y(m)}, L_{z(n)}), the identifiers to be integrated (1, 12, 13, 14) are obtained. Therefore, the sound with identifier 1, the sound with identifier 12, the sound with identifier 13, and the sound with identifier 14 are integrated to construct one virtual object, and sound is generated and output.

Note that this integration table may also be used when identifying sounds to be culled. For example, when the position of the sound source object is (O_{x(L-1)}, O_{y(M-1)}, O_{z(N-1)}) and the position of the listener is (Lₓ₍₀₎, L_{y(0)}, L_{z(0)}), the identifiers to be integrated (2, 10) are obtained. When the integration table is used to identify sounds to be culled, at least one of the sounds represented by the identifiers to be integrated is culled rather than integrated. When there are a plurality of pairs of parentheses, at least one of the sounds of the identifiers within each pair of parentheses is used so as to be culled respectively.

The integration table can be created in advance. As a specific method for this, for example, for all or some combinations of the position of the sound source object and the position of the listener, the direct sound, reverberant sound, reflected sound, and diffracted sound that actually reach the listener are calculated, and the sounds to be integrated may be determined based on indices that take into account auditory characteristics, such as the importance of those signals, for example, the magnitude of energy or energy corrected by auditory characteristics. The sounds to be integrated may be determined based on the angle of intersection (angle formed) between two sounds when the two sounds reach the listener or the level ratio of the two sounds. Although creating the integration table requires a large amount of computation, since the integration table can be created offline and it is not necessary to consider real-time performance, it can be created in advance.

Alternatively, a content creator or service provider may design part or all of the integration table to create the integration table.

The decoder may be preloaded with the integration table as part of its initialized state. In such cases, computational cost regarding the integration table can be reduced without any additional processing requirements.

Alternatively, the integration table may be obtained during initialization processing of the decoder, or the decoder may update part or all of the integration table during operation. These will be described later.

Note that while the integration table described here is designed based on both the position of the sound source object and the position of the listener, the integration table may be designed based on either the position of the sound source object or the position of the listener in order to reduce computational cost during integration table design and reduce the memory footprint of the integration table.

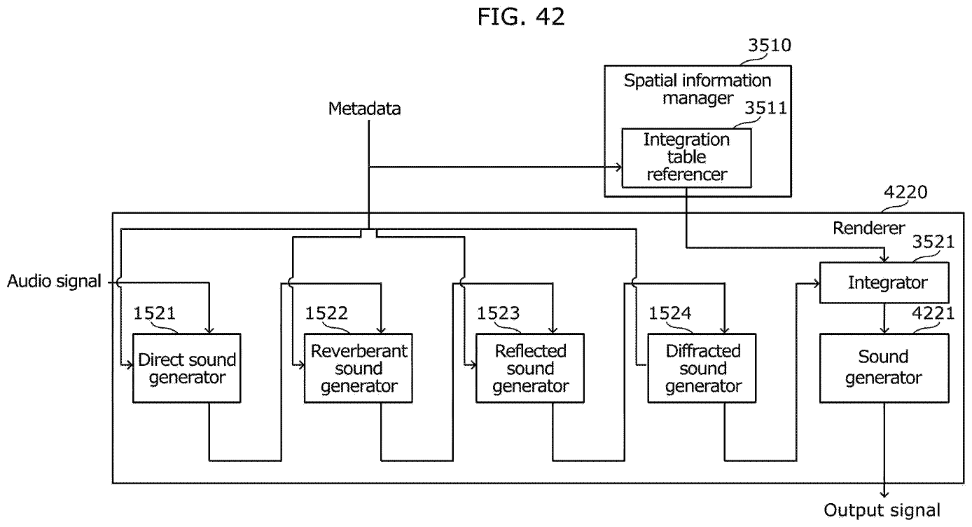

FIG. 42 will be described. FIG. 42 is a block diagram illustrating another configuration of a decoder that includes renderer 4220 instead of renderer 3520. A characteristic of this configuration is that direct sound generator 1521, reverberant sound generator 1522, reflected sound generator 1523, and diffracted sound generator 1524 are connected in series. According to this configuration, sound generated by a generator at a preceding stage can affect a generator at the current stage, making it possible to provide accurate immersive audio that is closer to actual spatial acoustics.

Note that while this diagram illustrates a configuration in which all output signals from diffracted sound generator 1524 are provided to integrator 3521, the configuration is not limited to this, and a configuration may be employed in which a portion of at least one output signal from direct sound generator 1521, reverberant sound generator 1522, reflected sound generator 1523, and diffracted sound generator 1524 does not enter integrator 3521 and is output directly to sound generator 4221.

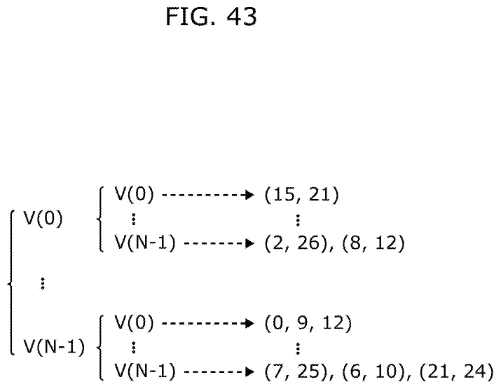

FIG. 43 will be described. In the above example, as illustrated in FIG. 36 and FIG. 37, the integration table has been defined on the premise that the space in which the sound source object and the listener are present is divided by grid points, and the sound source object and the listener are positioned on arbitrary grid points.

Here, the three-dimensional space is divided not by grid points but by voxels of arbitrary sizes, and the integration table obtains identifiers of sounds to be integrated based on both the identifier of the voxel to which the object belongs and the identifier of the voxel to which the listener belongs. Note that the voxels here do not necessarily need to be rectangular parallelepipeds. The configuration of the voxels is as described in FIG. 22, and description thereof will be omitted here.

FIG. 43 illustrates a configuration example of the integration table in this example. As illustrated in FIG. 43, identifiers of sounds to be integrated are obtained by a combination of the voxel number to which the sound source object belongs and the voxel number to which the listener belongs, and a virtual object is constructed from information of the plurality of sounds indicated by the obtained identifiers.

Note that this integration table may also be used when identifying sounds to be culled.

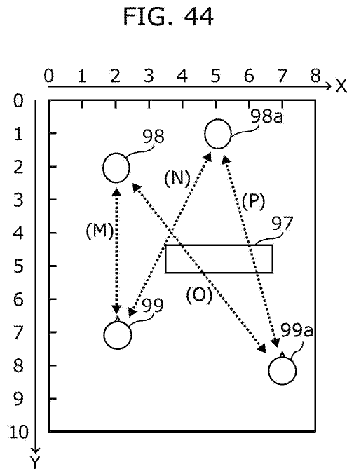

FIG. 44 will be described. While a rendering operation using an integration table when there is one sound source object and one listener has been described above, here, a rendering operation using an integration table when there are a plurality of (two or more) sound source objects, a plurality of listeners, or both, will be described. A feature in this situation is that an integration table adapted to each combination of sound source object and listener is used for each combination. With this, by using an integration table adapted to each combination of sound source object and listener, more accurate information on combinations of sounds to be integrated can be obtained than when using a common integration table.

FIG. 44 illustrates an example in which a plurality of objects 98 and 98a and listeners (users 99 and 99a) are arranged. Here, for convenience, the X-Y plane is displayed. In this figure, two sound source objects and two listeners are arranged. Here, the sounds reaching one listener (user 99) are emitted from sound source object 98 and sound source object 98a, respectively, and the integration tables used are two: integration table (M) generated from the positional relationship between sound source object 98 and the one listener, and integration table (N) generated from the positional relationship between sound source object 98a and the one listener. Integration table (M) is used to obtain combinations of sounds to be integrated when sounds emitted from sound source object 98 reach the one listener, and integration table (N) is used to obtain combinations of sounds to be integrated when sounds emitted from sound source object 98a reach the one listener.

Similarly, the sounds reaching the other listener (user 99a) are emitted from sound source object 98 and sound source object 98a, respectively, and the integration tables used are two: integration table (O) generated from the positional relationship between sound source object 98 and the other listener, and integration table (P) generated from the positional relationship between sound source object 98a and the other listener. Integration table (O) is used to obtain combinations of sounds to be integrated when sounds emitted from sound source object 98 reach the other listener, and integration table (P) is used to obtain combinations of sounds to be integrated when sounds emitted from sound source object 98a reach the other listener.

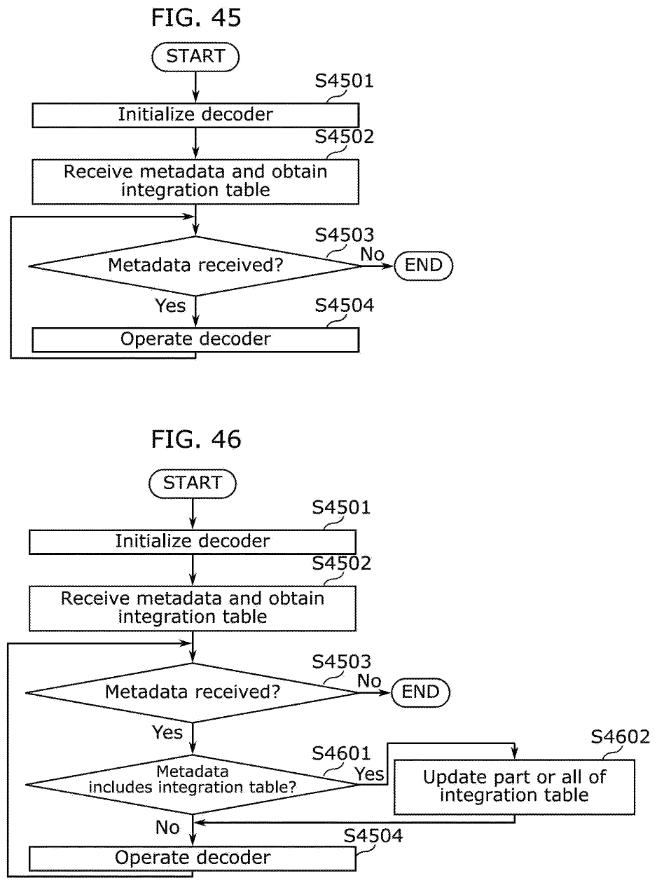

FIG. 45 will be described. A feature of this example is that the integration table is provided to the decoder as metadata during initialization of the decoder. This eliminates the need for the decoder to create a table during operation, thereby reducing the computational cost during operation of the decoder.

FIG. 45 illustrates a flowchart of the operation in this example.

First, the decoder is initialized (S4501), and at that time, metadata storing the integration table is received and the integration table is obtained (S4502). The obtained integration table is used in subsequent operations of the decoder.

Whether metadata is received is determined (S4503). If metadata is not received (No in S4503), the processing ends.

When metadata is received (Yes in S4503), acoustic processing is performed based on this metadata in the operation of the decoder (S4504), and immersive audio is generated and output.

The process returns to step S4503, and whether there is a reception of metadata is determined.

Note that while the flowchart here is defined based on whether metadata is received, the flowchart is not limited thereto and may be defined based on whether a bitstream, multiplexed data, a packet, or the like is received.

FIG. 46 will be described. A feature of this example is that the integration table is provided to the decoder as metadata during initialization of the decoder, and when metadata includes part or all of the integration table while the decoder is in operation, part or all of the integration table is updated. This eliminates the need for the decoder to create a table during operation, and enables the integration table to follow changes when spatial information changes, thereby reducing the computational cost during operation of the decoder while maintaining the quality of immersive audio.

FIG. 46 illustrates a flowchart of the operation in this example. Part of the operation is the same as in FIG. 45 described above, and therefore may be denoted by the same reference signs.

The decoder is initialized (S4501), and at that time, metadata storing the integration table is received and the integration table is obtained (S4502). The obtained integration table is used in subsequent operations of the decoder.

Whether metadata is received is determined (S4503). If metadata is not received (No in S4503), the processing ends.

When metadata is received (Yes in S4503), whether the metadata includes part or all of the integration table is determined (S4601). If it does include part or all (Yes in S4601), part or all of the integration table is updated (S4602).

Acoustic processing is performed based on this metadata in the decoder (operation of the decoder (S4504)), and immersive audio is generated and output.

The process returns to step S4503, and whether there is a reception of metadata is determined.

Note that while the flowchart here is defined based on whether metadata is received, the flowchart is not limited thereto and may be defined based on whether a bitstream, multiplexed data, a packet, or the like is received.

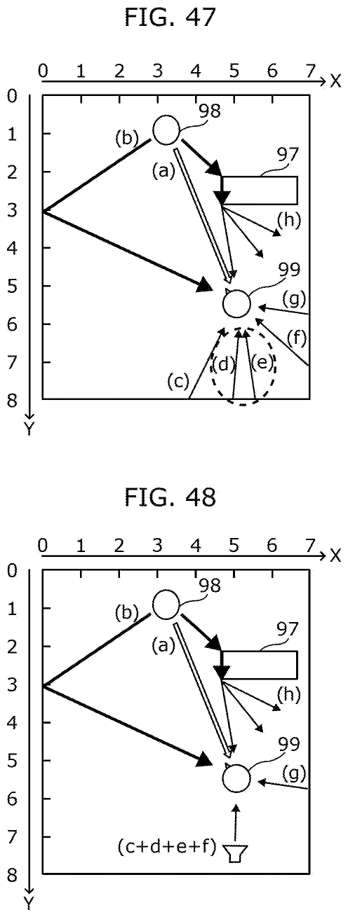

FIG. 47 and FIG. 48 will be described. These figures illustrate diagrams similar to FIG. 36.

FIG. 47 illustrates that reverberant sound (d) and reverberant sound (e) are selected as sounds to be integrated. Here, if the process follows the above description as illustrated in the figure, reverberant sound (d) and reverberant sound (e) are integrated to construct a virtual object, and sound is output from the virtual object toward the listener. In contrast, in the present example, in addition to reverberant sound (d) and reverberant sound (e), reverberant sound (c) and reverberant sound (f) in the vicinity are also used to construct a virtual object, and sound is output toward the listener.

The reason for constructing a virtual object that includes not only sounds selected as targets for integration but also sounds in the vicinity thereof in this way is to avoid changes in sounds output from the virtual object (changes from a virtual object constructed from reverberant sound (d) and reverberant sound (e) to a virtual object constructed from reverberant sound (e) and reverberant sound (f)) that would occur due to changes in sounds selected as targets for integration (for example, changes from reverberant sound (d) and reverberant sound (e) to reverberant sound (e) and reverberant sound (f)) when the sound source object or the listener moves as time passes. When such changes in the virtual object occur, the generation position of sound may change suddenly or the characteristics of the generated sound may change suddenly, and in such cases, the listener perceives degradation in the quality of the immersive audio.

By constructing a virtual object that includes not only sounds selected as targets for integration but also sounds in the vicinity thereof as in the present example, even if the sound source object or the listener moves, the virtual object is constructed to include sounds that would be selected at the destination because a wide range of sounds to be integrated is taken. Accordingly, changes in the virtual object are less likely to occur, and thus an effect is obtained in which the frequency of occurrence of degradation in the quality of the immersive audio as described above is reduced.

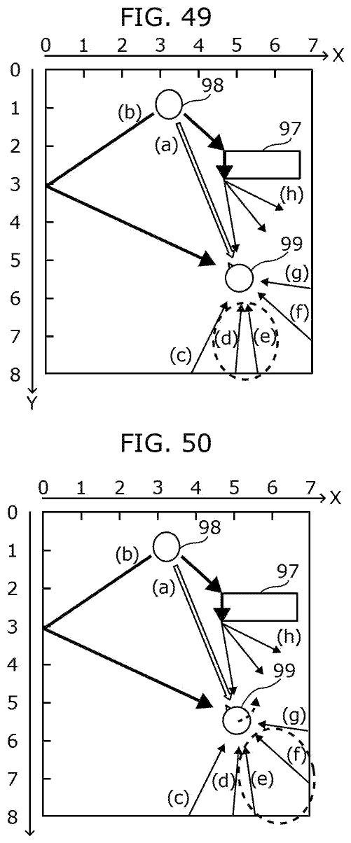

FIG. 49 through FIG. 53 will be described. FIG. 49 through FIG. 52 illustrate diagrams similar to FIG. 36.

Here, before the listener moves, reverberant sound (d) and reverberant sound (e) are selected as sounds to be integrated (FIG. 49). After a certain time has elapsed and the listener has moved, reverberant sound (e) and reverberant sound (f) are selected (FIG. 50).

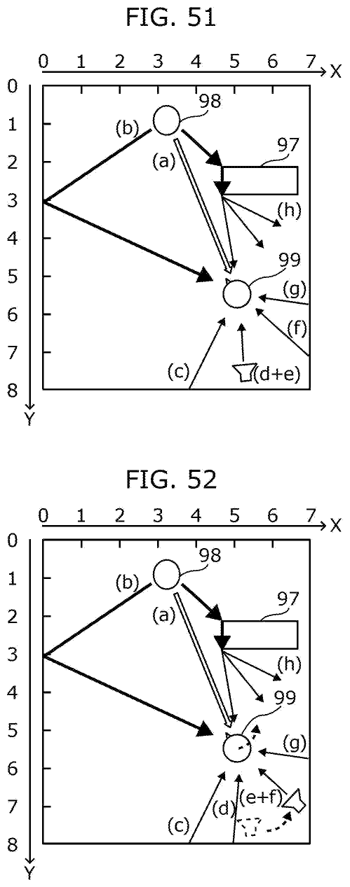

Before the listener moves, a virtual object is constructed based on reverberant sound (d) and reverberant sound (e) (FIG. 51), and sound generated by the virtual object is output toward the listener. After the listener moves, a virtual object is constructed based on reverberant sound (e) and reverberant sound (f) (FIG. 52), and sound generated by the virtual object is output toward the listener.

Here, changes occur in the position where reverberant sound (e) and reverberant sound (f) generated by the virtual object are generated and in the characteristics of the sounds, and therefore, the listener may perceive the position and characteristics of the sounds as having changed suddenly, and in such cases, the listener perceives degradation in the quality of the immersive audio.

To resolve this problem, processing is applied here using windowed addition so that the position and characteristics of the sounds gradually change, thereby mitigating degradation in the quality of the immersive audio.

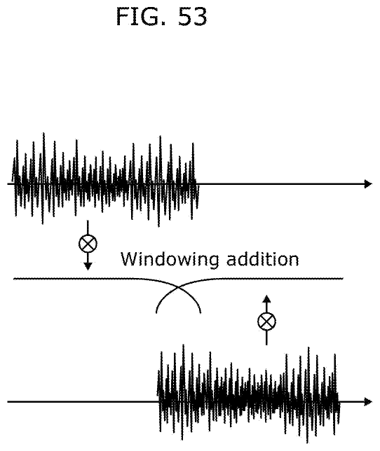

More specifically, the ending portion of a virtual sound that integrates reverberant sound (d) and reverberant sound (e) generated by the virtual object before the listener moves and the starting portion of a virtual sound that integrates reverberant sound (e) and reverberant sound (f) generated by the virtual object after the listener moves are generated so as to temporally overlap, and corresponding window functions are respectively multiplied and added (FIG. 53), ultimately generating sound that is output toward the listener. Here, the window function for the virtual sound that integrates reverberant sound (d) and reverberant sound (e) has a shape that gradually attenuates at the connection portion, and the window function for the virtual sound that integrates reverberant sound (e) and reverberant sound (f) has a shape that gradually amplifies at the connection portion.

The position of the virtual object is controlled so as to gradually change from the position of the virtual object before the listener moves to the position of the virtual object after the listener moves (FIG. 52).

By performing such processing, changes in the position and characteristics of the sounds become gradual, and degradation in the quality of the immersive audio can be avoided. Therefore, it is ultimately possible to provide high-quality immersive audio to the listener.

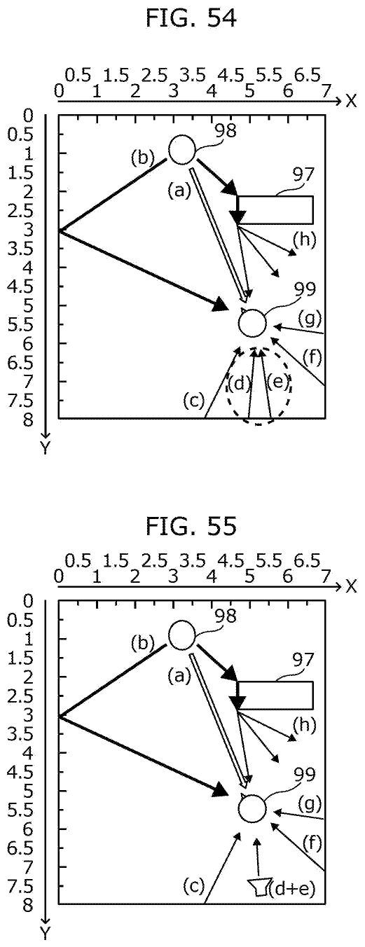

FIG. 54 through FIG. 57 will be described. These figures illustrate diagrams similar to FIG. 36.

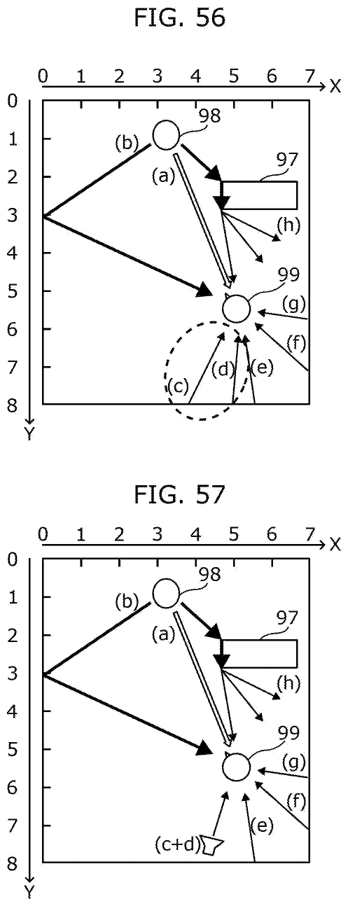

FIG. 54 through FIG. 57 illustrate a case where the device in which the decoder is implemented has a large storage capacity and high processing capability (FIG. 54 and FIG. 55, hereinafter referred to as a high-performance device (HP device)), and a case where the device in which the decoder is implemented has a small storage capacity and low processing capability (FIG. 56 and FIG. 57, hereinafter referred to as a low-performance device (LP device)). In the HP device, the grid spacing is narrow, and in the LP device, the grid spacing is wide; the narrower the grid spacing, the larger the storage capacity and the higher the processing capability must be, but on the other hand, high-quality immersive audio can be generated because sounds to be integrated can be accurately determined.

In the HP device, as a result of referring to the integration table with the positions of the sound source object and the listener as arguments, reverberant sound (d) and reverberant sound (e) are selected (dashed circle in FIG. 54). Therefore, a virtual object is constructed based on reverberant sound (d) and reverberant sound (e), and sound is generated and output toward the listener (FIG. 55). In the HP device, because the grid spacing is set narrow, the number of combinations of positions of the sound source object and the listener is large, and the integration table size and calculation amount are large; however, the integration table accuracy increases, and sounds to be integrated can be accurately selected.

On the other hand, in the LP device, because the grid spacing is set wide, the number of combinations of positions of the sound source object and the listener is small, and the integration table size and calculation amount are also small. However, integration table accuracy is impaired, and sounds to be integrated cannot necessarily be accurately selected. When the LP device is used, unlike the case of the HP device, reverberant sound (c) and reverberant sound (d) are selected (dashed circle in FIG. 56), a virtual object is constructed based on these two sounds, and sound is output toward the listener (FIG. 57).

Information about what type of device the listener uses is transmitted to a service provider or the like, such as via communication, at an initialization stage when the listener receives the immersive audio service. The service provider utilizes this device information to provide the immersive audio service based on an appropriate grid spacing.

In contrast to Example 2 that has been described thus far, the identifiers of sounds to be integrated in the integration table may be determined through two-stage processing. More specifically, in the first stage, identifiers of sounds to be integrated are tentatively determined using the integration table based on the listener position and the object position, as has been done thus far. Next, in the second stage, analysis is performed on the provisionally determined sounds, and the identifiers of the sounds to be integrated are modified (in other words, corrected) based on the analysis results to obtain the final sound identifiers. For this analysis method, for example, an index that takes into account the auditory characteristics of the listener may be used.

This enables performance improvement in cases where there is a discrepancy in acoustic conditions between when the integration table was designed and in actual operation.

Note that sound generator here refers to one or more of direct sound generator 1521 that generates direct sound, reverberant sound generator 1522 that generates reverberant sound, reflected sound generator 1523 that generates reflected sound, and diffracted sound generator 1524 that generates diffracted sound.

Although the above examples describe generation of direct sound, reflected sound, reverberant sound, and diffracted sound, the present disclosure is not limited thereto and can be applied to any type of sound, regardless of its name and sound characteristics, as long as it is direct sound or sound derived from direct sound that reaches the listener.

A method for achieving hardware scalability by controlling the grid spacing has been described. However, the present disclosure is not limited thereto, and for example, hardware scalability may be achieved by controlling the voxel size according to the storage capacity and processing capability of the device used by the listener.

Although the subject matter of the present disclosure has been described thus far based on sound propagation, the present disclosure is not limited to sound propagation and can also be applied to, for example, light propagation.

Regarding light propagation, the present disclosure is applicable to computer graphics that generate scenes based on direct light, reflected light, and diffracted light. More specifically, based on the positional relationship between the light source and the user in a virtual space or a space that fuses a virtual space and real space, light to be integrated is identified by referencing the integration table, and for the identified light, a virtual object is constructed, and new light is output to generate computer graphics. This enables greatly reducing the amount of computation for generating computer graphics while inhibiting degradation in the quality of computer graphics.

### Explanation of Functions of Renderer, Example 3

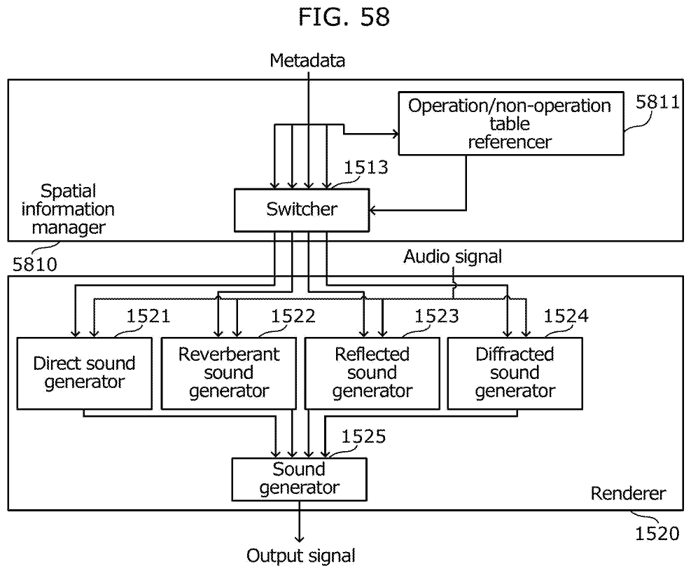

FIG. 58 through FIG. 70 are diagrams for explaining a specific example of an acoustic reproduction system according to Example 3 of the embodiment.

In Example 3, when spatial information (the shape of the room, the material properties of walls (reflectance, absorptance, etc.), the shape of obstacles, material properties (same as just mentioned), etc.) is given, whether or not each of a plurality of sounds such as direct sound, reflected sound, reverberant sound, and diffracted sound reaches the listener is determined in advance with respect to possible positional relationships between the listener and sound source objects, and an operation/non-operation table is created in advance that enables referencing, with the position information of objects disposed on grid points in space and the listener as arguments, information indicating whether or not each of direct sound generator 1521, reflected sound generator 1522, reverberant sound generator 1523, and diffracted sound generator 1524 operates.

FIG. 58 will be described. FIG. 58 is a block diagram of a decoder according to the present Example 3 (i.e., renderer 1520 and spatial information manager 5810). The basic concept in the present example is to reference the operation/non-operation table based on the position of the sound source object and the position of the listener, identify operation/non-operation information indicating whether or not to perform an operation of generating sounds reaching the listener at those positions, and generate sounds reaching the listener according to the operation/non-operation information. This makes it possible to cancel in advance the generation of sounds having low importance among sounds reaching the listener, enabling reduction of the amount of computation.

First, metadata is provided to the decoder. The configuration of the metadata is represented as in FIG. 16, and description thereof will be omitted here.

The operation/non-operation table is referenced based on the object position and listener position included in the metadata to obtain operation/non-operation information of sounds reaching the listener. This operation/non-operation information indicates whether to operate or not operate each of direct sound generator 1521, reverberant sound generator 1522, reflected sound generator 1523, and diffracted sound generator 1524, and sounds reaching the listener are generated according to the information.

The metadata is provided to each of direct sound generator 1521, reverberant sound generator 1522, reflected sound generator 1523, and diffracted sound generator 1524 via switcher 1513. Switcher 1513 controls each of the generators according to the operation/non-operation information obtained by referencing the operation/non-operation table.

An audio signal is provided to direct sound generator 1521, reverberant sound generator 1522, reflected sound generator 1523, and diffracted sound generator 1524. The audio signal is generated by performing decoding processing on encoded audio data included in the input data using an audio data decoder not shown here, and may be provided to each of direct sound generator 1521, reverberant sound generator 1522, reflected sound generator 1523, and diffracted sound generator 1524, or audio data included in the input data may be provided to each of direct sound generator 1521, reverberant sound generator 1522, reflected sound generator 1523, and diffracted sound generator 1524.

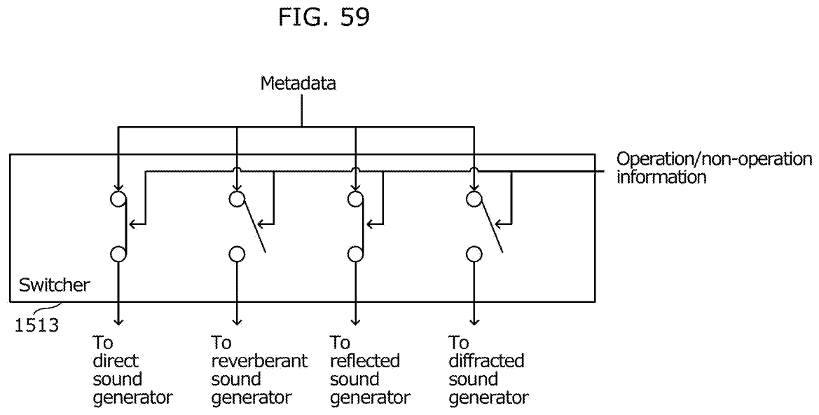

FIG. 59 will be described. FIG. 59 illustrates the configuration of the switcher. Switcher 1513 in this case differs from switcher 1513 described in FIG. 17 in that it uses operation/non-operation information instead of control information, but is otherwise similar.

When metadata is input and a switch is turned on, the metadata is provided to the generator for which the switch is turned on. Whether a switch is turned on or turned off is determined based on the operation/non-operation information. Stated differently, the switch is turned on when the operation/non-operation information indicates operation, and is turned off when it indicates non-operation.

Each generator for which a switch is turned on receives metadata, generates one of direct sound, reverberant sound, reflected sound, or diffracted sound, and outputs it to sound generator 1525. When the switch is off, the metadata is not sent to that generator, and that generator does not operate.

Sound generator 1525 performs acoustic processing such as a head related transfer function (HRTF) on the signals output from each generator, and outputs them as output signals. This acoustic processing performs processing adapted to the output format for the listener, such as headphones or multi-channel loudspeakers, and provides the output signal to the listener.

Note that while this decoder is configured with the generators in parallel, the configuration is not limited to this, and the generators may be configured in series. The series configuration will be described later.

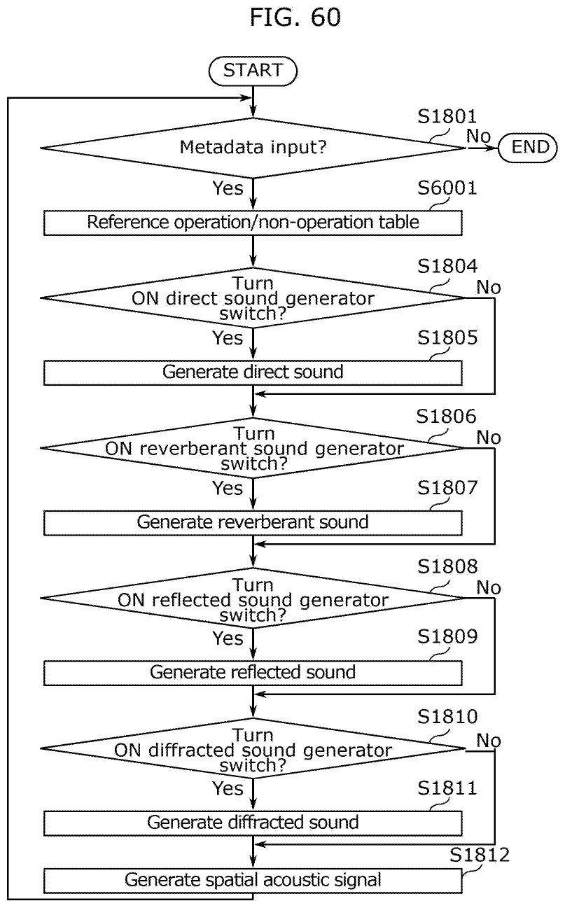

Next, FIG. 60 illustrates a flowchart of the operation of the decoder in the above configuration.

First, whether metadata has been input (whether there is an input of metadata) is determined (S1801). If metadata is input (Yes in S1801), the operation/non-operation table is referenced (S6001), and if metadata is not input (No in S1801), the processing ends.

The operation/non-operation table is referenced based on the positions of the listener and the sound source object (S6001) to obtain operation/non-operation information of the generators, and based on this information, whether the switch of each generator is to be turned on or off is specified.

Next, the operation/non-operation information for direct sound generator 1521 is referenced (S1804), and if this information indicates operation (Yes in S1804), the switch is turned on and direct sound is generated (S1805). If the operation/non-operation information indicates non-operation (No in S1804), the switch is turned off and direct sound is not generated (S1805 is skipped).

Similarly, the operation/non-operation information for reverberant sound generator 1522 is referenced (S1806), and if this information indicates operation (Yes in S1806), the switch is turned on and reverberant sound is generated (S1807), and if this information indicates non-operation (No in S1806), the switch is turned off and reverberant sound is not generated (S1807 is skipped). The operation/non-operation information for reflected sound generator 1523 is referenced (S1808), and if this information indicates operation (Yes in S1808), the switch is turned on and reflected sound is generated (S1809), and if this information indicates non-operation (No in S1808), the switch is turned off and reflected sound is not generated (S1809 is skipped). The operation/non-operation information for diffracted sound generator 1524 is referenced (S1810), and if this information indicates operation (Yes in S1810), the switch is turned on and diffracted sound is generated (S1811), and if this information indicates non-operation (No in S1810), the switch is turned off and diffracted sound is not generated (S1811 is skipped).

Finally, spatial acoustic signal processing such as convolution processing of a head-related transfer function is performed on the generated signals to generate a spatial acoustic signal (S1812), which is output to a device used by the listener such as headphones.

The process returns to step S1801, and whether new metadata is input is determined.

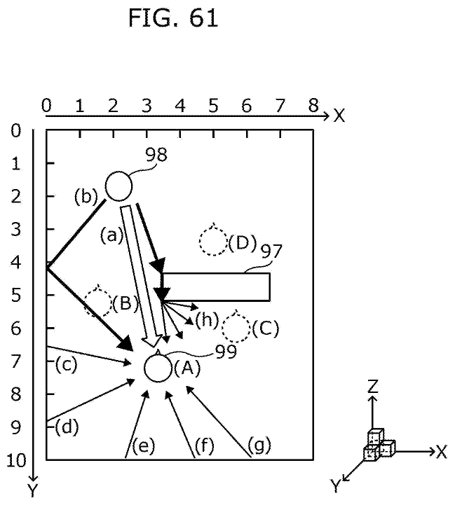

FIG. 61 will be described. FIG. 61 illustrates a conceptual diagram of an embodiment using an operation/non-operation table.

The space in which the sound source object and the listener are present is divided by a three-dimensional grid, and the operation/non-operation table stores the operation/non-operation information of each generator that generates sounds reaching the listener when a sound source object and a listener are positioned on arbitrary grid points.

FIG. 61 will be described as an example. Although FIG. 61 is displayed in the X-Y plane for convenience, the virtual space is actually represented by a 3D grid. When the position of the sound source object and the position of the listener are given, the operation/non-operation table is referenced to obtain operation/non-operation information of each generator that generates sounds reaching the listener (direct sound (a), reverberant sounds (c) through (g), reflected sound (b), and diffracted sound (h) in the figure).

Assuming that the sound source object is at the position in the figure and the listener is at position (A) in the figure, the listener can hear the direct sound, reflected sound, reverberant sound, and diffracted sound, so the operation/non-operation information at this positional relationship is (direct sound, reflected sound, reverberant sound, diffracted sound)=(∘, ∘, ∘, ∘). Here, ∘ (circle mark) indicates the generator operates to generate sounds reaching the listener, and x (“x” mark) indicates the generator does not operate. Note that even if a sound reaches the listener, when its level is below the loudness threshold, it is regarded as not reaching the listener, and the generator does not operate (x).

Note that when one or both of the sound source object or the listener is not positioned on a three-dimensional grid point, the operation/non-operation table is referenced by assuming that one or both of the sound source object or the listener is positioned at the grid point closest in distance from that position.

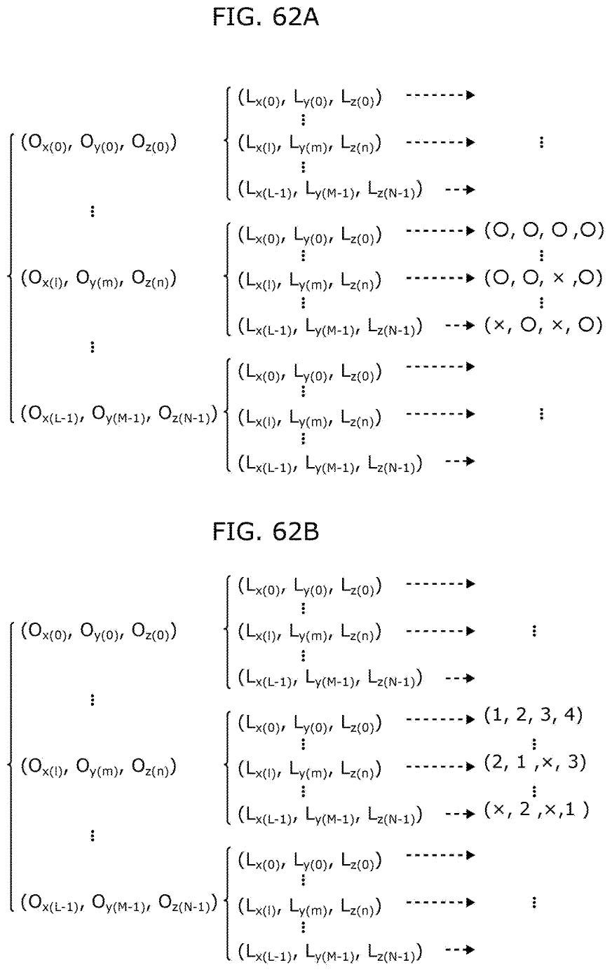

FIG. 62A will be described. FIG. 62A illustrates the configuration of an operation/non-operation table. In FIG. 62A, the left column indicates coordinate positions (X, Y, Z) of sound source objects, the center column indicates coordinate positions (X, Y, Z) of the listener, and the right column indicates operation/non-operation information corresponding to combinations of coordinate positions of sound source objects and coordinate positions of the listener. Note that the circle and “x” marks of the operation/non-operation information are as already described in the explanation of FIG. 61.

By referencing the operation/non-operation table based on the position of the sound source object and the position of the listener, operation/non-operation information can be obtained. For example, in FIG. 62A, when the position of the object is (O_{x(I)}, O_{y(m)}, O_{z(n)}) and the position of the listener is (L_{x(I)}, L_{y(m)}, L_{z(n)}), (direct sound, reverberant sound, reflected sound, diffracted sound)=(∘, ∘, x, ∘) is obtained as the operation/non-operation information. Stated differently, operation/non-operation information is obtained indicating that direct sound generation operates, reverberant sound generation operates, reflected sound generation does not operate, and diffracted sound generation operates.

The operation/non-operation table can be created in advance. As a specific method for this, for example, for all combinations of the position of the sound source object and the position of the listener, the direct sound, reverberant sound, reflected sound, and diffracted sound that reach the listener are actually calculated, an index that takes into account auditory characteristics, such as the importance of those signals, for example, the magnitude of energy or energy corrected by auditory characteristics, is calculated, and the setting is made such that operation occurs when the index exceeds a reference threshold and non-operation occurs when the index does not exceed the threshold. In this case, although a large amount of computation is required, since the operation/non-operation table can be created in advance, it is not necessary to consider limitations on hardware processing capability or real-time performance, and thus this is feasible.

Alternatively, a content creator may design part or all of the operation/non-operation table to create the operation/non-operation table.

The decoder may be preloaded with the operation/non-operation table as part of its initialized state. In such cases, computational cost regarding the operating/non-operating table can be reduced without any additional processing requirements.

Alternatively, the operation/non-operation table may be obtained during initialization processing of the decoder, or the decoder may update part or all of the operation/non-operation table during operation. These will be described later.

Note that while the integration table described here is designed based on both the position of the sound source object and the position of the listener, the operation/non-operation table may be designed based on either the position of the sound source object or the position of the listener in order to reduce computational cost during operation/non-operation table design and reduce the memory footprint of the operation/non-operation table.

FIG. 62B will be described. FIG. 62B illustrates an operation/non-operation table according to another embodiment. The operation/non-operation table of FIG. 62A indicated only whether each generator was to operate or not operate based on the position of the sound source object and the position of the listener. The feature of the operation/non-operation table described in this figure is that it indicates, based on the position of the sound source object and the position of the listener, whether each generator is to operate or not operate, and also represents priorities of generators that are to operate, i.e., are to generate sound.

The present embodiment has the following effects. That is, by assigning priorities to generators that are to operate, generators with lower priorities can be made non-operational until the computation fits within a predetermined amount. This provides effects such as facilitating further reduction in the amount of computation and implementation on devices with limited computation ability while inhibiting degradation in quality of immersive audio.

For example, in FIG. 62B, when the position of the object is (Oₓ₍₁₎, O_{y(m)}, O_{z(n)}) and the position of the listener is (L_{x(I)}, L_{y(m)}, L_{z(n)}), (direct sound, reverberant sound, reflected sound, diffracted sound)=(2, 1, x, 3) is obtained as the operation/non-operation information.

Stated differently, operation/non-operation information is obtained indicating that direct sound operates with a priority of 2, reverberant sound operates with a priority of 1, reflected sound does not operate, and diffracted sound operates with a priority of 3. This operation/non-operation information is used to determine whether each generator operates. The procedure is as follows.

Generators whose operation/non-operation information indicates non-operation do not operate. Furthermore, in addition to the amount of computation of generators that indicate non-operation, amounts of computation of generators are accumulated in order from lower priority, and when the cumulative value exceeds a predetermined threshold, generators that were accumulated up to the point immediately before exceeding the threshold are to not operate. Only the remaining generators operate.

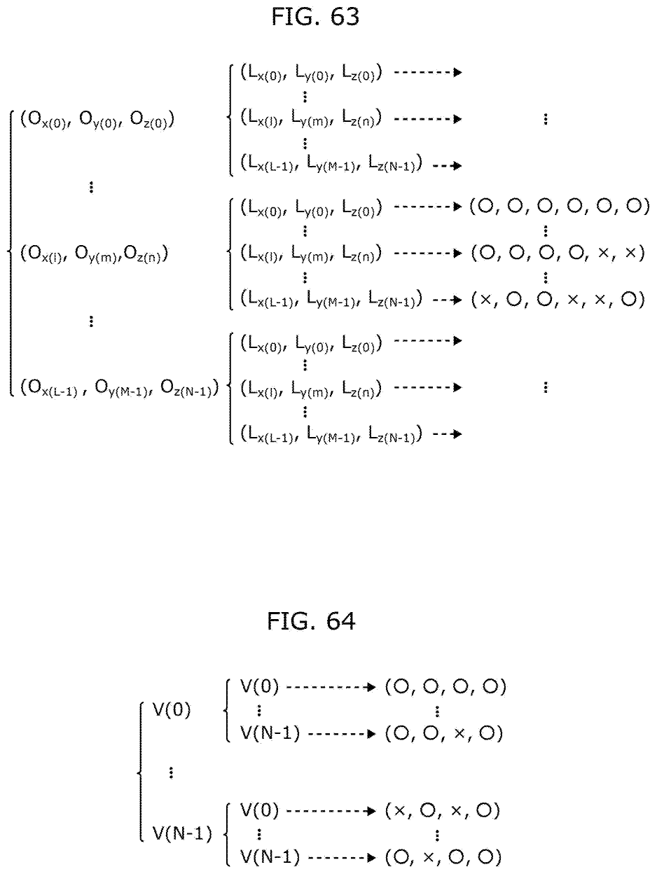

FIG. 63 will be described. FIG. 63 illustrates an operation/non-operation table according to another embodiment. The feature of the present embodiment is that the operation/non-operation table is configured by dividing reflected sounds into primary reflected sound that strikes a wall or obstacle once and reaches the listener, secondary reflected sound that strikes a wall or obstacle twice and reaches the listener, and higher-order reflected sound that strikes a wall or obstacle three or more times and reaches the listener.

Since reflected sounds, next to direct sound, have greater energy than other sounds that reach the listener such as reverberant sounds or diffracted sounds, configuring an operation/non-operation table that accounts for secondary reflected sounds and higher can enable more appropriate selection of generators to be operated or not operated to be performed.

In FIG. 63, the position of the sound source object and the position of the listener are referenced to obtain operation/non-operation information of respective sounds reaching the listener. Sounds considered for operation/non-operation information obtainment that reach the listener include direct sound, reverberant sound, primary reflected sound, secondary reflected sound, higher-order reflected sound, and diffracted sound.

For example, in FIG. 63, when the position of the object is (Oₓ₍₁₎, O_{y(m)}, O_{z(n)}) and the position of the listener is (L_{x(L-1)}, L_{y(M-1)}, L_{z(N-1)}), (direct sound, reverberant sound, primary reflected sound, secondary reflected sound, higher-order reflected sound, diffracted sound)=(x, ∘, ∘, x, x, ∘) is obtained as the operation/non-operation information.

Stated differently, operation/non-operation information is obtained indicating that direct sound generation does not operate, reverberant sound generation operates, primary reflected sound generation operates, secondary reflected sound generation does not operate, higher-order reflected sound generation does not operate, and diffracted sound generation operates.

FIG. 64 will be described. In the above example, as illustrated in FIG. 61, the operation/non-operation table has been defined on the premise that the space in which the sound source object and the listener are present is divided by equally-spaced grid points in three dimensions, and the sound source object and the listener are positioned on arbitrary grid points.

Here, the three-dimensional space is divided not by equally-spaced grid points but by cubes (voxels) of arbitrary sizes, and the operation/non-operation table defines operation/non-operation information of sounds reaching the listener when the sound source object and the listener are positioned at the centers of the voxels. Note that the voxels here do not necessarily need to be cubes, and may be rectangular parallelepipeds. The configuration of the voxels is as described in FIG. 22, and description thereof will be omitted here.

FIG. 64 illustrates a configuration example of the operation/non-operation table in this example. As illustrated in FIG. 64, operation/non-operation information of the direct sound, reverberant sound, reflected sound, and diffracted sound is predetermined by a combination of the voxel number at which the sound source object is positioned and the voxel number at which the listener is positioned, and the operation/non-operation information is obtained.

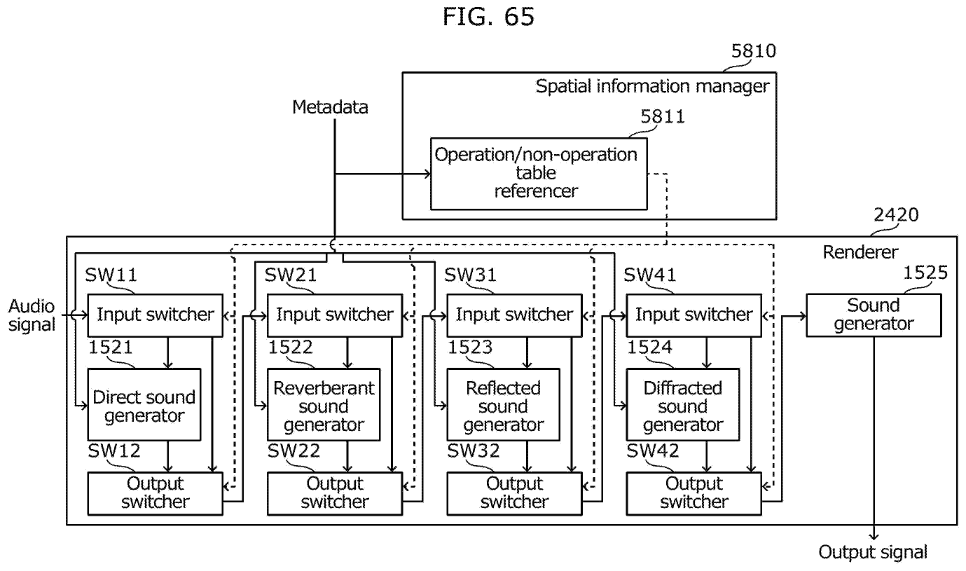

FIG. 65 will be described. FIG. 65 is a block diagram illustrating another configuration of a decoder that includes renderer 2420 instead of renderer 1520. A characteristic of this configuration is that direct sound generator 1521, reverberant sound generator 1522, reflected sound generator 1523, and diffracted sound generator 1524 are connected in series. According to this configuration, sound generated by a generator at a preceding stage affects a generator at the current stage, making it possible to provide accurate immersive audio that is closer to actual spatial acoustics.

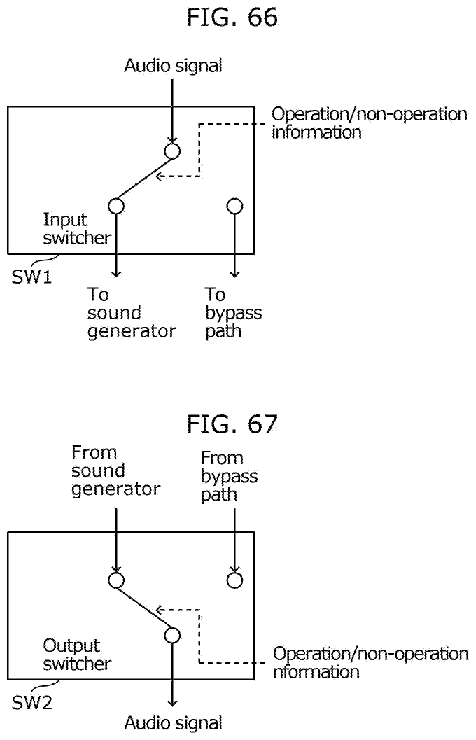

The operation/non-operation table is referenced based on the object position and listener position included in the metadata to obtain operation/non-operation information of sounds reaching the listener. According to this operation/non-operation information, input switchers SW11, SW21, SW31, and SW41, and output switchers SW12, SW22, SW32, and SW42 are controlled to generate sounds reaching the listener. Input switchers SW11, SW21, SW31, and SW41 are all configured like input switcher SW1 illustrated in FIG. 66, and output switchers SW12, SW22, SW32, and SW42 are all configured like output switcher SW2 illustrated in FIG. 67.

More specifically, input switcher SW11 at a preceding stage of direct sound generator 1521 and output switcher SW12 at a subsequent stage thereof, input switcher SW21 at a preceding stage of reverberant sound generator 1522 and output switcher SW22 at a subsequent stage thereof, input switcher SW31 at a preceding stage of reflected sound generator 1523 and output switcher SW32 at a subsequent stage thereof, and input switcher SW41 at a preceding stage of diffracted sound generator 1524 and output switcher SW42 at a subsequent stage thereof each synchronize with one another using control information provided from control information determiner 1512 to control whether to operate direct sound generator 1521, reverberant sound generator 1522, reflected sound generator 1523, and diffracted sound generator 1524.

Note that in Example 3 as well, as described with reference to FIG. 28 and FIG. 29 of Example 1, priority information may be obtained by using information from a plurality of grid points positioned in the vicinity of the sound source object or the listener.

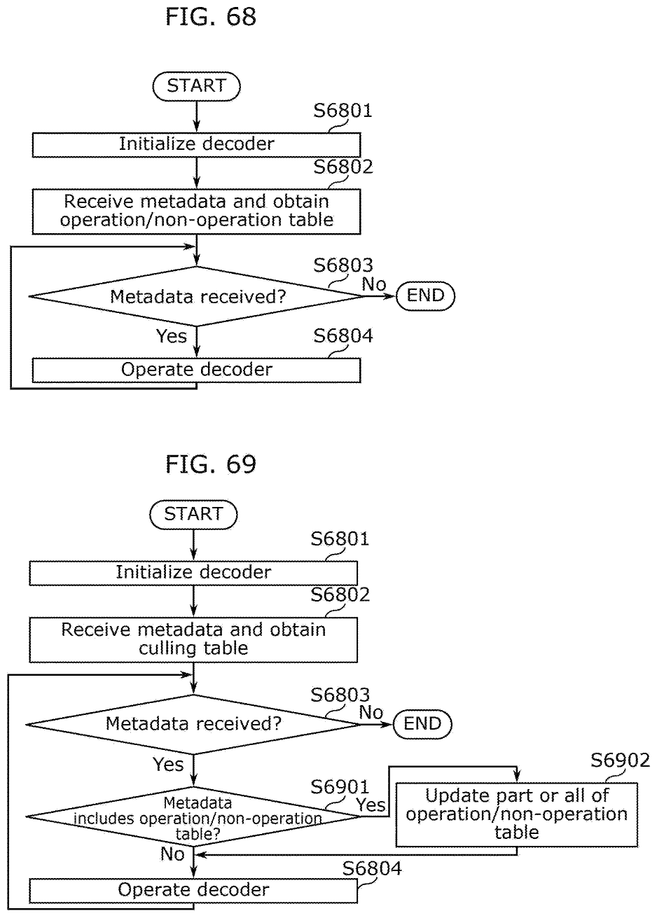

FIG. 68 will be described. A feature of this example is that the operation/non-operation table is provided to the decoder as metadata during initialization of the decoder. This eliminates the need for the decoder to create a table during operation, thereby reducing the computational cost during operation of the decoder.

FIG. 68 illustrates a flowchart of the operation in this example.

The decoder is initialized (S6801), and at that time, metadata storing the operation/non-operation table is received and the operation/non-operation table is obtained (S6802). The obtained operation/non-operation table is used in subsequent operations of the decoder.

Whether metadata is received is determined (S6803). If metadata is not received (No in S6803), the processing ends.

When metadata is received (Yes in S6803), acoustic processing is performed based on this metadata in the operation of the decoder (S6804), and immersive audio is generated and output.

The process returns to step S6803, and whether there is a reception of metadata is determined.

Note that while the algorithm here is defined based on whether metadata is received, the algorithm is not limited thereto and may be defined based on whether a bitstream, multiplexed data, a packet, or the like is received. FIG. 69 will be described. A feature of this example is that the operation/non-operation table is provided to the decoder as metadata during initialization of the decoder, and when metadata includes part or all of the operation/non-operation table while the decoder is in operation, part or all of the operation/non-operation table is updated. This eliminates the need for the decoder to create a table during operation, and enables the operation/non-operation table to follow changes when spatial information changes, thereby reducing the computational cost during operation of the decoder while maintaining the quality of immersive audio.

FIG. 69 illustrates a flowchart of the operation in this example. Part of the operation is the same as in FIG. 68 described above, and therefore may be denoted by the same reference signs.

The decoder is initialized (S6801), and at that time, metadata storing the operation/non-operation table is received and the operation/non-operation table is obtained (S6802). The obtained operation/non-operation table is used in subsequent operations of the decoder.

Whether metadata is received is determined (S6803). If metadata is not received (No in S6803), the processing ends.

When metadata is received (Yes in S6803), whether the metadata includes part or all of the operation/non-operation table is determined (S6901). If it does include part or all (Yes in S6901), part or all of the operation/non-operation table is updated (S6902).

Acoustic processing is performed based on this metadata in the decoder (operation of the decoder (S6804)), and immersive audio is generated and output.

The process returns to step S6803, and whether there is a reception of metadata is determined.

Note that while the algorithm here is defined based on whether metadata is received, the algorithm is not limited thereto and may be defined based on whether a bitstream, multiplexed data, a packet, or the like is received.

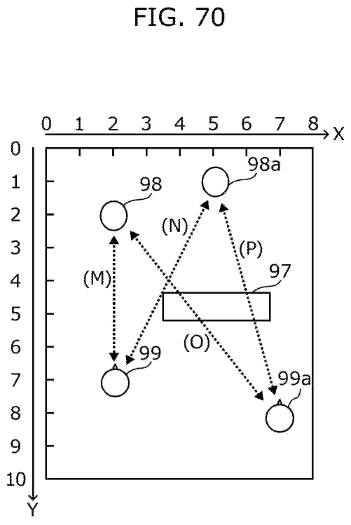

FIG. 70 will be described. While a rendering operation using an operation/non-operation table when there is one sound source object and one listener has been described above, here, a rendering operation using an operation/non-operation table when there are a plurality of (two or more) sound source objects, a plurality of listeners, or both, will be described. A feature in this situation is that an operation/non-operation table adapted to each combination of sound source object and listener is used for each combination. With this, by using an operation/non-operation table adapted to each combination of sound source object and listener, more accurate operation/non-operation information can be obtained than when using a common operation/non-operation table, enabling precise stoppage of sound generation mechanisms that have minimal importance to the listener.

FIG. 70 illustrates an example in which a plurality of objects 98 and 98a and listeners (users 99 and 99a) are arranged. Here, for convenience, the X-Y plane is displayed. In this figure, two sound source objects and two listeners are arranged. Here, the sounds reaching one listener (user 99) are emitted from sound source object 98 and sound source object 98a, respectively, and the operation/non-operation tables used are two: operation/non-operation table (M) generated from the positional relationship between sound source object 98 and the one listener, and operation/non-operation table (N) generated from the positional relationship between sound source object 98a and the one listener. Operation/non-operation table (M) is used to reference the priorities of sounds when sounds emitted from sound source object 98 reach the one listener, and operation/non-operation table (N) is used to reference the priorities of sounds when sounds emitted from sound source object 98a reach the one listener.

Similarly, the sounds reaching the other listener (user 99a) are emitted from sound source object 98 and sound source object 98a, respectively, and the operation/non-operation tables used are two: operation/non-operation table (O) generated from the positional relationship between sound source object 98 and the other listener, and culling table (P) generated from the positional relationship between sound source object 98a and the other listener. Operation/non-operation table (O) is used to reference the priorities of sounds when sounds emitted from sound source object 98 reach the other listener, and operation/non-operation table (P) is used to reference the priorities of sounds when sounds emitted from sound source object 98a reach the other listener.

In contrast to Example 3 that has been described thus far, the operation/non-operation information in the operation/non-operation table may be determined through two-stage processing. More specifically, in the first stage, sound generators to be operated and sound generators to be non-operated are tentatively determined using the operation/non-operation table based on the listener position and the object position, as has been done thus far. Next, in the second stage, analysis is performed on the sound of a sound generator that is to operate or the sound of a sound generator that is not to operate, and the operation/non-operation information is modified (in other words, corrected) based on the analysis results to determine the final operation/non-operation information. For this analysis method, for example, an index that takes into account the auditory characteristics of the listener may be used.

This enables performance improvement in cases where there is a discrepancy in acoustic conditions between when the operation/non-operation table was designed and in actual operation.

Note that sound generator here refers to one or more of direct sound generator 1521 that generates direct sound, reverberant sound generator 1522 that generates reverberant sound, reflected sound generator 1523 that generates reflected sound, and diffracted sound generator 1524 that generates diffracted sound.

Although the subject matter of the present disclosure has been described thus far based on sound propagation, the present disclosure is not limited to sound propagation and can also be applied to, for example, light propagation.

Regarding light propagation, the present disclosure is applicable to computer graphics that generate scenes based on direct light, reflected light, and diffracted light. More specifically, an operation/non-operation table is created in advance by tabulating operation/non-operation information obtained by simulating in advance whether direct light, reflected light, and diffracted light reach the user based on the positional relationship between the light source and the user in a virtual space or a space that fuses a virtual space and real space. At the computer graphics generation stage, operation/non-operation information is referenced from the operation/non-operation table based on the positions of the light source and the user, and based on the obtained operation/non-operation information, the operation of generators for light that are not to operate is stopped, and the computer graphics are generated. This enables stopping the operation of the generator of light that has a low impact on the user, so the degree of degradation in the quality of computer graphics provided to the user can be kept small, and the amount of computation for generating computer graphics can be reduced.

### Other Embodiments

While exemplary embodiments have been described above, the present disclosure is not limited to the above-described embodiments.

For example, the acoustic reproduction system described in the above embodiments may be implemented as a single device including all elements, or may be implemented by a plurality of devices, with each function allocated to the devices and these devices cooperating with each other. In the latter case, an information processing device such as a smartphone, tablet terminal, or personal computer (PC) may be used as a device corresponding to the information processing device. For example, in acoustic reproduction system 100 having a function as a renderer that generates an acoustic signal added with an acoustic effect, a server may handle all or part of the functions of the renderer. Stated differently, all or part of obtainer 111, route calculator 121, output sound generator 131, and signal outputter 141 may be implemented in a server not shown in the figure. In such case, acoustic reproduction system 100 is implemented by combining an information processing device such as a computer or smartphone, an audio presentation device such as a head-mounted display (HMD) or earphones worn by user 99, and a server not illustrated in the figures. Note that the computer, audio presentation device, and server may be communicably connected on the same network or may be connected on different networks. When connected on different networks, the possibility of communication delays increases, so a configuration may be adopted in which processing on the server is permitted only when the computer, audio presentation device, and server are communicably connected on the same network. Based on the amount of data in the bitstream received by acoustic reproduction system 100, a configuration in which whether or not all or part of the renderer's functions are to be handled by the server is determined may be implemented.

The acoustic reproduction system according to the present disclosure can also be implemented as an information processing device that is connected to a reproduction device including only drivers, and that only reproduces output sound signals generated based on obtained sound information for the reproduction device. In such cases, the information processing device may be implemented as hardware including dedicated circuits, or may be implemented as software for causing a general-purpose processor to execute specific processing.

In the above embodiments, processing executed by a specific processor may be executed by another processor. The order of a plurality of processes may be changed, and a plurality of processes may be executed in parallel.

Moreover, in the above embodiments, each element may be realized by executing a software program suitable for the element. Each of the elements may be realized by means of a program executing unit, such as a central processing unit (CPU) or a processor, reading and executing the software program recorded on a recording medium such as a hard disk or a semiconductor memory.

Each of the structural elements may be implemented by hardware. For example, each element may be a circuit (or an integrated circuit). These circuits may constitute one circuit as a whole, or may be separate circuits. These circuits may each be a general-purpose circuit or a dedicated circuit.

General or specific aspects of the present disclosure may be realized as a device, a method, an integrated circuit, a computer program, or a computer-readable recording medium such as a CD-ROM. General or specific aspects of the present disclosure may be realized as any given combination of a device, an apparatus, a method, an integrated circuit, a computer program, and a recording medium.

For example, the present disclosure may be implemented as an audio signal reproduction method executed by a computer, or may be implemented as a program for causing a computer to execute an audio signal reproduction method. The present disclosure may be implemented as a computer-readable non-transitory recording medium having the program recorded thereon.

Embodiments arrived at by a person skilled in the art making various modifications to any one of the embodiments, or embodiments realized by arbitrarily combining elements and functions in the embodiments which do not depart from the essence of the present disclosure are also included in the present disclosure.

Note that the encoded sound information in the present disclosure can be rephrased as a bitstream including a sound signal, which is information about a predetermined sound reproduced by acoustic reproduction system 100, and metadata, which is information about a localization position when localizing the sound image of the predetermined sound at a predetermined position in a three-dimensional sound field. For example, the sound information may be obtained by acoustic reproduction system 100 as a bitstream encoded in a predetermined format such as MPEG-H 3D Audio (ISO/IEC 23008-3). As one example, the encoded sound signal includes information about a predetermined sound that is reproduced by acoustic reproduction system 100. Here, the predetermined sound is a sound emitted by a sound source object existing in the three-dimensional sound field or an environmental sound, and can include, for example, mechanical sounds, or voices of animals including humans. Note that when there are a plurality of sound source objects in the three-dimensional sound field, acoustic reproduction system 100 obtains a plurality of sound signals respectively corresponding to the plurality of sound source objects.

Metadata is, for example, information used for controlling acoustic processing on the sound signal in acoustic reproduction system 100. The metadata may be information used for describing a scene expressed in the virtual space (three-dimensional sound field). Here, the term “scene” refers to an aggregate of all elements representing three-dimensional images and acoustic events in the virtual space, which are modeled in acoustic reproduction system 100 using metadata. Thus, metadata herein may include not only information for controlling acoustic processing, but also information for controlling video processing. The metadata may of course include information for controlling only acoustic processing or video processing, or may include information for use in controlling both. In the present disclosure, the bitstream obtained by acoustic reproduction system 100 may include such metadata. Alternatively, acoustic reproduction system 100 may obtain metadata separately from the bitstream, as described later.

Acoustic reproduction system 100 generates virtual acoustic effects by performing acoustic processing on the sound signal using metadata included in the bitstream and additionally obtained interactive position information of user 99. For example, acoustic effects such as early reflected sound generation, late reverberant sound generation, diffracted sound generation, distance attenuation effect, localization, sound image localization processing, or Doppler effect may be added. Information for switching on or off all or part of the acoustic effects may be added as metadata.

Note that the entire metadata or part of the metadata may be obtained from somewhere other than a bitstream that includes sound information. For example, metadata for controlling an acoustic sound or metadata for controlling a video may be obtained from somewhere other than from a bitstream or both may be obtained from somewhere other than from a bitstream.

When metadata for controlling video is included in the bitstream obtained by acoustic reproduction system 100, acoustic reproduction system 100 may include a function to output metadata that can be used for controlling video to a display device that displays images, or to a stereoscopic image reproduction device that reproduces stereoscopic images.

As an example, encoded metadata includes information about a three-dimensional sound field including a sound source object that emits sound and an obstacle object and information about a localization position when the sound image of the sound is localized at a predetermined position in the three-dimensional sound field (i.e., the sound is perceived as arriving from a predetermined direction), namely, information about the predetermined direction. Here, an obstacle object is an object that can affect the sound perceived by user 99, for example, by blocking or reflecting the sound, during the period until the sound emitted by the sound source object reaches user 99. Obstacle objects can include not only stationary objects but also animals such as humans or mobile bodies such as machines. When there are a plurality of sound source objects in the three-dimensional sound field, for any given sound source object, the other sound source objects can become obstacle objects. Non-emitting sound source objects such as building material and inanimate objects and sound emitting sound source objects can both be obstacle objects.

The metadata may include, as spatial information including the metadata, not only the shape of the three-dimensional sound field, but also information representing the shape and position of obstacle objects existing in the three-dimensional sound field, and the shape and position of sound source objects existing in the three-dimensional sound field. The three-dimensional sound field may be either a closed space or an open space, and the metadata includes, for example, information representing the reflectivity of structures that can reflect sound in the three-dimensional sound field, such as floors, walls, or ceilings, and the reflectivity of obstacle objects present in the three-dimensional sound field. As used herein, reflectance is the ratio of energy of reflected sound to incident sound, and is set for each frequency band of the sound. The reflectance may be set uniformly regardless of the frequency band of the sound. If the three-dimensional sound field is an open space, parameters such as a uniformly set attenuation rate, diffracted sound, or early reflected sound may be used.

In the above description, reflectance is stated as a parameter with regard to an obstacle object or a sound source object included in metadata, but the metadata may include information other than reflectance. For example, information on the material of an object may be included as metadata related to both of a sound source object and a non-emitting sound source object. Specifically, metadata may include a parameter such as a diffusion factor, a transmittance, or an acoustic absorptivity.

Information related to the sound source object may include loudness, radiation characteristics (directivity), reproduction conditions, the number and types of sound sources emitted from a single object, or information specifying the sound source region in the object. The reproduction condition may determine that a sound is, for example, a sound that is continuously being emitted or is emitted at an event. The sound source region in the object may be determined based on the relative relationship between the position of user 99 and the position of the object, or may be determined with reference to the object. When determined based on the relative relationship between the position of user 99 and the position of the object, with respect to the plane along which user 99 is looking at the object, user 99 can be made to perceive that sound X is emitted from the right side of the object and sound Y is emitted from the left side of the object as seen from user 99. When determined with reference to the object, regardless of the direction in which user 99 is looking, it is possible to fixate which sound is emitted from which region of the object. For example, user 99 can be made to perceive that a high-pitched sound is emitted from the right side and a low-pitched sound is emitted from the left side when viewing the object from the front. In this case, when user 99 moves around to the back of the object, user 99 can be made to perceive that a low-pitched sound is emitted from the right side and a high-pitched sound is emitted from the left side as seen from the back.

The time until an initial reflected sound arrives, the reverberation time, or the ratio between the direct sound and the diffused sound, for instance, can be included as metadata related to a space. When the ratio between the direct sound and the diffused sound is zero, user 99 can be made to perceive only the direct sound. Information indicating the position and orientation of user 99 in the three-dimensional sound field may be included in the bitstream as metadata as an initial setting, or may not be included in the bitstream. When information indicating the position and orientation of user 99 is not included in the bitstream, information indicating the position and orientation of user 99 is obtained from information other than the bitstream. For example, regarding position information of user 99 in a VR space, the position information may be obtained from an application providing VR content. Regarding position information of user 99 for presenting sound as AR, position information obtained by performing self-position estimation using GPS, a camera, or Laser Imaging Detection and Ranging (LIDAR) on the mobile terminal, for example, may be used. Note that the sound signal and metadata may be stored in a single bitstream or may be separately stored in a plurality of bitstreams. Similarly, the sound signal and metadata may be stored in a single file or may be separately stored in a plurality of files.

When the sound signal and metadata are separately stored in a plurality of bitstreams, information indicating other relevant bitstreams may be included in one or some of the plurality of bitstreams in which the sound signal and metadata are stored. Information indicating other relevant bitstreams may be included in the metadata or control information of each bitstream of the plurality of bitstreams in which the sound signal and metadata are stored. When the sound signal and metadata are separately stored in a plurality of files, information indicating other relevant bitstreams or files may be included in one or some of the plurality of files in which the sound signal and metadata are stored. Information indicating other relevant bitstreams or files may be included in the metadata or control information of each bitstream of the plurality of bitstreams in which the sound signal and metadata are stored.

Here, the related bitstream or the related file is a bitstream or a file that may be simultaneously used in acoustic processing, for example. Information indicating other relevant bitstreams may be collectively described in the metadata or control information of one bitstream of the plurality of bitstreams in which the sound signal and metadata are stored, or may be separately described in the metadata or control information of two or more bitstreams of the plurality of bitstreams in which the sound signal and metadata are stored. Similarly, information indicating other relevant bitstreams or files may be collectively described in the metadata or control information of one file of the plurality of files in which the sound signal and metadata are stored, or may be separately described in the metadata or control information of two or more files of the plurality of files in which the sound signal and metadata are stored. A control file that collectively describes information indicating other relevant bitstreams or files may be generated separately from the plurality of files in which the sound signal and metadata are stored. In such cases, the control file need not store the sound signal and metadata.

Here, information indicating a relevant other bitstream or file may be an identifier indicating the other bitstream, a file name showing the other file, a uniform resource locator (URL), or a uniform resource identifier (URI), for instance. In this case, the obtainer identifies or obtains a bitstream or a file, based on information indicating a relevant other bitstream or file. Information indicating other relevant bitstreams may be included in the metadata or control information of at least some of the plurality of bitstreams in which the sound signal and metadata are stored, and information indicating other relevant files may be included in the metadata or control information of at least some of the plurality of files in which the sound signal and metadata are stored. Here, a file that includes information indicating a relevant bitstream or file may be a control file such as a manifest file for use in distributing content, for example.

### INDUSTRIAL APPLICABILITY

The present disclosure is useful for acoustic reproduction, such as making a user perceive three-dimensional sound.

1. An acoustic processing device comprising:
an obtainer that obtains sound information including: an acoustic signal; and information on a position of a sound source object in a three-dimensional sound field;
a table referencer that references a table that associates at least one of a position of a user in the three-dimensional sound field or a position of the sound source object with information for determining a target sound; and
a reduction processor that determines the target sound using the information for determining the target sound obtained by referencing the table, and generates an output sound signal excluding a signal of the target sound determined, by removing the signal of the target sound from among signals of a plurality of sounds generated for use in generating the output sound signal from the acoustic signal included in the sound information obtained.

2. The acoustic processing device according to claim 1, wherein
the table includes a priority for each of the plurality of sounds, and
a lower rank in the priority increases a likelihood to be determined as the target sound.

3. The acoustic processing device according to claim 1, wherein
the table includes an identifier for distinguishing, from other sounds, each of at least two sounds to be determined as the target sound from among the plurality of sounds.

4. The acoustic processing device according to claim 1, wherein
the table includes information indicating whether or not to perform an operation to generate each of the plurality of sounds.

5. The acoustic processing device according to claim 1, wherein
the table includes information indicating whether or not to perform an operation to generate each of the plurality of sounds, and a priority for each of the plurality of sounds, and
a lower priority increases a likelihood to be determined as the target sound.

6. The acoustic processing device according to claim 1, wherein
the reduction processor includes a culler that removes the signal of the target sound by discarding the signal of the target sound.

7. The acoustic processing device according to claim 6, wherein
the reduction processor discards the signal of the target sound by stopping an operation to generate the signal of the target sound.

8. The acoustic processing device according to claim 1, wherein
the reduction processor includes an integrator that removes signals of at least two target sounds, each of which is the target sound, by discarding the signals of the at least two target sounds and supplementing one signal of a virtual sound that integrates the signals of the at least two target sounds.

9. The acoustic processing device according to claim 8, wherein
the integrator supplements the signal of the virtual sound to localize the virtual sound at a position based on positions of the at least two target sounds discarded and the position of the user.

10. The acoustic processing device according to claim 3, wherein
the table is created in advance to include identifiers of at least two sounds as sounds to be determined as the target sound, based on at least one of information regarding an angle of two or more sounds arriving toward the user or information regarding a level ratio of the two or more sounds arriving toward the user.

11. The acoustic processing device according to claim 1, wherein
the reduction processor gradually removes at least one sound signal in a time domain.

12. The acoustic processing device according to claim 1, wherein
the reduction processor corrects the information for determining the target sound obtained by referencing the table, and determines the target sound using the information for determining the target sound that has been corrected.

13. The acoustic processing device according to claim 1, wherein
the table referencer converts each of the position of the user and the position of the sound source object using positions of grid points that partition the three-dimensional sound field into unit spaces of a predetermined size, and references the table using at least one of the position of the user that has been converted or the position of the sound source object that has been converted.

14. The acoustic processing device according to claim 1, wherein
the table referencer converts each of the position of the user and the position of the sound source object using identifiers of voxels that are unit spaces partitioning the three-dimensional sound field into a plurality of sizes, and references the table using at least one of the position of the user that has been converted or the position of the sound source object that has been converted.

15. The acoustic processing device according to claim 13, wherein
a size of the unit spaces is changed based on at least one of a storage capacity or a processing capability of the acoustic processing device.

16. The acoustic processing device according to claim 1, further comprising:
a table setter that sets the table when the acoustic processing device is initialized.

17. The acoustic processing device according to claim 16, wherein
the table setter further updates at least a portion of the table when information for updating the table is obtained.

18. The acoustic processing device according to claim 2, wherein
the reduction processor integrates a computation amount in descending order of the priorities included in the table, and determines each sound at or below a rank at which the computation amount exceeds a predetermined computation amount as the target sound.

19. The acoustic processing device according to claim 1, wherein
when there are a plurality of users present, each of which is the user, or a plurality of sound source objects present, each of which is the sound source object, the table referencer references, from among a plurality of tables, each of which is the table, one table that corresponds to a combination of the position of the user and the position of the sound source object.

20. An acoustic processing method executed by a computer, the acoustic processing method comprising:
obtaining sound information including: an acoustic signal; and information on a position of a sound source object in a three-dimensional sound field;
referencing a table that associates at least one of a position of a user in the three-dimensional sound field or a position of the sound source object with information for determining a target sound; and
determining the target sound using the information for determining the target sound obtained by referencing the table, and generating an output sound signal excluding a signal of the target sound determined, by removing the signal of the target sound from among signals of a plurality of sounds generated for use in generating the output sound signal from the acoustic signal included in the sound information obtained.

21. A non-transitory computer-readable recording medium for use in a computer, the recording medium having a computer program recorded thereon for causing the computer to execute the acoustic processing method according to claim 20.
